(19) United States
(12) Patent Application Publication
(10) Pub. No.: US 2002/0122751 A1
(43) Pub. Date: Sep. 5, 2002

(54) Electro-kinetic air transporter-conditioner devices with a enhanced collector electrode for collecting more particulate matter

(76) Inventors: Robert J. Sinaiko, San Francisco, CA (US); Charles E. Taylor, Sebastopol, CA (US)

Correspondence Address: Sheldon R. Meyer, Esq., FLIESLER DUBB MEYER & LOVEJOY LLP, Four Embarcadero Center, Fourth Floor, San Francisco, CA, 94111-4156, US

(21) Appl. No.: 10/074,103

(22) Filed: Feb. 12, 2002

Related U.S. Application Data
(63) Continuation-in-part of application No. 09/924,624, filed on Aug. 8, 2001.
(63) Continuation of application No. 09/564,960, filed on May 4, 2000, now Pat. No. 6,350,417.
(63) Continuation-in-part of application No. 09/186,471, filed on Nov. 5, 1998, now Pat. No. 6,176,977.
(60) Provisional application No. 60/340,462, filed on Dec. 13, 2001.
(60) Provisional application No. 60/306,479, filed on Jul. 18, 2001.

(51) Int. Cl. B01J 19/08

(52) U.S. Cl. 422/186

(57) ABSTRACT

Air transporter-conditioner for removing particles from the air has a first electrode assembly and a second electrode assembly for creating an air flow and collecting particulates within the air flow as the air passes through the first and second electrode assembly. An embodiment of the device has dual inlet and dual outlet in order to enhance the airflow therethrough. An embodiment includes a collector electrode with multiple surfaces in order to enhance particle collection.

### CLAIM OF PRIORITY

This application claims priority from provisional application entitled “ELECTRO-KINETIC AIR TRANSPORTER-CONDITIONER DEVICES WITH A ENHANCED COLLECTOR ELECTRODE FOR COLLECTING MORE PARTICULATE MATTER,” Application No. 60/340,462, filed Dec. 13, 2001, under 35 U.S.C. 119(e), which application is incorporated herein by reference. This application claims priority from provisional application entitled “FOCUS ELECTRODE, ELECTRO-KINETIC AIR TRANSPORTER-CONDITIONER DEVICES,” Application No. 60/306,479, filed Jul. 18, 2001 under 35 U.S.C. 119(e), which application is incorporated herein by reference. This application claims priority from and is a continuation-in-part of U.S. patent application Ser. No. 09/924,624 filed Aug. 8, 2001 which is a continuation of U.S. Pat. No. 09/564,960 filed May 4, 2000, which is a continuation-in-part of U.S. patent application Ser. No. 09/186,471 filed Nov. 5, 1998, now U.S. Pat. No. 6,176,977. All of the above are incorporated herein by reference.

### CROSS-REFERENCE TO RELATED APPLICATIONS

1. U.S. Patent Application No. 60/341,518, filed Dec. 13, 2001, entitled “ELECTRO-KINETIC AIR TRANSPORTER-CONDITIONER DEVICES WITH AN UPSTREAM FOCUS ELECTRODE”; SHPR-01041US6

2. U.S. Patent Application No. 60/341,090, filed Dec. 13, 2001, entitled “ELECTRO-KINETIC AIR TRANSPORTER-CONDITIONERDEVICES WITH TRAILING ELECTRODE”; SHPR-01041USE

3. U.S. Patent Application No. 60/341,433, filed Dec. 13,2001, entitled “ELECTRO-KINETIC AIR TRANSPORTER-CONDITIONER DEVICES WITH INTERSTITIAL ELECTRODE”; SHPR-01041USF

4. U.S. Patent Application No. 60/341,592, filed Dec. 13, 2001, entitled “ELECTRO-KINETIC AIR TRANSPORTER-CONDITIONER DEVICES WITH ENHANCED COLLECTOR ELECTRODE”; SHPR-01041USG

5. U.S. Patent Application No. 60/341,320, filed Dec. 13, 2001, entitled “ELECTRO-KINETIC AIR TRANSPORTER-CONDITIONER DEVICES WITH ENHANCED EMITTER ELECTRODE”; SHPR-01041USH

6. U.S. Patent Application No. 60/341,179, filed Dec. 13, 2001, entitled “ELECTRO-KINETIC AIR TRANSPORTER AND CONDITIONER DEVICE WITH ENHANCED ANTI-MICROORGANISM CAPABILITY”; SHPR-01028US1

7. U.S. Patent Application No. 60/340,702, filed Dec. 13, 2001, entitled “ELECTRO-KINETIC AIR TRANSPORTER AND CONDITIONER DEVICE WITH ENHANCED HOUSING CONFIGURATION AND ENHANCED ANTIMICROORGANISM CAPABILITY”; SHPR-01028US2

8. U.S. Patent Application No. 60/341,377, filed Dec. 13, 2001, entitled “ELECTRO-KINETIC AIR TRANSPORTER AND CONDITIONER DEVICE WITH ENHANCED MAINTENANCE FEATURES AND ENHANCED ANTI-MICROORGANISM CAPABILITY”; SHPR-01028US3

9. U.S. patent application Ser. No. 10/023,197, filed Dec. 13, 2001, entitled “ELECTRO-KINETIC AIR TRANSPORTER-CONDITIONER WITH ENHANCED CLEANING FEATURES”; SHPR-01041USI

10. U.S. patent application Ser. No. 10/023,460, filed Dec. 13, 2001, entitled “ELECTRO-KINETIC AIR TRANSPORTER CONDITIONER WITH PIN-RING CONFIGURATION”; SHPR-01041USJ

11. U.S. Patent Application No. 60/341,176, filed Dec. 13, 2001, entitled “ELECTRO-KINETIC AIR TRANSPORTER-CONDITIONER WITH NON-EQUIDISTANT COLLECTOR ELECTRODES “; SHPR-01041US8

12. U.S. Patent Application No. 60/340,288, filed Dec. 13, 2001, entitled “DUAL INPUT AND OUTLET ELECTROSTATIC AIR TRANSPORTER-CONDITIONER”; SHPR-01041US7.

13. U.S. patent application Ser. No. ______, filed herewith, entitled “ELECTROKINETIC AIR TRANSPORTER-CONDITIONER DEVICES WITH AN UPSTREAM FOCUS ELECTRODE”; SHPR-01041USL

14. U.S. patent application Ser. No. ______, filed herewith, entitled “ELECTROKINETIC AIR TRANSPORTER-CONDITIONER DEVICES WITH TRAILING ELECTRODE”; SHPR-01041USM

15. U.S. patent application Ser. No. ______, filed herewith, entitled “ELECTROKINETIC AIR TRANSPORTER-CONDITIONER DEVICES WITH INTERSTITIAL ELECTRODE”; SHPR-01041USN

16. U.S. patent application Ser. No. ______, filed herewith, entitled “ELECTROKINETIC AIR TRANSPORTER-CONDITIONER DEVICES WITH ENHANCED COLLECTOR ELECTRODE”; SHPR-01041USO

17. U.S. patent application Ser. No. ______, filed herewith, entitled “ELECTROKINETIC AIR TRANSPORTER-CONDITIONER DEVICES WITH ENHANCED EMITTER ELECTRODE”; SHPR-01041USP

18. U.S. patent application Ser. No. ______, filed herewith, entitled “ELECTROKINETIC AIR TRANSPORTER AND CONDITIONER DEVICE WITH ENHANCED ANTI-MICROORGANISM CAPABILITY”; SHPR-01028US4

19. U.S. patent application Ser. No. ______, filed herewith, entitled “ELECTROKINETIC AIR TRANSPORTER AND CONDITIONER DEVICE WITH ENHANCED HOUSING CONFIGURATION AND ENHANCED ANTI-MICROORGANISM CAPABILITY”; SHPR-01028US5

20. U.S. patent application Ser. No. ______, filed herewith, entitled “ELECTROKINETIC AIR TRANSPORTER AND CONDITIONER DEVICE WITH ENHANCED MAINTENANCE FEATURES AND ENHANCED ANTI-MICROORGANISM CAPABILITY”; SHPR-01028US6

21. U.S. patent application Ser. No. ______, filed herewith, entitled “ELECTROKINETIC AIR TRANSPORTER-CONDITIONER WITH NON-EQUIDISTANT COLLECTOR ELECTRODES”; and SHPR-01041USQ

22. U.S. patent application Ser. No. ______, filed herewith, entitled “DUAL INPUT AND OUTLET ELECTROSTATIC AIR TRANSPORTER-CONDITIONER”; SHPR-01041USR.

All of the above are incorporated herein by reference.

### BACKGROUND OF THE INVENTION

The use of an electric motor to rotate a fan blade to create an airflow has long been known in the art. Unfortunately, such fans produce substantial noise, and can present a hazard to children who maybe tempted to poke a finger or a pencil into the moving fan blade. Although such fans can produce substantial airflow (e.g., 1,000 ft³/minute or more), substantial electrical power is required to operate the motor, and essentially no conditioning of the flowing air occurs.

It is known to provide such fans with a HEPA-compliant filter element to remove particulate matter larger than perhaps 0.3 μm. Unfortunately, the resistance to airflow presented by the filter element may require doubling the electric motor size to maintain a desired level of airflow. Further, HEPA-compliant filter elements are expensive, and can represent a substantial portion of the sale price of a HEPA-compliant filter-fan unit. While such filter-fan units can condition the air by removing large particles, particulate matter small enough to pass through the filter element is not removed, including bacteria, for example.

The use of an electric motor to rotate a fan blade to create an airflow has long been known in the art. Unfortunately, such fans produce substantial noise, and can present a hazard to children who maybe tempted to poke a finger or a pencil into the moving fan blade. Although such fans can produce substantial airflow, e.g., 1,000 ft³/minute or more, substantial electrical power is required to operate the motor, and essentially no conditioning of the flowing air occurs.

It is known to provide such fans with a HEPA-compliant filter element to remove particulate matter larger than perhaps 0.3 μm. Unfortunately, the resistance to airflow presented by the filter element may require doubling the electric motor size to maintain a desired level of airflow. Further, HEPA-compliant filter elements are expensive, and can represent a substantial portion of the sale price of a HEPA-compliant filter-fan unit. While such filter-fan units can condition the air by removing large particles, particulate matter small enough to pass through the filter element is not removed, including bacteria, for example.

It is also known in the art to produce an airflow using electro-kinetic techniques, by which electrical power is directly converted into a flow of air without mechanically moving components. One such system is described in U.S. Pat. No. 4,789,801 issued to Lee (1988), which is incorporated herein by reference. The '801 patent describes various devices to generate a stream of ionized air using so-called electro-kinetic techniques. In some applications, the electro-kinetic devices maybe small enough to be handheld, and in other applications electro-kinetic devices maybe large enough to condition the air in a room. In overview, electro-kinetic techniques use high electric fields to ionize air molecules, a process that may produce ozone (O₃) as a byproduct. Ozone is an unstable molecule of oxygen that is commonly produced as a byproduct of high voltage arcing. In appropriate concentrations, ozone can be a desirable and useful substance. But ozone by itself may not be effective to kill microorganisms such as germs, bacteria, and viruses in the environment surrounding the device.

FIG. 1A depicts a generic electro-kinetic device 10 to condition air. Device 10 includes a housing 20 that typically has at least one air input port 30 and at least one air output port 40. Within housing 20 there is disposed an electrode assembly or system 50 comprising a first electrode array 60 having at least one electrode 70 and comprising a second electrode array 80 having at least one electrode 90. System 10 further includes a high voltage generator 95 coupled between the first and second electrode arrays.

As a result, ozone and ionized particles of air are generated within device 10, and there is an electro-kinetic flow of air in the direction from the first electrode array 60 towards the second electrode array 80. In FIG. 1 A, the large arrow denoted IN represents ambient air that can enter input port 30. The small “x's” denote particulate matter that may be present in the incoming ambient air. The air movement is in the direction of the large arrows, and the output airflow, denoted OUT, exits device 10 via port 40. An advantage of electro-kinetic devices such as device 10 is that an airflow is created without using fans or other moving parts to create the airflow.

Preferably, particulate matter in the ambient air can be electrostatically attracted to the second electrode array 80, with the result that the outflow (OUT) of air from device 10 not only contains ozone and ionized air, but can be cleaner than the ambient air. Thus, device 10 in FIG. 1A can function somewhat as a fan to create an output airflow, but without requiring moving parts. Ideally the outflow of air (OUT) is conditioned in that particulate matter is removed and the outflow includes appropriate amounts of ozone, and some ions.

As shown in FIG. 1B, system 50 includes an array of first (“emitter”) electrodes or conductive surfaces 70 that are spaced-apart symmetrically from an array of second (“collector”) electrodes or conductive surfaces 90. The positive terminal of a generator such as, for example, pulse generator 95 that outputs a train of high voltage pulses (e.g., 0 to perhaps +5 KV) is coupled to the first array, and the negative pulse generator terminal is coupled to the second array in this example. It is to be understood that the arrays depicted include multiple electrodes, but that an array can include or be replaced by a single electrode.

The high voltage pulses ionize the air between the arrays, and create an airflow from the first array toward the second array, without requiring any moving parts. Particulate matter 60 in the air is entrained within the airflow and also moves towards the second electrodes 90. Much of the particulate matter 60 is electrostatically attracted to the surfaces of the second electrodes 90, where it remains, thus conditioning the flow of air exiting system 50. Further, the high voltage field present between the electrode arrays can release ozone into the ambient environment, which can eliminate odors that are entrained in the airflow.

In the particular embodiment of FIG. 1B, first electrodes 70 are circular in cross-section, having a diameter of about 0.003″ (0.08 mm), whereas the second electrodes 90 are substantially larger in area and define a “teardrop” shape in cross-section. The ratio of cross-sectional radii of curvature between the bulbous front nose of the second electrode and the first electrodes exceeds 10:1. As shown in FIG. 1B, the bulbous front surfaces of the second electrodes 90 face the first electrodes 70, and the somewhat “sharp” trailing edges face the exit direction of the airflow. The “sharp” trailing edges on the second electrodes 90 promote good electrostatic attachment of particulate matter entrained in the airflow.

In another particular embodiment shown herein as FIG. 1 C, second electrodes 90 are symmetrical and elongated in cross-section. The elongated trailing edges on the second electrodes 90 provide increased area upon which particulate matter entrained in the airflow can attach.

While the electrostatic techniques disclosed by the '801 patent are advantageous over conventional electric fan-filter units, further increased air transport-conditioning efficiency would be advantageous.

What is needed is a device to condition air in a room that can operate relatively silently to remove particulate matter in the air, that can preferably output appropriate amounts of ozone or no ozone, and that can also kill or reduce microorganisms such as germs, fungi, bacteria, viruses, and the like.

### SUMMARY OF THE INVENTION

The present invention provides such an apparatus.

An aspect of the present invention is an electro-kinetic system for transporting and conditioning air without moving parts. An embodiment of the present invention includes an ion generator comprising first and second electrodes, or first and second conducting surfaces, electrically connected to the output ports of a high voltage generator. The second electrode or conducting surface can electrostatically collect dust and other particulate matter contained within the air.

Another aspect of the present invention is to increase the air cleaning per watt of electrical power consumed. An embodiment of the present invention has two intake and two outlet ports. By increasing the number of intakes and outlets, a larger volume of air can be moved and conditioned without having to expend more energy to maintain the airflow velocity.

In another aspect of the present invention, two or more ion generating units are enclosed in a housing having dual inlets and dual outlets. Such an arrangement can increase airflow without an increase in voltage levels or voltage differentials in the ion generating unit.

Another embodiment of the invention includes one or more second electrodes having a non-linear tail section. The tail section increases the width and surface area of the second electrode. As a result, there is a larger surface area to attract and capture particles.

Still another aspect of the present invention is to kill microorganisms within the airflow. An embodiment of the invention has a germicidal lamp, located upstream of the ion generator, to kill microorganisms.

Other objects, aspects, features and advantages of the invention will appear from the following description in which preferred embodiments have been set forth in detail, in conjunction with the accompanying drawings and also from the following claims.

### BRIEF DESCRIPTION OF THE DRAWINGS

FIGS. 1A-1C;

FIG. 1A is a plan view of an electro-kinetic air transporter-conditioner system, according to the prior art;

FIG. 1B is a plan view of another embodiment of first and second electrode arrays, according to the prior art;

FIG. 1C is yet another embodiment of the first and second electrode arrays, according to the prior art;

FIGS. 2A-2B;

FIG. 2A is a perspective view of an embodiment of the present invention;

FIG. 2B is a perspective view of the embodiment in FIG. 2A, illustrating the removable second array of electrodes;

FIGS. 3A-3E;

FIG. 3A is a perspective view of another embodiment of the present invention;

FIG. 3B is a cut-away view of the embodiment shown in FIG. 3A, illustrating the ion generator contained within the housing;

FIG. 3C is a cut-away plan view of the embodiment shown in FIG. 3B;

FIG. 3D is a perspective view of yet another embodiment of the present invention;

FIG. 3E is still another embodiment of the present invention;

FIGS. 4A-4C;

FIG. 4A is an electrical block diagram of an embodiment the ion generator, according to the present invention;

FIG. 4B is a partial electrical block diagram of another embodiment of the present invention;

FIG. 4C is a partial electrical block diagram of still another embodiment of the present invention depicted in FIG. 4B;

FIGS. 5A-5J;

FIG. 5A is a perspective view of an embodiment of the electrode assembly, according to the present invention;

FIG. 5B is a plan view of the embodiment shown in FIG. 5A;

FIG. 5C is a perspective view of another embodiment of the electrode assembly;

FIG. 5D is still another embodiment of the electrode assembly;

FIG. 5E is yet another embodiment of the electrode assembly;

FIG. 5F is a plan view of the embodiment shown in FIG. 5E;

FIG. 5G is still a further embodiment of the electrode assembly;

FIG. 5H is a plan view of another embodiment of the invention;

FIG. 5I is a perspective view of yet another embodiment of the electrode assembly;

FIG. 5J is a plan view of the embodiment shown in FIG. 5I;

FIGS. 6A-6B;

FIG. 6A is a perspective view of yet another embodiment of the electrode assembly, according to the invention;

FIG. 6B is a plan view of a further embodiment of the electrode assembly;

FIGS. 7A-7D;

FIG. 7A is a perspective view of another embodiment of the electrode assembly, according to the present invention;

FIG. 7B is a perspective view of an embodiment modified from that shown in FIG. 7A;

FIG. 7C is a perspective view of yet another embodiment modified from that shown in FIG. 7A;

FIG. 7D is still another embodiment of the electrode assembly;

FIGS. 8A-8C;

FIG. 8A is a perspective view of yet another embodiment of the electrode assembly, according to the present invention;

FIG. 8B is a perspective view of an embodiment modified from that shown in FIG. 8A;

FIG. 8C is a perspective view of still another embodiment of the electrode assembly;

FIGS. 9A-9C;

FIG. 9A is a perspective view of still another embodiment of the electrode assembly, according to the present invention;

FIG. 9B is a perspective view of another embodiment of the electrode assembly;

FIG. 9C is a perspective view of yet another embodiment of the electrode assembly;

FIGS. 10A-10C;

FIG. 10A is a perspective view of yet another embodiment of the electrode assembly, according to the present invention;

FIG. 10B is a perspective view of an embodiment modified from that show in FIG. 10A;

FIG. 10C is a perspective view of another embodiment modified from that shown in FIG. 10A;

FIGS. 11A-11D;

FIG. 11A is a perspective view of still another embodiment of the electrode assembly, according to the present invention;

FIG. 11B is a plan view of the embodiment shown in FIG. 11A;

FIG. 11C is a perspective view of an embodiment of the invention modified from that shown in FIG. 11B;

FIG. 11D depicts another embodiment of the invention;

FIGS. 12A-12F;

FIG. 12A is a plan view of still another embodiment of the electrode assembly, according to the present invention;

FIG. 12B is a plan view of an embodiment modified from that shown in FIG. 12A;

FIG. 12C is a plan view of yet another embodiment of the electrode assembly;

FIG. 12D is a plan view of an embodiment modified from that shown in FIG. 12C;

FIG. 12E is a plan view of a further embodiment of the electrode assembly;

FIG. 12F is a plan view of an embodiment modified from that shown in FIG. 12E;

FIGS. 13A-13C;

FIG. 13A is a perspective view of another embodiment of the electrode assembly, according to the present invention;

FIG. 13B is a perspective view of still another embodiment of the electrode assembly;

FIG. 13C is a perspective view of yet another embodiment of the electrode assembly; and

FIGS. 14A-14C;

FIG. 14A is a plan view of another embodiment of the present invention;

FIG. 14B is an embodiment modified of that shown in FIG. 14A;

FIG. 14C is an another embodiment modified of that shown in FIG. 14A.

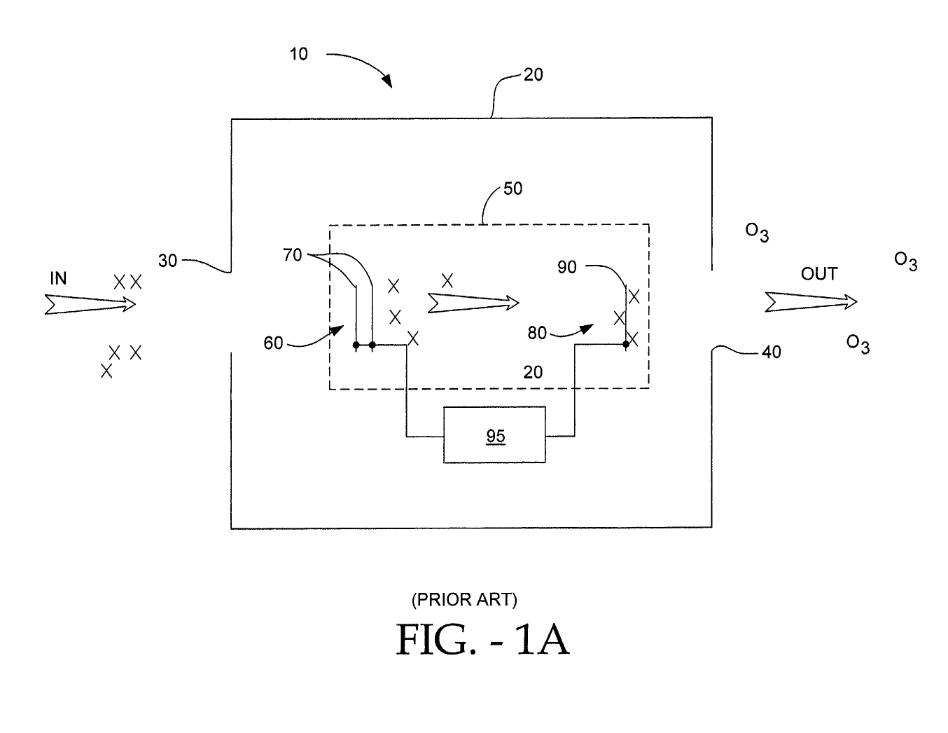

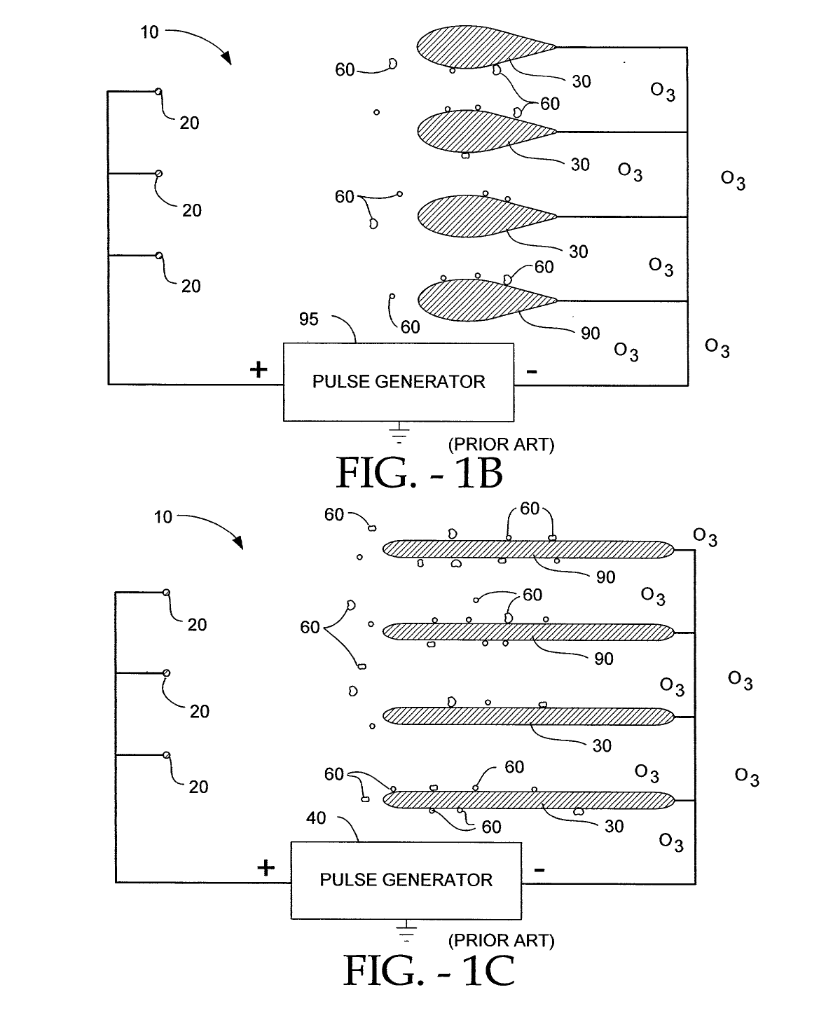

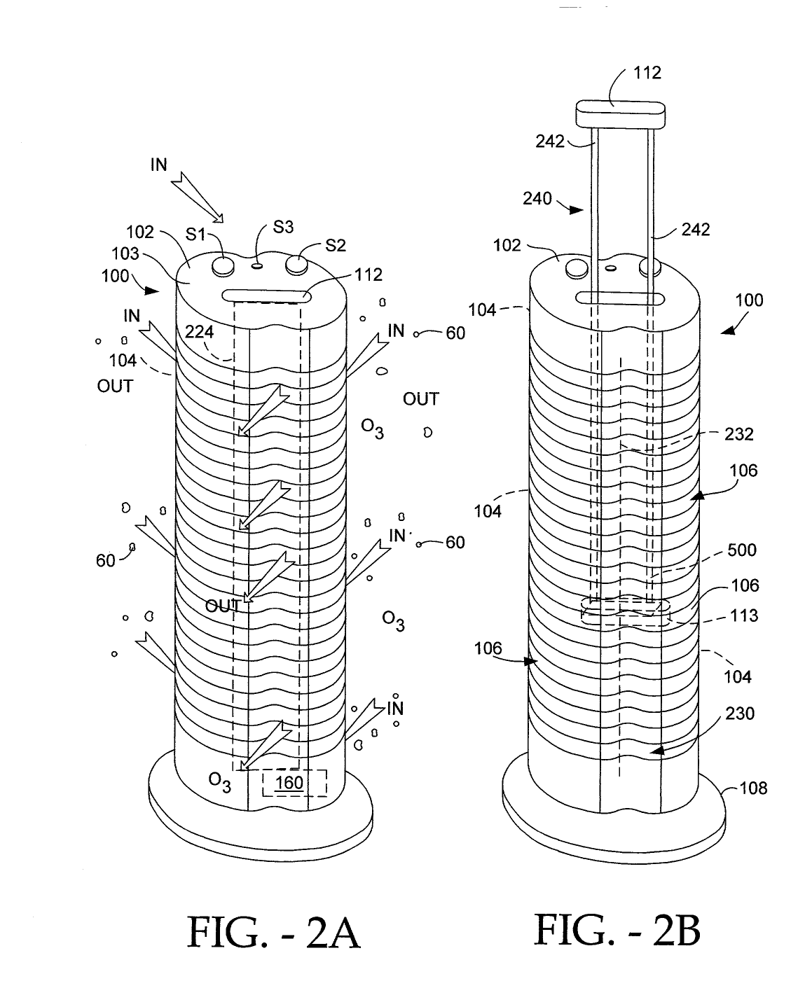

### DETAILED DESCRIPTION OF THE PRESENT INVENTION

Overall Air Transporter-Conditioner System Configuration:

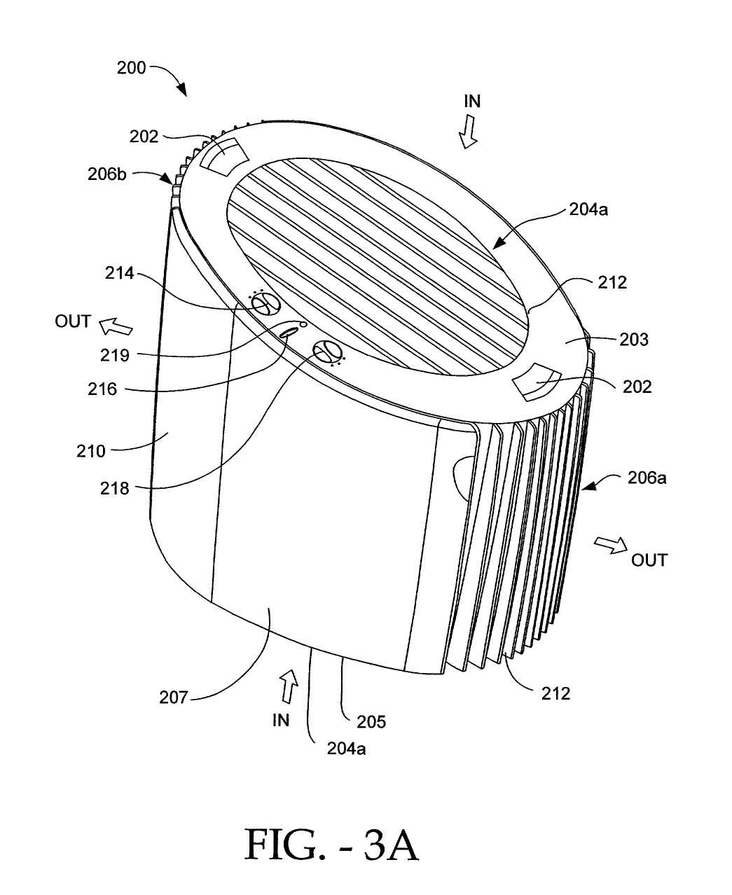

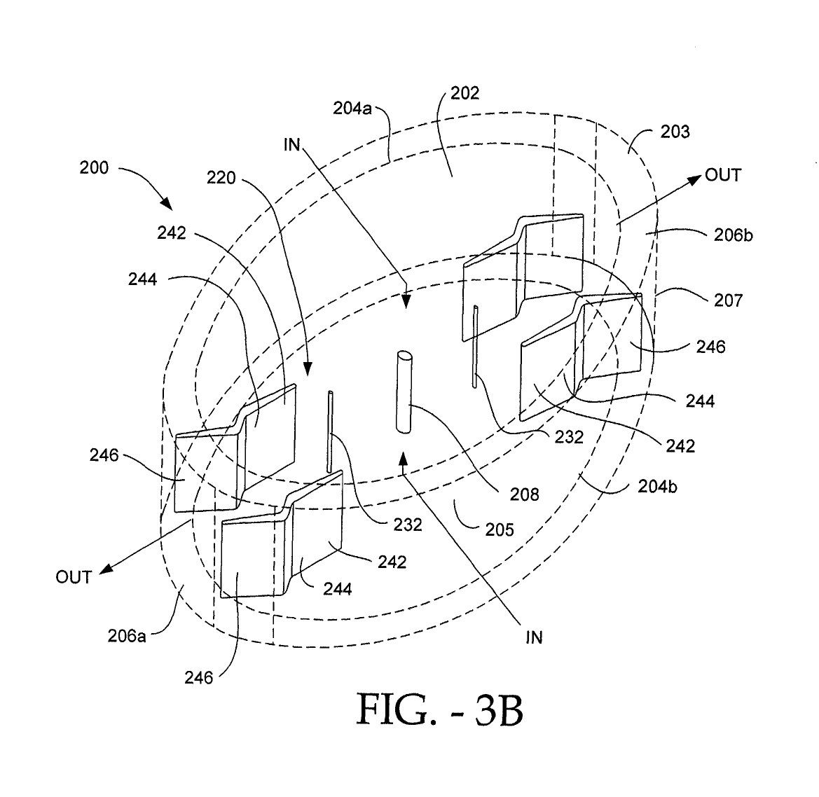

FIGS. 2A and 2B depict an electro-kinetic air transporter-conditioner system 100 whose housing 102 includes preferably rear-located intake vents or louvers 104 and preferably front located exhaust vents 106, and a base pedestal 108. Preferably the housing is freestanding and/or upstandingly vertical and/or elongated. Internal to the transporter housing is an ion generating unit 160, preferably powered by an AC:DC power supply that is energizable or excitable using switch S1. Switch S1, along with the other below described user operated switches, is conveniently located at the top 103 of the unit 100. Ion generating unit 160 is self-contained in that other than ambient air, nothing is required from beyond the transporter housing, save external operating potential, for operation of the present invention.

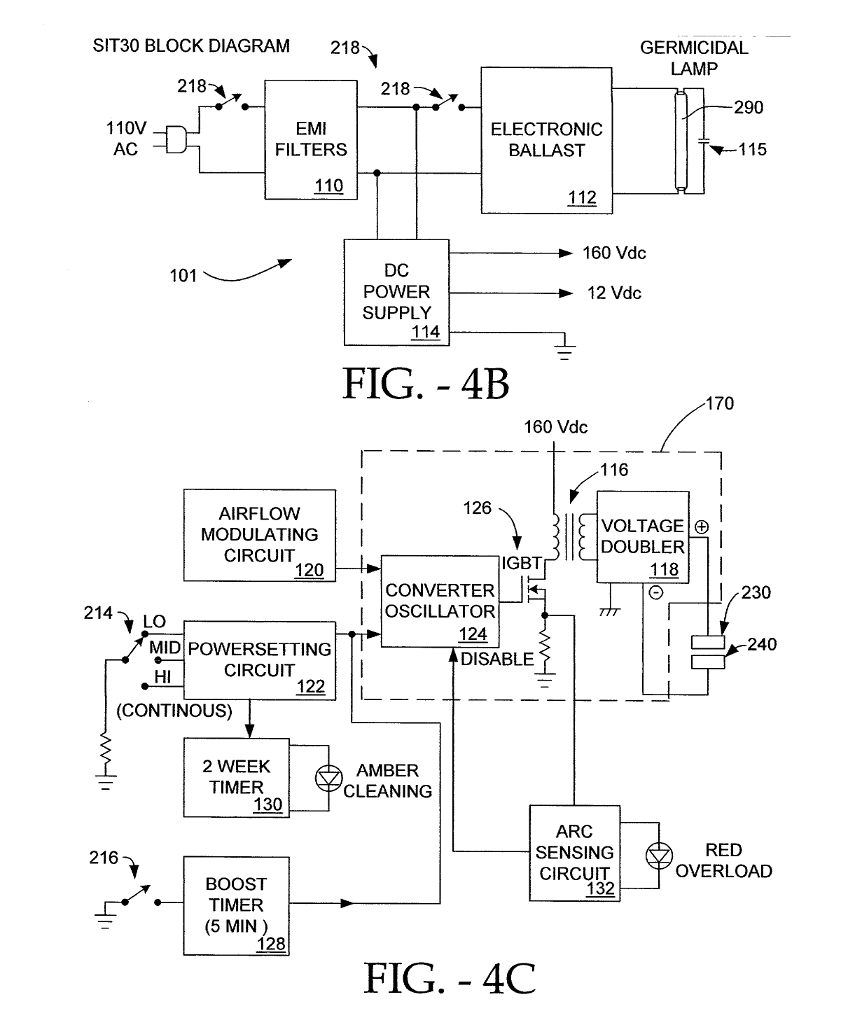

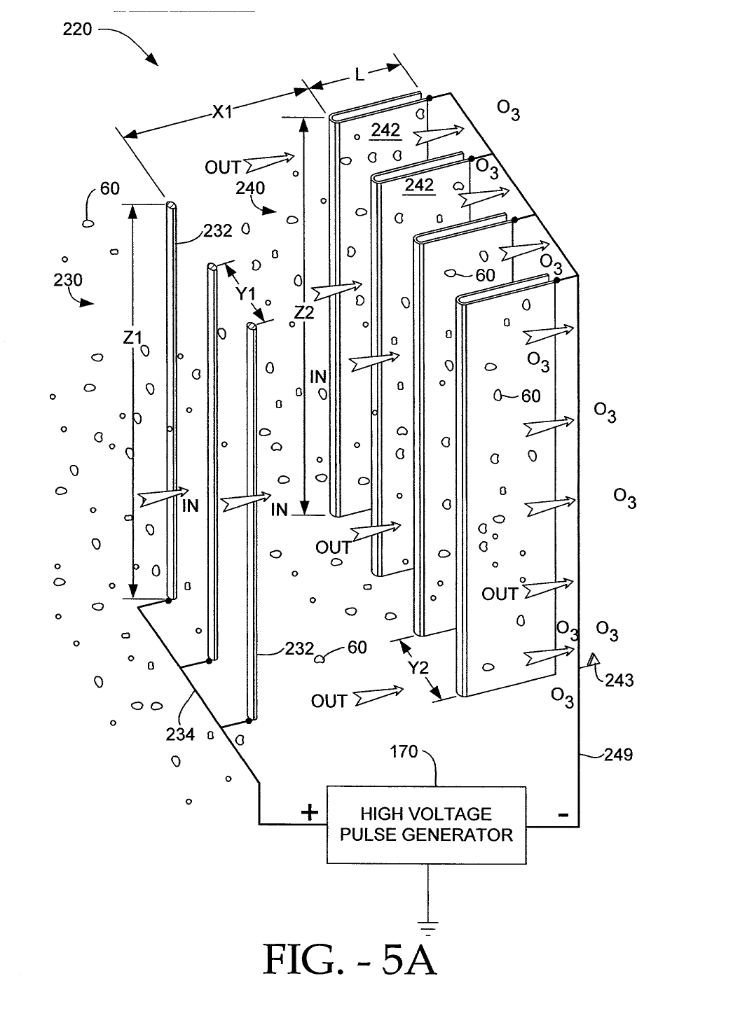

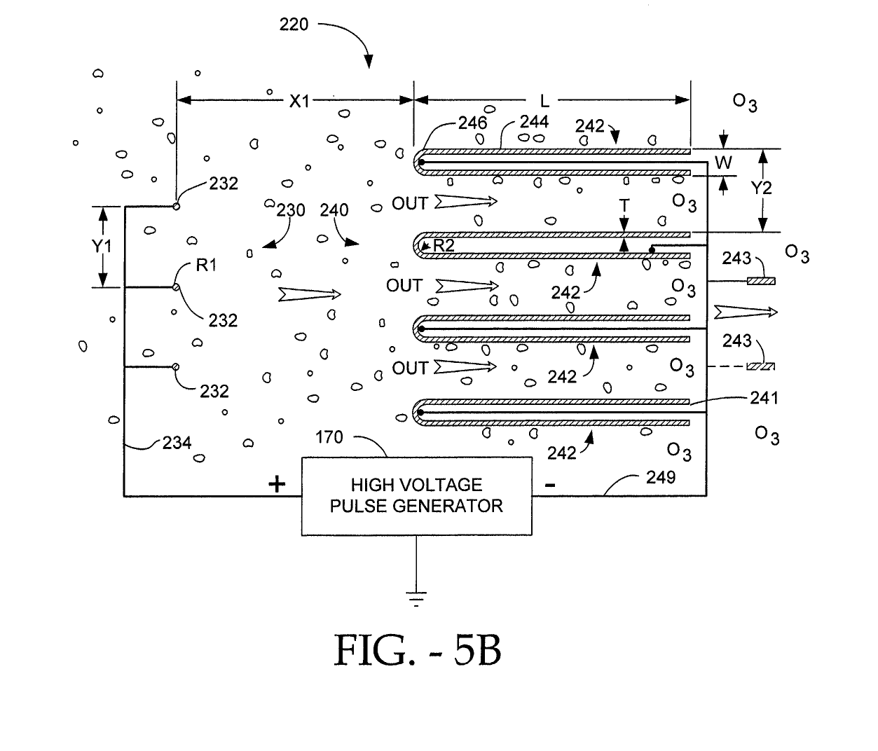

The upper surface 103 of housing 102 includes a user-liftable handle member 112 to which is affixed a second array 240 of collector electrodes 242. The housing 102 also contains a first array of emitter electrodes 230, or a single first electrode shown here as a single wire or wire-shaped electrode 232. (The terms “wire” and “wire-shaped” shall be used interchangeably herein to mean an electrode either made from a wire or, if thicker or stiffer than a wire, having the appearance of a wire.) In the embodiment shown, lifting member 112 lifts second array electrodes 240 upward, causing the second electrode to telescope out of the top of the housing 102 and, if desired, out of unit 100 for cleaning, while the first electrode array 230 remains within unit 100. As is evident from the figure, the second array of electrodes 240 can be lifted vertically out from the top 103 of unit 100 along the longitudinal axis or direction of the elongated housing 102. This arrangement with the second electrodes removable from the top 103 of the unit 100, makes it easy for the user to pull the second electrodes 242 out for cleaning. In FIG. 2B, the bottom ends of second electrodes 242 are connected to a member 113, to which is attached a mechanism 500, which includes a flexible member and a slot for capturing and cleaning the first electrode 232, whenever handle member 112 is moved upward or downward by a user. The first and second arrays of electrodes are coupled to the output terminals of ion generating unit 160, as shown in FIGS. 4A-4B.

The general shape of the embodiment of the invention shown in FIGS. 2A and 2B is that of a figure eight in cross-section, although other shapes are within the spirit and scope of the invention. The top-to-bottom height of the preferred embodiment is in one preferred embodiment, 1 m, with a left-to-right width of preferably 15 cm, and a front-to-back depth of perhaps 10 cm, although other dimensions and shapes can of course be used. A louvered construction provides ample inlet and outlet venting in an economical housing configuration. There need be no real distinction between vents 104 and 106, except their location relative to the second electrodes. These vents serve to ensure that an adequate flow of ambient air can be drawn into or made available to the unit 100, and that an adequate flow of ionized air that includes appropriate amounts of O₃ flows out from unit 100.

As will be described, when unit 100 is energized with S1, high voltage or high potential output by ion generator 160 produces ions at the first electrode, which ions are attracted to the second electrodes. The movement of the ions in an “IN” to “OUT” direction carries with the ions air molecules, thus electro-kinetically producing an outflow of ionized air. The “IN” notation in FIGS. 2A and 2B denote the intake of ambient air with particulate matter 60. The “OUT” notation in the figures denotes the outflow of cleaned air substantially devoid of the particulate matter, which particulates matter adheres electrostatically to the surface of the second electrodes. In the process of generating the ionized airflow appropriate amounts of ozone (O₃) are beneficially produced. It may be desired to provide the inner surface of housing 102 with an electrostatic shield to reduces detectable electromagnetic radiation. For example, a metal shield could be disposed within the housing, or portions of the interior of the housing can be coated with a metallic paint to reduce such radiation.

Dual Inlet and Dual Outlet Electro-Static Air Transporter-Conditioner:

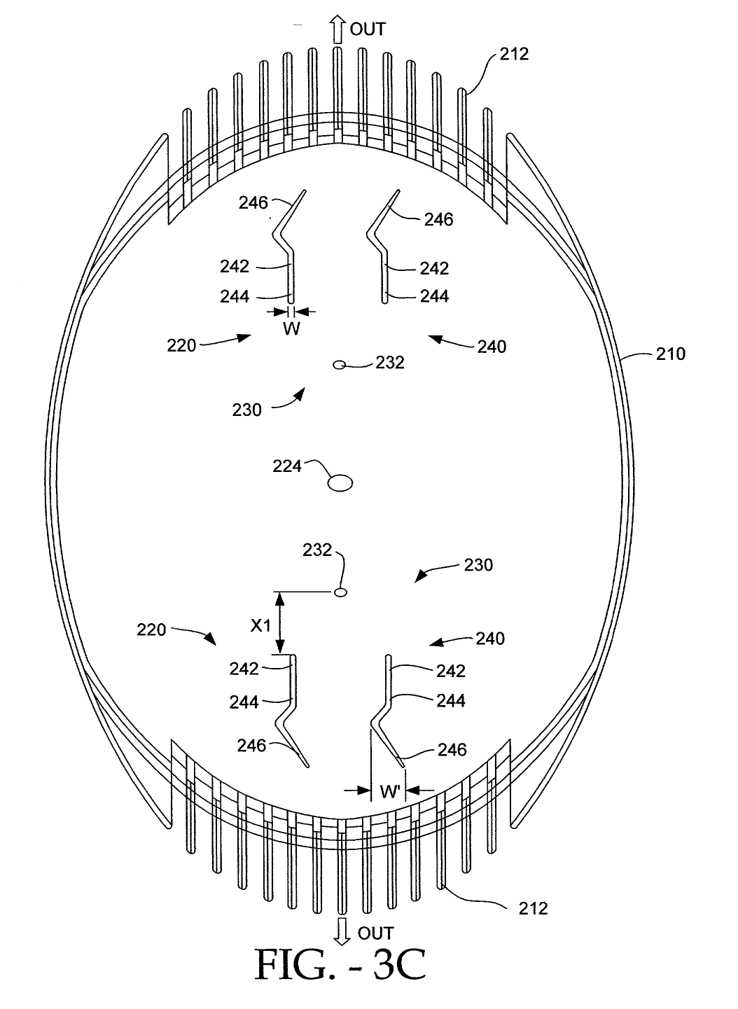

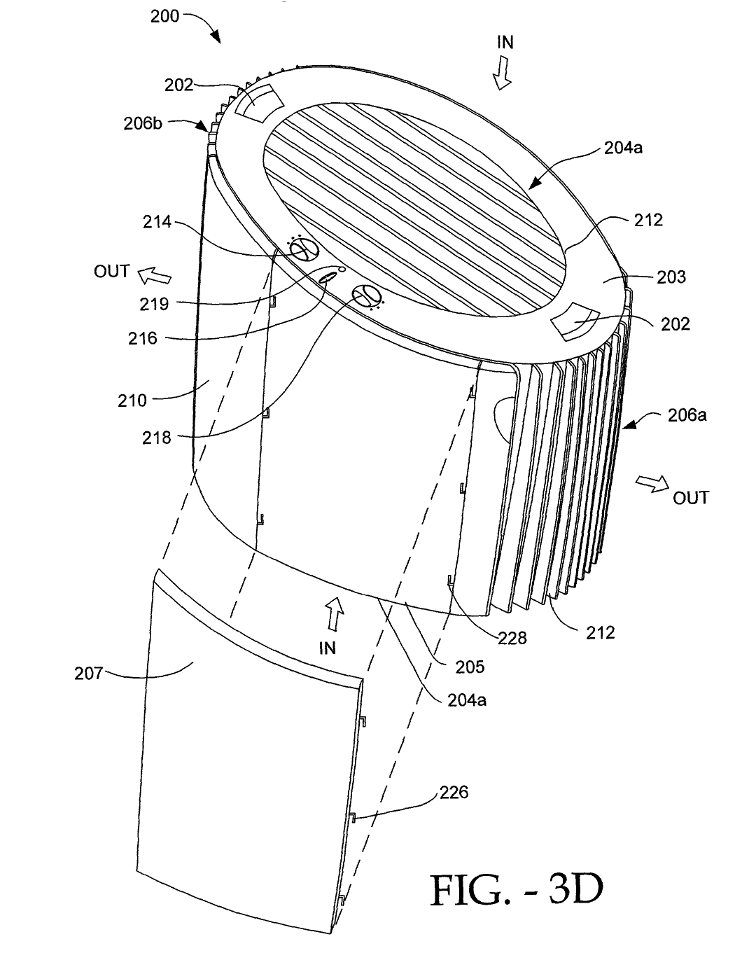

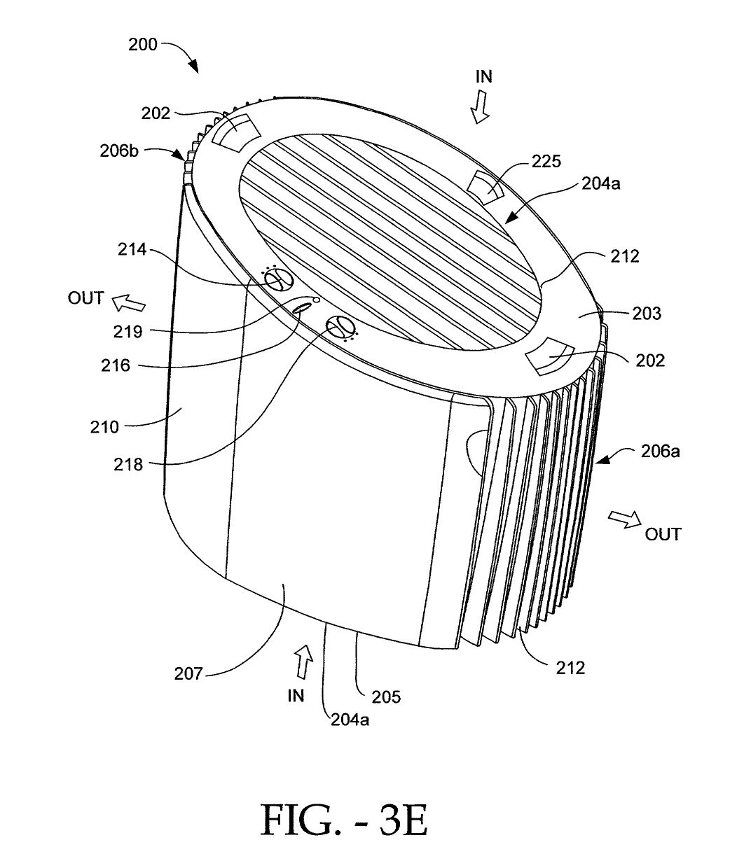

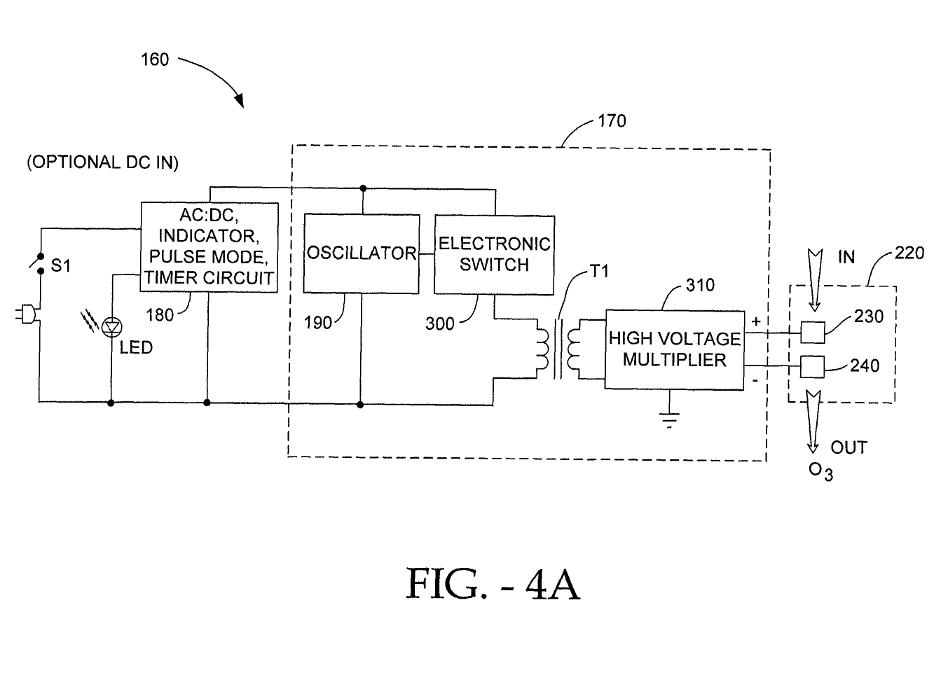

Referring now to FIGS. 3A-3B, the unit 200 has a housing 210 with two intake areas 204a and 204b and two exit areas 206a and 206b. The housing 210 is preferably manufactured from ABS plastic. Housing 210 is preferably substantially shorter than the housing of unit 100. However, the unit 200 has a substantially larger body (i.e. the cross-section in plan view is substantially larger) in order, as described below to, accommodate two ion generating units. With two ion generating units, more particles can be removed from the airflow with lower or no increase in voltage or voltage differential across the electrodes of the ion generating units and with thus less generation of ozone. It is within the scope and spirit of the present invention to manufacture the housing 210 from other material such as, but not limited to, aluminum or stainless steel. If the housing 210 contains a germicidal lamp 290 (to be described later), the housing 210 must be manufactured from a material that will not deteriorate or degrade from exposure to ultraviolet light. By way of example only, such material may be CYCOLAC® ABS plastic, manufactured by General Electric Plastics.

A first inlet area or vent 204a is located on the top surface 203 of the housing 210, and a second inlet area or vent 204b is located on the bottom surface 205 of the housing 210. It is to be understood that with a bottom inlet the housing has legs (not shown) which elevate the housing above the surface upon which it rests. Preferably, the first inlet vent 204a is located in the center of the top surface 203. Similarly, the second inlet vent 204b is preferably located in the center of the bottom 205. As is evident from the FIG. 3A the inlets cover a large part of the area of the top of the housing and the bottom of the housing. In particular in this embodiment, only a peripheral margin of the top of the housing does not comprise an inlet. The same is true of the inlet in the bottom of the housing. These large inlets allow for an increased volume of airflow. Further, in the peripheral margin of the top surface are located the controls and indicators and the handle for removing the second collector electrode of the ion generators and in another embodiment the germicidal lamps. As will become apparent later, the air is preferably brought into the center of the housing 210 with the two electrode assemblies 220 (to be described later) located downstream towards the outlet vents 206a and 206b. The inlet vents 204a and 204b are located “upstream” of each of the two electrode assembly 220 so that in a preferred embodiment the air travels the shortest path possible between the inlet and outlet. The outlet vents 206a, 206b are preferably located directly downstream of each ion generator so that the airflow created by each electrode assembly 220 may have a separate exit out of the housing 210. The outlet vents are located through the side peripheral wall of the housing between the top and bottom. Preferably the outlet vents are located at the ends of the oval-shaped housing. The outlet can extend around the ends to the flatter side of the oval if necessary to increase the volume of air that flows therethrough in order to match the intake of air through the inlet vents. The inlet vents 204a, 204b as shown in FIGS. 3A-3B are elliptical or oval in shape. It is within the scope of the present invention for the inlet vents 204a, 204b to include other shapes such as, but not limited to, circular, rectangular, and hexagonal. Air entering the unit 200 is shown by the large arrow labeled “IN.” Air exiting the unit 200 is shown by a large arrow labeled “OUT”. The two inlet vents 204a, 204b allows, a greater volume of air to enter the unit 200. As previously mentioned, the air contains particles, such as dust, which are removed by the unit 200. The more air conditioned or cleaned by the unit 200, the greater the number of particles removed from the air.

As indicated above the unit 200 also has two outlet vents to provide an outlet for each ion generator disposed within the housing 200. The two outlet vents 206a, 206b are located along the side wall 207, and are preferably opposite one another. The air passing through the housing 210 could be conditioned and/or cleaned by a single electrode assembly 220 as in previous air conditioners (see FIGS. 2A-2B). However, a single electrode assembly 220 will not efficiently condition/clean the increased volume of air brought into the housing 210 through the two inlet vent 204a, 204b. By way of example only, the increased airflow can pass more particles through the electrode assembly 220. Accordingly, in a preferred embodiment, and as indicated above, the housing 210 contains two electrode assemblies 220 to efficiently condition/clean the increased airflow.

Both the inlet vents 204a, 204b and the outlet vent 206a, 206b are partially covered by fins or louvers 212. Each fin 212 is a thin ridge, spaced-apart from the next fin 212, so that each fin 212 creates minimal resistance as air flows through the housing 210. In this embodiment, as in the embodiment of FIGS. 3A, the fins 212 covering the inlet vents 204a and 204b are aligned along the long axis of the oval or elliptical cross-section of the housing 210. This configuration does not allow an individual to look side-to-side through the inlet 204a or 204b and directly view the inner side wall 211. The fins 212 covering the outlet vents 206a and 206b are preferably elongated and vertically oriented and parallel to the upstanding housing 210 of the unit and the electrodes, and particularly and preferably are parallel to the second collector electrodes (described below) within the electrode assembly. Accordingly in a preferred embodiment the inlet louvers, the outlet louvers, and the second collector electrodes are all parallel. Of course none of the above could be parallel in other embodiments of the invention. The outlet fins are aligned to give the unit 200 a “see through” appearance. Thus, a user can “see through” the unit 200 by looking into outlet 206a and out of the outlet 206b or vice versa. The user will see no moving parts within the housing 210, but just a quiet unit that cleans air passing therethrough.

An electro-kinetic air transporter-conditioner having two intake areas 204a, 204b is an improvement over previous models. An electro-kinetic air conditioner-transporter draws air into the housing 210 at a fixed volumetric air rate (ft³/sec). The volumetric air rate is proportional to the area of the inlet of the housing 202. For example, as shown in FIG. 2A-2B, the volumetric air rate of this embodiment is proportional to the area of the inlet 104. The volumetric air rate of unit 100 is constrained by the area of the single inlet 104. In contrast, the embodiment in FIG. 3A has two inlets 204a, 204b. Accordingly, if the airflow velocity is similar between the embodiments shown in FIGS. 2A and 3A, the embodiment of unit 200, as shown in FIG. 3A, will draw more air into the housing 210. Since more air can travel through the housing 210 shown in FIG. 3A, particles are brought into the housing 210, and collected by the electrode assembly 220, in a quicker fashion than a unit with only a single inlet and outlet.

This phenomenon can also be explained by an enlarged catchment area formed around the housing 210. A catchment area is defined as the horizontal planar area at the height of the top surface 203 or the bottom surface 205 of the housing 210. The catchment area is where a rising stream of smoke will be drawn into the housing 210 through the inlet vents 204a or 204b, instead of continuing vertically into the room. The catchment radius R is the distance between the outer edge of the inlet vents 204a or 204b of the device 200 and the outer margin of the catchment area. The catchment radius R of an air transporter-conditioner as shown in FIGS. 2A-2B extends only a few inches upstream from the intake of the device. The catchment area of the unit 200, as shown as R in FIG. 3B, extends approximately three times farther from the intake of prior devices. Further, the presence of catchment areas on each of the two sides 203, 205 of the housing 210 essentially doubles the effectiveness of the unit 200 in comparison to other transporter-conditioners.

With two larger inlet vents 204a, 204b, the intake air flows more slowly than it would be if it were funneled and accelerated through a single inlet. This means that less energy is needed to move air through the intakes 204a, 204b, or alternatively, that for a given energy expenditure, more air is moved. Since energy required to maintain air velocity is proportional to the linear airflow velocity, energy savings is realized. Alternatively, additional volumemetric airflow, for a given energy expenditure, can result in energy savings. With larger inlets and outlets, there is more airflow without increasing the voltage or voltage potential across the electrode of the ion generating unit. In another embodiment, increased airflow can be realized with an increased voltage potential across the ion generator unit. However, this may require greater energy expenditure and may generate more ozone. In the present embodiment with dual ion generation units, and with dual inlets and outlets, a greater volume of air is cleaned at the same or lower voltage potential than in previous embodiments.

There are other dividends of a slow intake airflow velocity. For example, slow-moving particles suspended in the intake air are likely to be captured on the trailing sides 244 of the collector electrodes 242 before the airflow exits the unit 200. A longer dwell time in the unit 200 also means that, if the device 200 is equipped with a germicidal U lamp 290, microbes suspended in the intake air will spend more time in proximity to the lamps, and will be more effectively killed (described hereinafter).

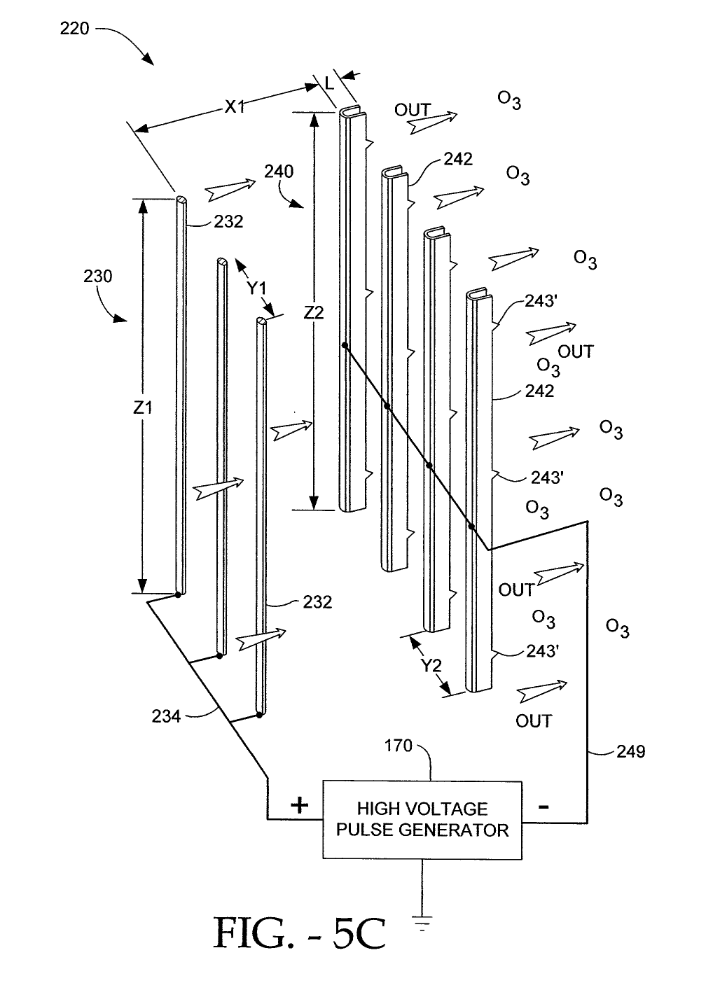

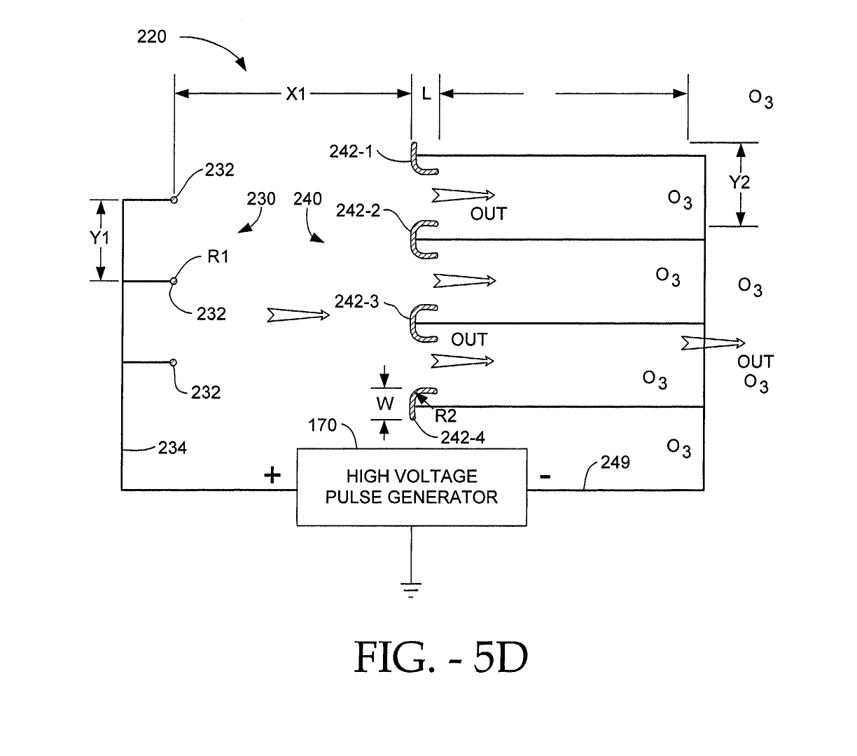

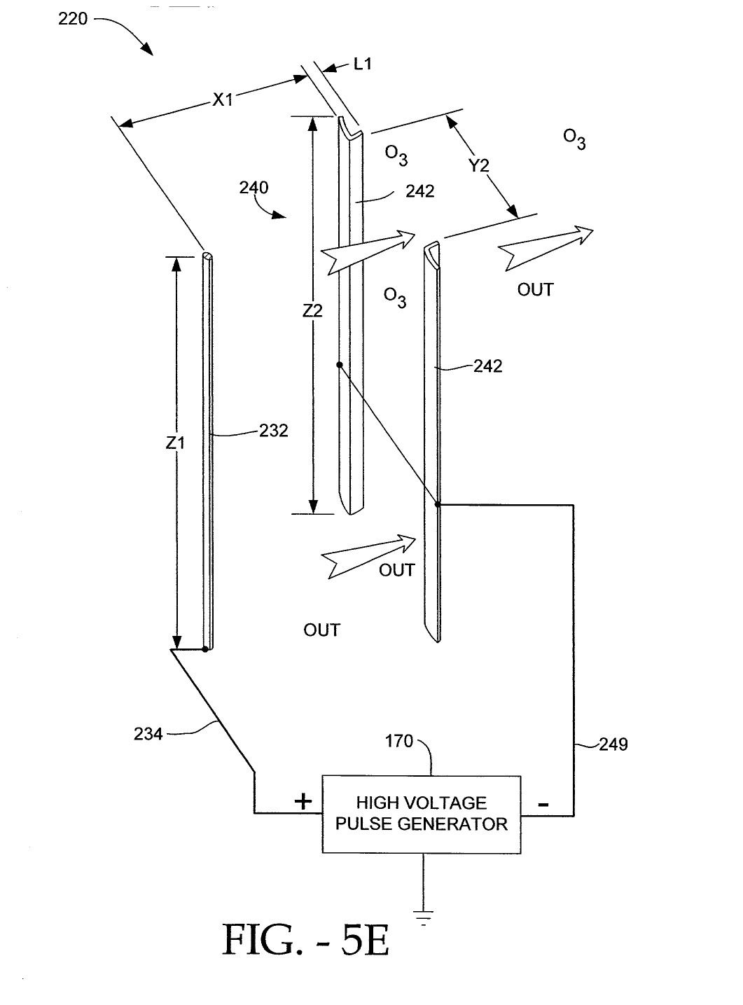

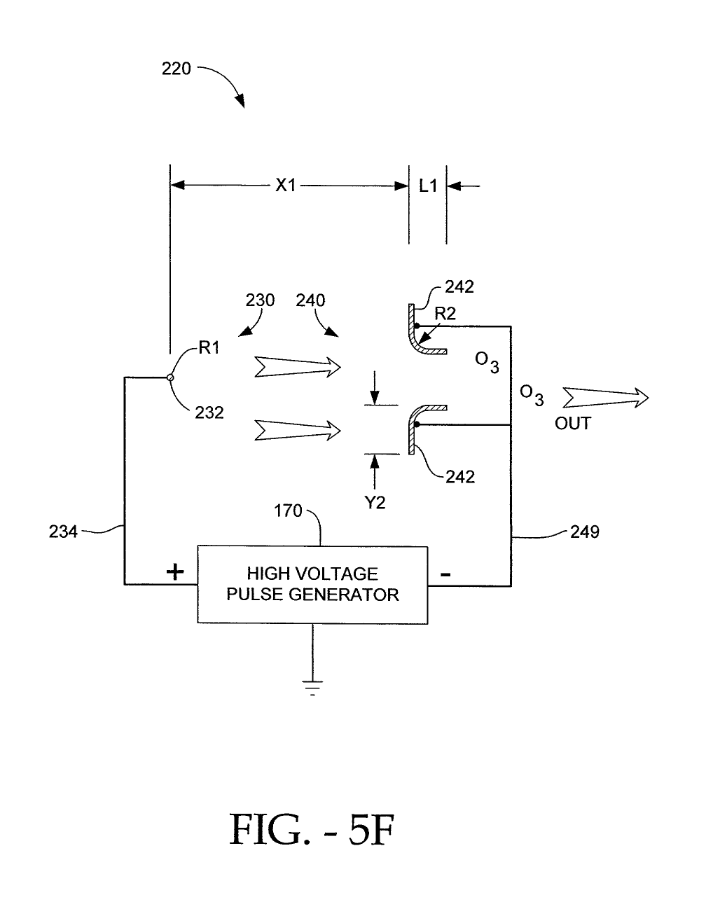

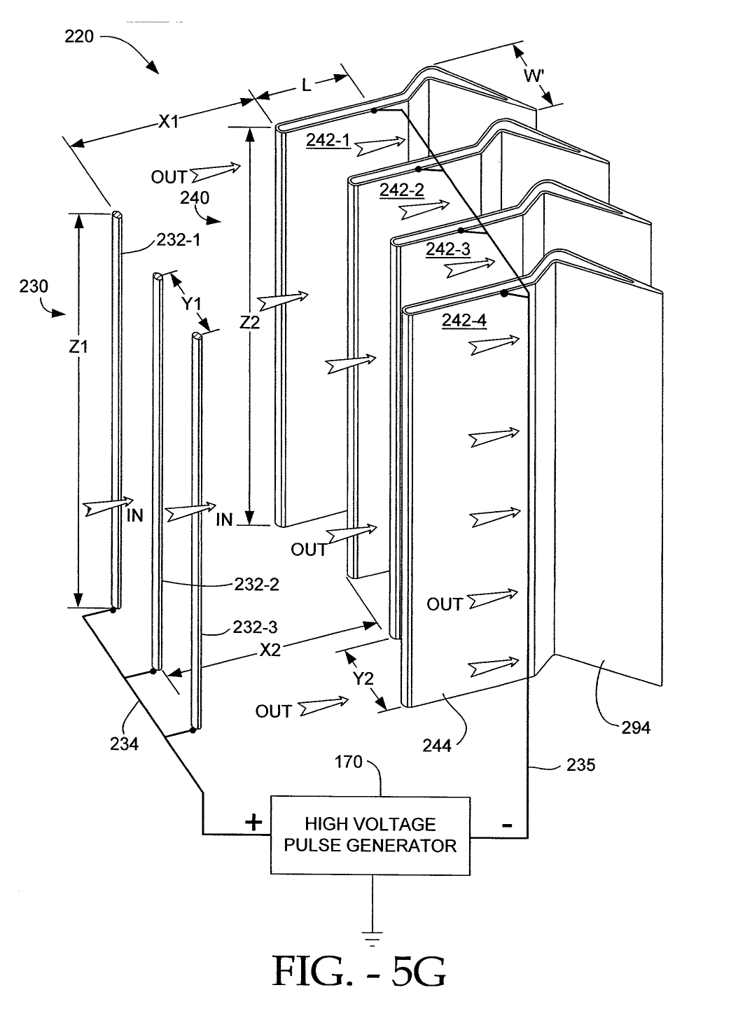

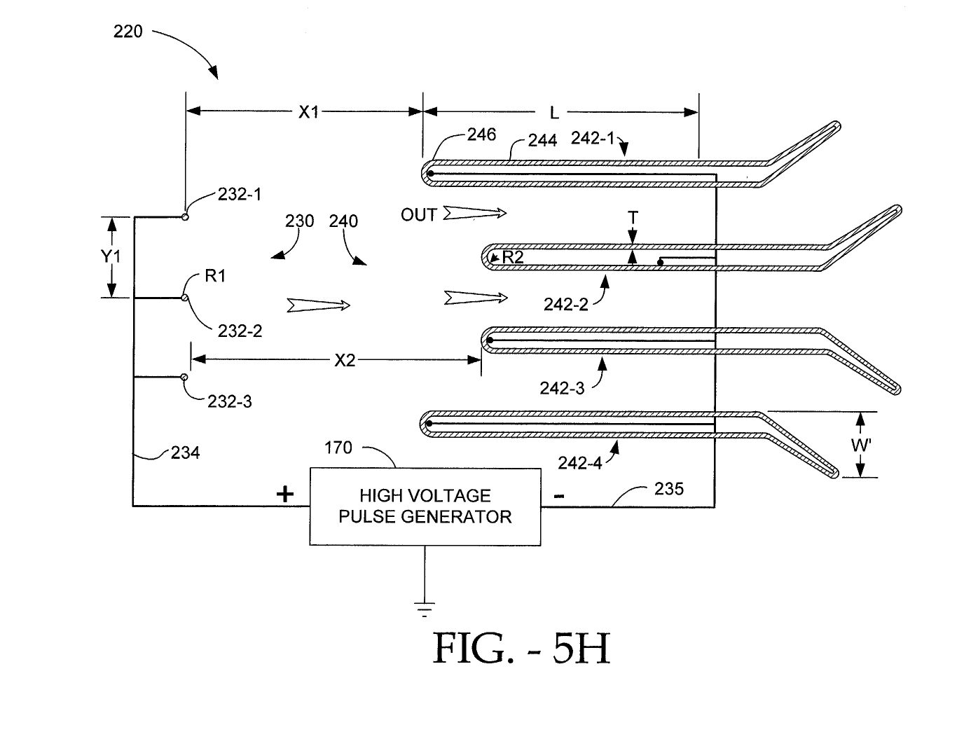

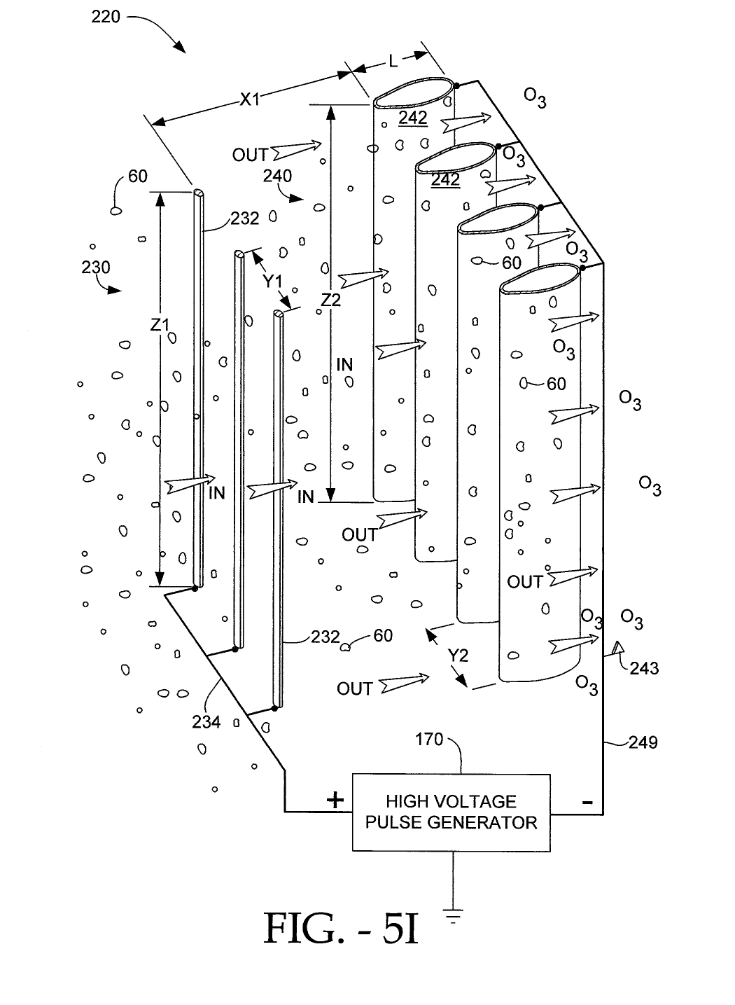

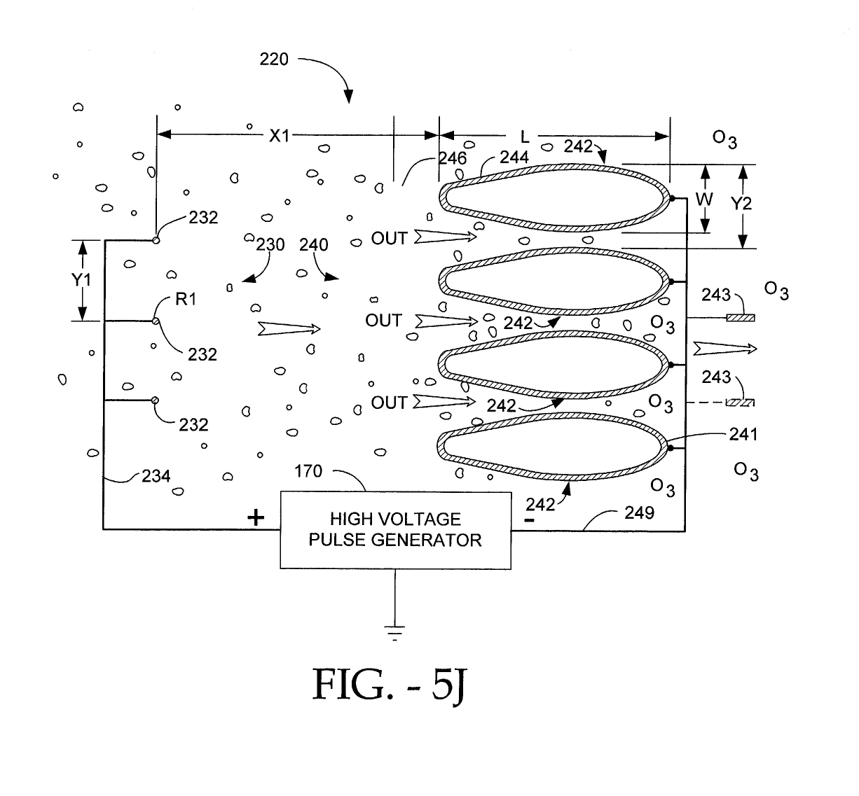

Improvements are also due to an increased cross-sectional area of the outlet vents 206a, 206b. For a given degree of air cleaning, the airflow velocity through the outlet vents 206a, 206b of the device 200 is slower than the velocity of the previous models. Preferably wider spacing between second electrodes 242 gives rise to a greater total cross-sectional outlet 206a, 206b, and the presence of two separate outlet vents 206a, 206b effectively doubles the outflow. Increasing the spacing between electrodes 242 slightly diminishes the linear outflow velocity. It is believed, however, that the gain in airflow cross-sectional area is increased substantially more than the reduction in flow velocity. For example, widening the distance Y2 (see FIG. 5A) from 1″ to 1.25″ was found to reduce the airflow velocity by less than 5%, while the cross-sectional area of the airflow was increased by 25%.

FIG. 3A further illustrates the operating controls for the device 200 on the peripheral margin. The following discussions can be more fully appreciated in conjunction with the electrical schematic of FIGS. 4A and the accompanying description.

Located on top surface 203 of the housing 210 is an airflow speed control dial 214, a boost button 216, a function dial 218, and a cleaning/overload light 219. The airflow speed control dial 214 has three settings from which a user can choose: LOW, MEDIUM, and HIGH. The airflow rate is proportional to the voltage differential between the electrodes or electrode arrays in the ion generators. The LOW, MEDIUM, and HIGH settings generate a different predetermined voltage difference between the first and second arrays within the ion generator. For example, the LOW setting will create the smallest voltage difference, while the HIGH setting will create the largest voltage difference. The LOW setting will cause the device 200 to generate the slowest airflow rate, while the HIGH setting will cause the device 200 to generate the fastest airflow rate.

The function dial 218 enables a user to select “Ionic,” “Ionic/UV,” or “Off” When the function dial 218 is set to the “Ionic” setting, the unit 200 will function as an electrostatic air transporter-conditioner, creating an airflow from the inlets 204a, 204b to the outlets 206a, 206b removing the particles within the airflow. The germicidal lamp 290 (described below) does not operate when the function dial 218 is set to “Ionic.” When the function dial 218 is set to the “Ionic/UV” setting, the device 200 will function as an electrostatic air transporter-conditioner, creating an airflow from the inlets 204a, 204b to the outlets 206a, 206b, removing the particles within the airflow. In addition, the “Ionic/UV” setting activates the germicidal lamp 290 to additionally remove or kill bacteria within the airflow. The device 200 will not operate when the function dial 218 is set to the “Off” setting.

As previously mentioned, the device 200 preferably generates small amounts of ozone to reduce odors within the room. If there is an extremely pungent odor within the room, or a user would like to temporarily accelerate the rate of cleaning, the device 200 has a boost button 216. When the boost button 216 is pressed, the device 200 will temporarily increase the airflow rate to a predetermined maximum rate, and generate a higher amount of ozone. In a preferred embodiment, pressing the boost button 216 will increase the airflow rate and ozone production continuously for 5 minutes. This time period may be longer or shorter. At the end of the preset time period (e.g., 5 minutes), the device 200 will return to the airflow rate previously selected by the control dial 214.

The cleaning/overload light 219 indicates if the second electrodes 242 require cleaning, or if arcing between the first and second electrode arrays has occurred. The cleaning/overload light 219 may illuminate either amber or red in color. The light 219 will turn amber if the device 200 has been operating continuously for more than two weeks and the second array 240 has not been removed for cleaning within the two week period. The amber light is controlled by the two week time circuit 130 (see FIG. 4B) which is connected to the power setting circuit 122. The device 200 will continue to operate after the light 219 turns amber. The light 219 is only an indicator. To reset the light 219, the second array 240 must be removed completely from the unit 200, and then placed back into the unit 200. The timer circuit 130 (see FIG. 4B) will reset and begin counting a new two week period.

The light 219 will turn red to indicate that arcing has occurred between the first array 230 and the second array 240 as sensed by a sensing circuit 132. When arcing occurs, the device 200 will automatically shut itself off. The device 200 cannot be restarted until the device 200 is reset. For the device 200 to be reset, the second array 240 may be removed from the housing 210, preferably after the unit is turned off. The second electrode array 240 should then be cleaned and placed back into the housing 210. After placing the second array 240 back into the housing 202, turn the unit 200 on and if no arcing occurs this time, the device 200 will operate and generate an airflow. If the arcing between the electrodes continues, the device 200 will again shut itself off.

Also on the top surface of the housing are located handle 212 which are used for lifting out through the top of the housing the second collector electrodes of the ion generating electrode assembly units for cleaning. This is accomplished in much the same manner as the second collector electrode are removed from the unit 100 depicted in FIG. 2B.

Dual Ion Generating Units for Dual Inlet and Dual Outlet Air Transporter-Conditioner:

Referring now to FIG. 3C, the housing 210 contains two ion generators 220. Preferably, both ion generators 220 are similar. It is within the scope and spirit of the invention for the ion generators 220 to have different configurations. Byway of example, and as shown in FIG. 3C, each ion generator 220 has a first array of electrodes 230 including a single wire-shaped electrode 232, and a second array of electrodes 240 including two “U”-shaped electrodes 242 having a tail section 246. The tail sections 246 can be directed in the same direction and be parallel as depicted, or the tail sections can be configured to diverge from each other in order to form a “V” or “Y” configuration adjacent to the outlet vents. It is within the scope of the present invention for the first and second array 230, 240 to include more than one electrode and also to comprise other configurations as described below (see FIGS. 5A-13C). Thus, any of the other many ion generator units described and depicted below can be substituted for the ion generating units depicted in FIG. 3C. Located between the two ion generators 220 is a focus or leading electrode 224 (described hereinafter). In this case, the two ion generating units 220 share a focus electrode 224. However, in other embodiments the focus electrode 224 can be eliminated or the ion generating unit can have multiple focus electrodes.

In the various electrode assemblies to be described herein, the first electrode 232 is preferably fabricated from tungsten. Tungsten is sufficiently robust to withstand cleaning, has a high melting point to retard breakdown due to ionization, and has a rough exterior surface that seems to promote efficient ionization. On the other hand, second electrode 242 preferably will have a highly polished exterior surface to minimize unwanted point-to-point radiation. As such, electrodes 242 preferably are fabricated from stainless steel or brass, among other materials. The polished surface of electrodes 242 also promotes ease of electrode cleaning. Understandably, the material for electrodes 232 and 242 should conduct electricity, be resistant to corrosive effects from the application of high voltage, yet be strong enough to be cleaned.

In contrast to the prior art electrodes disclosed by the '801 patent, electrodes 232 and 242, are light weight, easy to fabricate, and lend themselves to mass production. Further, electrodes 232 and 242 described herein promote more efficient generation of ionized air, and appropriate amounts of ozone, (indicated in several of the figures as O₃).

Electrical Circuit for the Electro-Kinetic Device:

As best seen in FIG. 4A, ion generating unit 160 for the embodiment of FIGS. 2A-3C includes a high voltage generator unit 170 and circuitry 180 for converting raw alternating voltage (e.g., 117 VAC) into direct current (“DC”) voltage. Circuitry 180 preferably includes circuitry controlling the shape and/or duty cycle of the generator unit output voltage (which control is altered with user switch S2). Circuitry 180 preferably also includes a pulse mode component, coupled to switch S3, to temporarily provide a burst of increased output ozone. Circuitry 180 can also include a timer circuit and a visual indicator such as a light emitting diode (“LED”). The LED or other indicator (including, if desired, an audible indicator) signals when ion generation quits occurring. The timer can automatically halt generation of ions and/or ozone after some predetermined time, e.g., 30 minutes.

The high voltage generator unit 170 preferably comprises a low voltage oscillator circuit 190 of perhaps 20 KHz frequency, that outputs low voltage pulses to an electronic switch 300, e.g., a thyristor or the like. Switch 300 switchably couples the low voltage pulses to the input winding of a step-up transformer T1. The secondary winding of T1 is coupled to a high voltage multiplier circuit 310 that outputs high voltage pulses. Preferably the circuitry and components comprising high voltage pulse generator 170 and circuit 180 are fabricated on a printed circuit board that is mounted within housing 102.

Output pulses from high voltage generator 170 preferably are at least 10 KV peak-to-peak with an effective DC offset of, for example, half the peak-to-peak voltage, and have a frequency of, for example, 20 KHz. Frequency of oscillation can include other values, but frequency of at least about 20 KHz is preferred as being inaudible to humans. If pets will be in the same room as the unit 100, it maybe desired to utilize and even higher operating frequency, to prevent pet discomfort and/or howling by the pet. The pulse train output preferably has a duty cycle of for example 10%, which will promote battery lifetime if live current is not used. Of course, different peak-peak amplitudes, DC offsets, pulse train wave shapes, duty cycle, and/or repetition frequencies can be used instead. Indeed, a 100% pulse train (e. g., an essentially DC high voltage) maybe used, albeit with shorter battery lifetime. Thus, generator unit 170 for this embodiment can be referred to as a high voltage pulse generator. Unit 170 functions as a DC:DC high voltage generator, and could be implemented using other circuitry and/or techniques to output high voltage pulses that are input to electrode assembly 220.

As noted, outflow (OUT) preferably includes appropriate amounts of ozone that can destroy or at least substantially alter bacteria, germs, and other living (or quasi-living) matter subjected to the outflow. Thus, when switch S1 is closed and the generator 170 has sufficient operating potential, pulses from high voltage pulse generator unit 170 create an outflow (OUT) of ionized air and ozone. When S1 is closed, LED will visually signal when ionization is occurring.

Preferably operating parameters of unit 100 are set during manufacture and are generally not user-adjustable. For example, with respect to operating parameters, increasing the peak-to-peak output voltage and/or duty cycle in the high voltage pulses generated by unit 170 can increase the airflow rate, ion content, and ozone content. These parameters can be set by the user by adjusting switch S2 as disclosed below. In the preferred embodiment, output flow rate is about 200 feet/minute, ion content is about 2,000,000/cc and ozone content is about 40 ppb (over ambient) to perhaps 2,000 ppb (over ambient). Decreasing the ratio of the radius of the nose of the second electrodes to the radius of the first electrode or decreasing the ratio of the cross-sectioned area of the second electrode to the first electrode below about 20:1 will decrease flow rate, as will decreasing the peak-to-peak voltage and/or duty cycle of the high voltage pulses coupled between the first and second electrode arrays.

In practice, unit 100 is placed in a room and connected to an appropriate source of operating potential, typically 117 VAC. With S1 energizing ionization unit 160, systems 100 emits ionized air and preferably some ozone via outlet vents 106. The airflow, coupled with the ions and ozone freshens the air in the room, and the ozone can beneficially destroy or at least diminish the undesired effects of certain odors, bacteria, germs, and the like. The airflow is indeed electro-kinetically produced, in that there are no intentionally moving parts within unit 100. (Some mechanical vibration may occur within the electrodes.).

Dual Ion Generating Unit Embodiment with Germicidal Lamp:

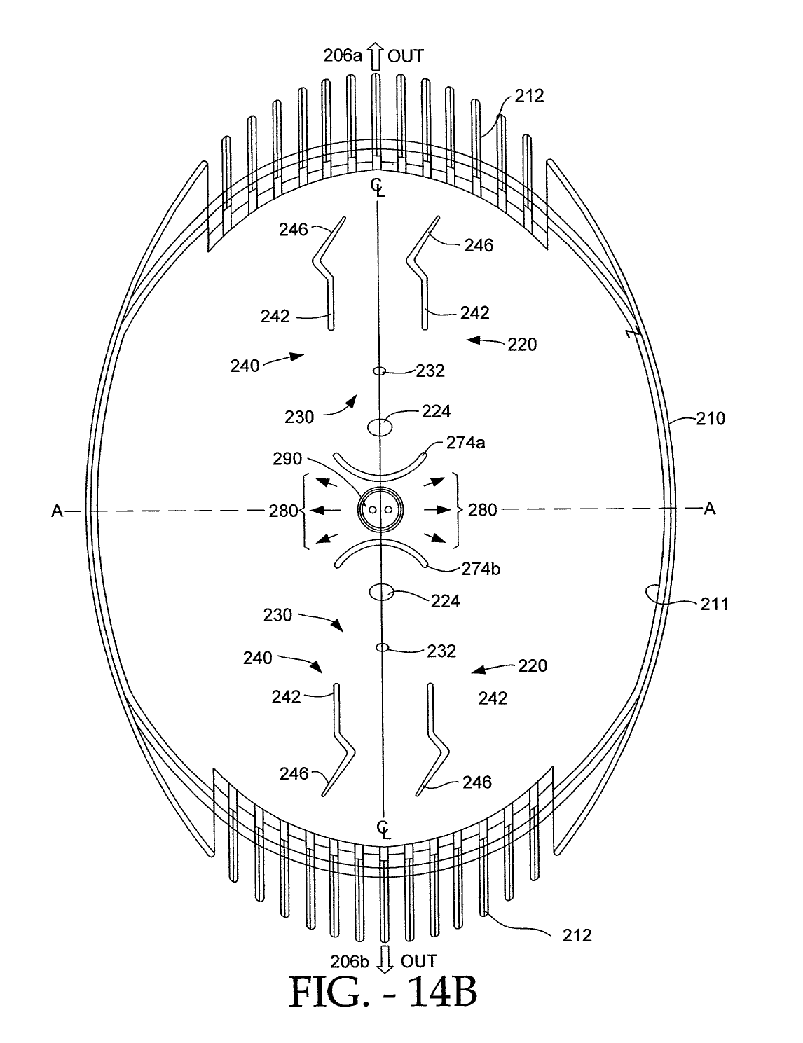

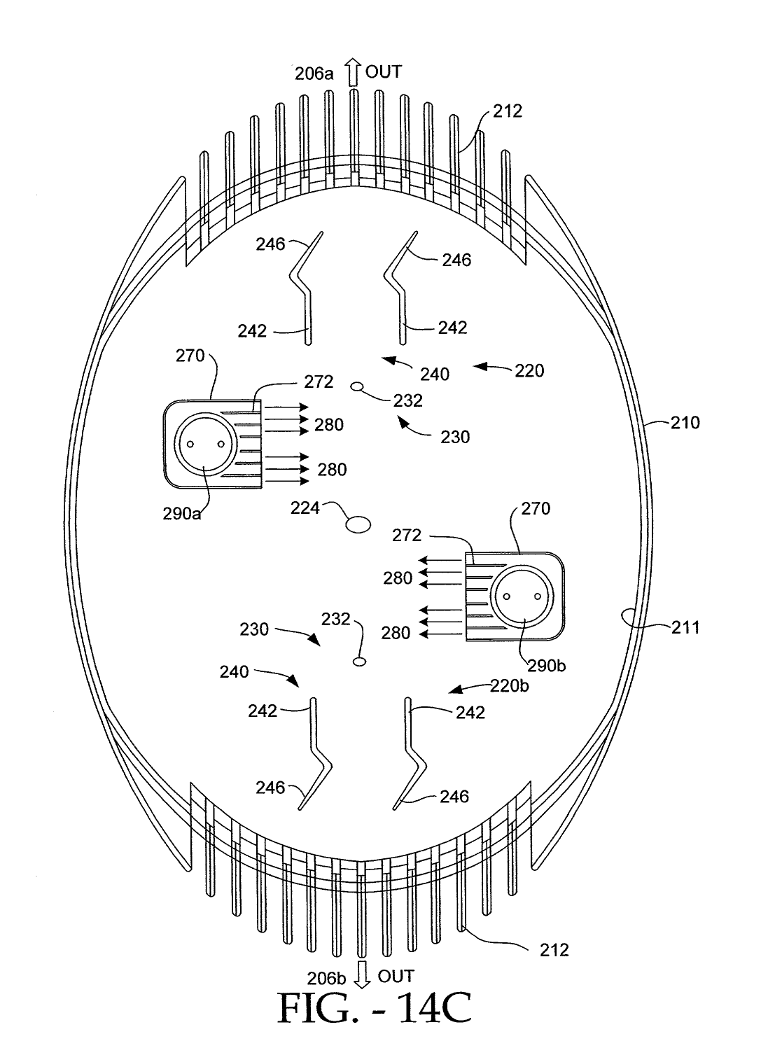

FIGS. 14A-14B

FIGS. 14A-14B illustrate that the unit 200 may also include a germicidal lamp 290 to further reduce or kill bacteria within the airflow. The germicidal lamp 290 is preferably a UV-C lamp that emits viewable light and radiation (in combination referred to as radiation or light 280) having wavelength of about 254 nm. This wavelength is effective in diminishing or destroying bacteria, germs, and viruses to which it is exposed. Lamps 290 are commercially available. For example, the lamp 290 may be a Phillips model TUO 25W/G25 T8, a 25 W tubular lamp measuring about 25 mm in diameter by about 43 cm in length. Another suitable lamp is the Phillips TUO 8WG8 T6, an 8 W lamp measuring about 15 mm in diameter by about 29 cm in length. Other lamps that emit the desired wavelength can instead be used.

As previously mentioned, one role of the housing 210 is to prevent an individual from viewing, byway of example, ultraviolet (UV) radiation generated by the germicidal lamp 290 disposed within the housing 210. FIGS. 14A-14B illustrate preferred locations of the germicidal lamp 290 within the housing 210. FIGS. 14A-14B further show the spacial relationship between the germicidal lamp 290 and the electrode assembly 220, and the germicidal lamp 290 and the inlet 250 and the outlet 260 and the inlet and outlet louvers 212.

In a preferred embodiment, the inner surface 211 of the housing 210 diffuses or absorbs the UV radiation emitted from the lamp 290. By way of example only, the inner surface 211 of the housing 210 can be formed with a non-smooth finish, or a non-radiation reflecting or radiation absorbing finish or color, to also prevent the UV radiation from exiting through either the inlet 250 or the outlet 260.

As discussed above, the fins 212 covering the inlet 250 and the outlet 260 also limit any line of sight of the user into the housing 210. The fins 212 covering the outlets are vertical. The fins 212 covering the inlets 204a, 204b are horizontal. Preferably, the fins 212 covering the inlet and the outlet are all parallel to each other and are also parallel to the second collector electrode 242 (excluding any tail portion 246 of the second collector electrode) in order to streamline the airflow. Preferably, at least the outlet fins and the second collector electrodes 242 are parallel. Thus, it can also be observed that the fins 212 covering the inlets 204a, 204b are about parallel with the sides of the housing 210. It is to be understood, however, that an embodiment of the invention also works if none of the fins and the electrodes are parallel. The depth D of each fin 212 is preferably deep enough to prevent an individual from directly viewing the portion of the interior wall 211 upon which UV radiation strikes. In a preferred embodiment, an individual cannot directly view the inner surface 211 by moving from side-to-side, while looking into either outlet vent 260a or 206b, or either inlet vent 204a or 204b. Looking between the fins 212 and into the housing 210 allows an individual to “see through” the device 200. That is, a user can look into one of the outlet vents 206a and at the other outlet vent 206b. It is to be understood that it is acceptable to see light or a glow coming from within housing 210 if the light has a non-UV wavelength. In general, an user viewing into the inlets 204a, 204b or the outlets 206a, 206b may be able to notice a light or glow emitted from within the housing 210. In general, the radiation 280 reflected off the interior surface 211 of the housing 210, has shifted from the UV spectrum. The wavelength of the radiation changes from the UV spectrum into an appropriate viewable spectrum. Thus, any light emitted from within the housing 210 is appropriate to view.

As also discussed above, the housing 210 is designed to optimize the reduction of microorganisms within the airflow. The efficacy of radiation 280 upon microorganisms depends upon the length of time such organisms are subjected to the radiation 280. Thus, the lamp 290 is preferably located within the housing 210 where the airflow is the slowest. In preferred embodiments, the lamp 290 is disposed within the housing 210 along line A-A. Line A-A designates the largest width and cross-sectional area of the housing 210, perpendicular to the airflow. The housing 210 creates a fixed volume for the air to pass through. In operation, air enters the inlets 204a and 204b which has a smaller width, and cross-sectional area, than along line A-A. Since the width and cross-sectional area of the housing at line A-A are larger than the width and cross-sectional area of the inlet 204a or 204b, the airflow will decelerate from the inlet to the line A-A. By placing the lamp 290 substantially along line A-A, the air will have the longest dwell time as it passes through the radiation 280 emitted by the lamp 290. In other words, the microorganisms within the air will be subjected to the radiation 280 for the longest period possible by placing the lamp 290 along line A-A. It is, however, within the scope of the present invention to locate the lamp 290 anywhere within the housing 210, preferably upstream of the electrode assembly 220.

A radiation-shielding shell 270 substantially surrounds the lamp 290. The lamp 290, as shown in FIGS. 14A-14C, is a circular tube parallel to the housing 210. Thus, without the shell 270, lamp radiation 280 would be emitted in all directions from the lamp 290. The shell 270 mounts to secure the lamp 290 within the housing 210. The interior surface 271 of the shell 270 can be blackened. The shell 270 has fins 272 that are spaced apart and substantially parallel to the lamp 290. The fins 272 direct the radiation 280 toward the interior wall 211 away from the inlet 204a or 204b, or the outlet 206a or 206b. The shell 270 directs the radiation towards the fins 272 for radiating the passing airflow. The shell 270 directs the radiation 280 emitted from the lamp 290 in a substantially perpendicular orientation, in a preferred embodiment, to the crossing airflow traveling through the housing 210. This directing effect prevents the radiation 280 from being emitted directly towards the inlet 204a or 204b or the outlet 206a or 206b. In other embodiments the shell 270 and the fins 272 can have reflective surfaces if desired. In the embodiment shown in FIG. 14A, the lamp 290 is located along the side of the housing 210. Thus, soon after the air passes through the inlet 204a or 204b, the air is immediately exposed to the radiation emitted by the lamp 290.

Another preferred location of the lamp 290 along line A-A is shown in FIG. 14B. Two walls 274a, 274b direct the radiation 280 away from the electrode assemblies 220, the inlets 204a and 204b, and the outlets 206a and 206b. The wall 274a is located between the lamp 290 and the electrode assembly 220a and the outlet 206a. The second wall 274b is located between the lamp 290 and the electrode assembly 220b and the outlet 206b. Both walls 274a, 274b prevent a user from directly looking through the outlets 206a and 206b and viewing the UV radiation emitted from the lamp 290. To prevent the light emitted from the lamp 290 from shining directly at the inlets 204a and 204b, the walls 274a and 274b form a cover over the top and bottom of the lamp 290. Preferably, the first and second walls 274a, 274b are curved, with the convex surface facing the lamp 290, in order to direct radiation from the lamp 290 outward toward the flow of air. It is within the scope of the present invention for the first and second walls 274a, 274b to have other shapes such as, but not limited to, “V”-shaped and concave.

FIG. 14C illustrates the unit 200 having two germicidal lamps 290 within the housing 210. In this embodiment, a first germicidal lamp 290a is located between the third focus electrode 224 and the first electrode assembly 220a and the outlet 206a. A second germicidal lamp 290b is located between the third focus electrode 206b. Each germicidal lamp 290a and 290b has a shell 270 substantially surrounding it, similar to the embodiment previously shown in FIG. 14A. It is within the spirit and scope of the present invention to incorporate the walls 274a and 274b from FIG. 14B into this embodiment, and to use other configurations to prevent the light 280 from shining directly into the inlets or outlets.

FIGS. 14A-14C illustrate embodiments of the electrode assembly 220 somewhat similar to those shown in FIGS. 5G-5H. However, it is to be understood that any of the electrode assembly configurations depicted in FIGS. 5A-13C maybe used in the device 200 depicted in FIGS. 14A-14C.

In FIG. 3D, the housing 210 has a removable side panel 207, allowing a user to access and remove the germicidal lamp 290 from the housing 210 when the lamp 290 expires. The side panel 207 has locking tabs 226 located on each side, along the entire length of the panel 224. The locking tabs 226, as shown in FIG. 3D, are “L”-shaped. Each tab 226 extends away from the panel 207 inward towards the housing 210, and then projects downward, parallel with the edge of the panel 207. It is within the spirit and scope of the invention to have differently shaped tabs 226. Each tab 226 individually and slidably interlocks with recesses 228 formed within the housing 210. The side panel 207 also has a biased lever (not shown) located at the bottom of the panel 207 that interlocks with the recess 230. To remove the panel 207 from the housing 210, the lever is urged away from the housing 210, and the panel 207 is slid vertically upward until the tabs 226 disengage the recesses 228. The panel 207 is then pulled away from the housing 210. Removing the panel 207 exposes the lamp 290 for replacement.

The panel 207 also has a safety mechanism (not shown) to shut the device 200 off when the panel 207 is removed. The panel 207 has a rear projecting tab (not shown) that engages a safety interlock recess (not shown) when the panel 207 is secured to the housing 210. Byway of example only, the rear tab depresses a safety switch located within the recess when the front panel 207 is secured to the housing 210. The device 200 will operate only when the rear tab in the panel 207 is fully inserted into the safety interlock recess. When the panel 207 is removed from the housing 210, the rear projecting tab disengages from the recess and the power is cut-off to the entire device 200. For example if a user removes the front panel 207 while the device 200 is running, and the germicidal lamp 290 is emitting UV radiation, the device 200 will turn off as soon as the rear projecting tab disengages from the recess. Preferably, the device 200 will turn off when the front panel 207 is removed only a very short distance (e.g., ¼″) from the housing 210.

FIG. 3E illustrates yet another embodiment of the housing 210. In this embodiment, the germicidal lamp 290 can be removed from the housing 210 by lifting the germicidal lamp 290 vertically out of the housing 210. Thus, the housing 210 does not need a removable side panel 202 to access the germicidal lamp 290. Instead, a handle 225 is affixed to a lamp fix fixture that holds the germicidal lamp 290. The handle 225 is located on the top surface 203 of the housing 210, when the lamp 290 is within the housing 210 similar to the handle 212 for removing the second electrodes. To remove the lamp fixture and lamp 290, the handle 225 is pulled vertically out of the housing 210. The lamp 290 is situated within the housing 210 in a similar manner to the second array of electrodes 240. That is to say, that when the lamp 290 is pulled vertically out of the top surface 203 of the housing 210, the electrical circuit that provides power to the lamp 290 is disconnected. As the handle 225 is lifted from the housing 210, a cutoff switch will shut the entire device 200 off. This safety mechanism ensures that the device 200 will not operate without the lamp 290 placed securely in the housing 210, preventing an individual from directly viewing the radiation emitted from the lamp 290. Reinserting the lamp 290 into the housing 210 causes the lamp fixture to be re-engaged with the circuit contacts as is known in the art. In similar, but less convenient fashion, the lamp 290 is designed to be removed from the bottom of the housing 210.

Electrical Circuit for the Electro-Kinetic Device:

FIGS. 4B and 4C depict an electrical schematic that is switchable for use with a germicidal lamp system.

FIGS. 4B-4C illustrate a preferred embodiment of an electrical block diagram for the electro-kinetic device 200 with enhanced anti-microorganism capability. FIG. 4A illustrates a preferred electrical block diagram of the germicidal lamp circuit 101. The main components of the circuit 101 are an electromagnetic interference (EMI) filter 110, an electronic ballast 112, and a DC power supply 114. The device 200 has an electrical power cord that plugs into a common electrical wall socket. The (EMI) filter 110 is placed across the incoming 110V AC line to reduce and/or eliminate high frequencies generated by the electronic ballast 112 and the DC Power Supply 114. The electronic ballast 112 is electrically connected to the germicidal lamp 290 to regulate, or control, the flow of current through the lamp 290. Electrical components such as the EMI Filter 110 and electronic ballast 112 are well known in the art and do not require a further description. The DC Power Supply 114 receives the 110 V AC and outputs 12VDC for the internal logic of the device 200, and 160V DC for the primary side of the transformer 116 (see FIG. 4C).

As seen in FIG. 4C, a high voltage pulse generator 170 is coupled between the first electrode array 230 and the second electrode array 240. The generator 170 receives low input voltage, e.g., 160V DC from DC power supply 114, and generates high voltage pulses of at least 5 KV peak-to-peak with a repetition rate of about 20 KHz. Preferably, the voltage doubler 118 outputs 9 KV to the first array 230, and 18 KV to the second array 240. It is within the scope of the present invention for the voltage doubler 118 to produce a greater or smaller voltage. The pulse train output preferably has a duty cycle of perhaps 10%, but may have other duty cycles, including a 100% duty cycle. The high voltage pulse generator 170 may be implemented in many ways, and typically will comprise a low voltage converter oscillator 124, operating at perhaps 20 KHz frequency, that outputs low voltage pulses to an electronic switch. Such a switch is shown as an insulated gate bipolar transistor (IGBT) 126. The IGBT 126, or other appropriate switch, couples the low voltage pulses from the oscillator 124 to the input winding of a step-up transformer 116. The secondary winding of the transformer 116 is coupled to the voltage doubler 118, which outputs the high voltage pulses to the first and second array of electrodes 230, 240. In general, the IGBT 126 operates as an electronic on/off switch. Such a transistor is well known in the art and does not require a further description.

The voltage doubler 118 preferably includes circuitry controlling the shape and/or duty cycle of the output voltage of the generator 170. The voltage doubler 118 preferably also includes a pulse mode component, controlled by the boost timer 128, to temporarily provide a burst of increased output ozone.

The converter oscillator 124 receives electrical signals from the airflow modulating circuit 120, the power setting circuit 122, and the boost timer 128. The airflow rate of the device 200 is primarily controlled by the airflow modulating circuit 120 and the power setting circuit 122. The airflow modulating circuit 120 is a “micro-timing” gating circuit. The airflow modulating circuit 120 outputs an electrical signal that modulates between a “low” airflow signal and a high” airflow signal. The airflow modulating circuit 120 continuously modulates between these two signals, preferably outputting the high” airflow signal for 2.5 seconds, and then the “low” airflow signal for 5 seconds. By way of example only, the “high” airflow signal causes the voltage doubler 118 to provide 9 KV to the first array 230, while 18 KV is provided to the second array 240, and the “low” airflow signal causes the voltage doubler 118 to provide 6 KV to the first array 230, while 12 KV is provided to the second array 240. As will be described later, the voltage difference between the first and second array is proportional to the airflow rate of the device 200. In general, a greater voltage differential is created between the first and second array by the “high” airflow signal. It is within the scope of the present invention for the airflow modulating circuit 120 to produce different voltage differentials between the first and second arrays. The various circuits and components comprising the high voltage pulse generator 170 can be fabricated on a printed circuit board mounted within housing 210.

The power setting circuit 122 is a “macro-timing” circuit that can be set, by a control dial 214 (described hereinafter), to a LOW, MED, or HIGH setting. The three settings determine how long the signal generated by the airflow modulating circuit 120 will drive the oscillator 124. When the control dial 214 is set to HIGH, the electrical signal output from the airflow modulating circuit 120, modulating between the high and low airflow signals, will continuously drive the connector oscillator 124. When the control dial 214 is set to MED, the electrical signal output from the airflow modulating circuit 120 will cyclically drive the oscillator 124 for 25 seconds, and then drop to a zero or a lower voltage for 25 seconds. Thus, the airflow rate through the device 200 is slower when the dial 214 is set to MED than when the control dial 214 is set to HIGH. When the control dial 214 is set to LOW, the signal from the airflow modulating circuit 120 will cyclically drive the oscillator 124 for 25 seconds, and then drop to a zero or a lower voltage for 75 seconds. It is within the scope and spirit of the present invention for the HIGH, MED, and LOW settings to drive the oscillator 124 for longer or shorter periods of time.

The boost timer 128 sends a signal to the converter oscillator 124 when the boost button 216 is depressed. The boost timer 128 when activated, instructs the device 200 to run at a maximum airflow rate for a 5 minute period. This maximum airflow rate preferably creates an airflow velocity higher than that created when the control dial 214 is set to HIGH.

FIG. 4C further illustrates some preferred timing and maintenance features of the device 200. The device 200 has a 2 week timer 130 and an arc sensing circuit 132 that either shuts the device 200 completely off, or provides a reminder to the user to clean the device 200.

Electrode Assembly with First and Second Electrodes:

Having described various aspects of the invention in general, preferred embodiments of the electrode assembly 220 will now be described. The embodiments shown in FIGS. 5A-13C only illustrate a single electrode assembly 220. As previously mentioned, the unit 200 preferably includes two electrode assemblies 220 within the housing 210. Thus, a complete unit 200 will include a combination of any or more two electrode assemblies disclosed in FIGS. 5A-13C.

FIGS. 5A-5H

FIGS. 5A-5H illustrate several configurations of the electrode assembly 220. As shown in FIG. 5A, the output from high voltage pulse generator unit 170 is electronically connected to an electrode assembly 220 that comprises a first electrode array 230 and a second electrode array 240. Again, instead of arrays, single electrodes or single conductive surfaces can be substituted for one or both array 230 and array 240.

In a preferred embodiment, the positive output terminal of unit 170 is electrically connected to first electrode array 230, and the negative output terminal is coupled to second electrode array 240. It is believed that with this arrangement the net polarity of the emitted ions is positive, e.g., more positive ions than negative ions are emitted. This coupling polarity has been found to work well, including minimizing unwanted audible electrode vibration or hum. However, while generation of positive ions is conducive to a relatively silent airflow, from a health standpoint, it is desired that the output airflow be richer in negative ions, not positive ions. It is noted that in some embodiments, one port (preferably the negative port) of the high voltage pulse generator 170 can in fact be the ambient air. Thus, electrodes in the second array 240 need not be electrically connected to the high voltage pulse generator 170 using a wire. Nonetheless, there will be an “effective connection” between the second array electrodes 240 and one output port of the high voltage pulse generator 170, in this instance, via ambient air. Alternatively, the negative output terminal of unit 170 can be connected to the first electrode array 230 and the position output terminal can be connected to the second electrode array 240.

With this arrangement an electrostatic flow of air is created, going from the first electrode array 230 towards the second electrode array 240. (This flow is denoted “OUT” in the figures.) Accordingly, electrode assembly 220 is mounted within transporter system 100 or 200 such that second electrode array 240 is closer to the “OUT” vents and first electrode array 230 is closer to the “IN” vents.

When voltage or pulses from high voltage pulse generator 170 are electrically connected across first and second electrode arrays 230 and 240, a plasma-like field is created surrounding electrodes 232 in first array 230. This electric field ionizes the ambient air between the first and second electrode arrays and establishes an “OUT” airflow that moves towards the second array 240. It is understood that the “IN” flow enters via vents 104, or 204a and 204b, and that the “OUT” flow exits via vents 106, or 206a and 206b.

Ozone and ions are generated simultaneously by the first array electrodes 232, essentially as a function of the potential from generator 170 electrically connected to the first array of electrodes or conductive surfaces 230. Ozone generation can be increased or decreased by increasing or decreasing the potential at the first array 230. Electrically connecting an opposite polarity potential to the second array electrodes 242 essentially accelerates the motion of ions generated at the first array 230, producing the airflow denoted as “OUT” in the figures. As the ions and ionized particles move toward the second array 240, the ions and ionized particles push or move air molecules toward the second array 240. The relative velocity of this motion may be increased, byway of example, by decreasing the potential at the second array 240 relative to the potential at the first array 230.

For example, if +10 KV were applied to the first array electrode(s) 232, and no potential were applied to the second array electrode(s) 242, a cloud of ions (whose net charge is positive) would form adjacent the first electrode array 230. Further, the relatively high 10 KV potential would generate substantial ozone. By electrically connecting a relatively negative potential to the second array electrode(s) 242, the velocity of the air mass moved by the net emitted ions increases.

On the other hand, if it were desired to maintain the same effective outflow (OUT) velocity, but to generate less ozone, the exemplary 10 KV potential could be divided between the electrode arrays. For example, generator 170 could provide +4 KV (or some other fraction) to the first array electrodes 232 and −6 KV (or some other fraction) to the second array electrodes 242. In this example, it is understood that the +4 KV and the −6 KV are measured relative to ground. Understandably it is desired that the unit 100 or 200 operates to output appropriate amounts of ozone. Accordingly, the high voltage is preferably fractionalized with about +4 KV applied to the first array electrodes 232 and about −6 KV applied to the second array electrodes 242.

In the embodiments of FIGS. 5A and 5B, electrode assembly 220 comprises a first array 230 of wire-shaped electrodes 232, and a second array 240 of generally “U”-shaped electrodes 242. In preferred embodiments, the number N1 of electrodes comprising the first array can preferably differ by one relative to the number N2 of electrodes comprising the second array 240. In many of the embodiments shown, N2>N1. However, if desired, additional first electrodes 232 could be added at the outer ends of array 230 such that N1>N2, e.g., five first electrodes 232 compared to four second electrodes 242.

As previously indicated, first or emitter electrodes 232 are preferably lengths of tungsten wire, whereas electrodes 242 are formed from sheet metal, preferably stainless steel, although brass or other sheet metal could be used. The sheet metal is readily configured to define side regions 244 and bulbous nose region 246, forming the hollow, elongated “U”-shaped electrodes 242. While FIG. 5A depicts four electrodes 242 in second array 240 and three electrodes 232 in first array 230, as noted previously, other numbers of electrodes in each array could be used, preferably retaining a symmetrically staggered configuration as shown. It is seen in FIG. 5A that while particulate matter 60 is present in the incoming (IN) air, the outflow (OUT) air is substantially devoid of particulate matter, which adheres to the preferably large surface area provided by the side regions 244 of the second array electrodes 242.

FIG. 5B illustrates that the spaced-apart configuration between the first and second arrays 230, 240 is staggered. Preferably, each first array electrode 232 is substantially equidistant from two second array electrodes 242. This symmetrical staggering has been found to be an efficient electrode placement. Preferably, in this embodiment, the staggering geometry is symmetrical in that adjacent electrodes 232 or adjacent electrodes 242 are spaced-apart a constant distance, Y1 and Y2 respectively. However, anon-symmetrical configuration could also be used. Also, it is understood that the number of electrodes 232 and 242 may differ from what is shown.

In the embodiment of FIGS. 5A and 5B, typically dimensions are as follows: diameter of electrodes 232, R1, is about 0.08 mm, distances Y1 and Y2 are each about 16 mm, distance X1 is about 16 mm, distance L is about 20 mm, and electrode heights Z1 and Z2 are each about 1 m. The width W of electrodes 242 is preferably about 4 mm, and the thickness of the material from which electrodes 242 are formed is about 0.5 mm. Of course other dimensions and shapes could be used. For example, preferred dimensions for distance X1 may vary between 12-30 mm, and the distance Y2 may vary between 15-30 mm. It is preferred that electrodes 232 have a small diameter. A wire having a small diameter, such as R1, generates a high voltage field and has a high emissivity. Both characteristics are beneficial for generating ions. At the same time, it is desired that electrodes 232 (as well as electrodes 242) be sufficiently robust to withstand occasional cleaning.

Electrodes 232 in first array 230 are electronically connected to a first (preferably positive) output port of high voltage pulse generator 170 by a conductor 234. Electrodes 242 in second array 240 are electrically connected to a second (preferably negative) output port of high voltage generator 170 by a conductor 249. The electrodes maybe electrically connected to the conductors 234 or 249 at various locations. By way of example only, FIG. 5B depicts conductor 249 making connection with some electrodes 242 internal to bulbous end 246, while other electrodes 242 make electrical connection to conductor 249 elsewhere on the electrode 242. Electrical connection to the various electrodes 242 could also be made on the electrode external surface, provided no substantial impairment of the outflow airstream results; however it has been found to be preferable that the connection is internal.

In this and the other embodiments to be described herein, ionization appears to occur at the electrodes 232 in the first electrode array 230, with ozone production occurring as a function of high voltage arcing. For example, increasing the peak-to-peak voltage amplitude and/or duty cycle of the pulses from the high voltage pulse generator 170 can increase ozone content in the output flow of ionized air. If desired, user-control S2 or dial 214 can be used to somewhat vary ozone content by varying amplitude and/or duty cycle. Specific circuitry for achieving such control is known in the art and need not be described in detail herein.

Note the inclusion in FIGS. 5A and 5B of at least one output controlling electrode 243, preferably electrically connected to the same potential as the second array electrodes 242. Electrode 243 preferably defines a pointed shape in side profile, e.g., a triangle. The sharp point on electrodes 243 causes generation of substantial negative ions (since the electrode is electrically connected to a relatively negative high potential). These negative ions neutralize excess positive ions otherwise present in the output airflow, such that the “OUT” flow has a net negative charge. Electrodes 243 is preferably stainless steel, copper, or other conductor material, and is perhaps 20 mm high and about 12 mm wide at the base. The inclusion of one electrode 243 has been found sufficient to provide a sufficient number of output negative ions, but more such electrodes may be included.

In the embodiments of FIGS. 5A, 5B and 5C, each “U”-shaped electrode 242 has two trailing surface or sides 244 that promote efficient kinetic transport of the outflow of ionized air and ozone. For the embodiment of FIG. 5C, there is the inclusion on at least one portion of a trailing edge of a pointed electrode region 243′. Electrode region 243′ helps promote output of negative ions, in the same fashion that was previously described with respect to electrodes 243, as shown in FIGS. 5A and 5B.

In FIG. 5C and the figures to follow, the particulate matter is omitted for ease of illustration. However, from what was shown in FIGS. 5A-5B, particulate matter will be present in the incoming air, and will be substantially absent from the outgoing air. As has been described, particulate matter 60 typically will be electrostatically precipitated upon the surface area of electrodes 242.

As discussed above and as depicted by FIG. 5C, it is relatively unimportant where on an electrode array electrical connection is made. Thus, first array electrodes 232 are shown electrically connected together at their bottom regions by conductor 234, whereas second array electrodes 242 are shown electrically connected together in their middle regions by the conductor 249. Both arrays may be connected together in more than one region, e.g., at the top and at the bottom. It is preferred that the wire or strips or other inter-connecting mechanisms be at the top, bottom, or periphery of the second array electrodes 242, so as to minimize obstructing stream air movement through the housing 210.

It is noted that the embodiments of FIGS. 5C and 5D depict somewhat truncated versions of the second electrodes 242. Whereas dimension L in the embodiment of FIGS. 5A and 5B was about 20 mm, in FIGS. 5C and 5D, L has been shortened to about 8 mm. Other dimensions in FIG. 5C preferably are similar to those stated for FIGS. 5A and 5B. It will be appreciated that the configuration of second electrode array 240 in FIG. 5C can be more robust than the configuration of FIGS. 5A and 5B, by virtue of the shorter trailing edge geometry. As noted earlier, a symmetrical staggered geometry for the first and second electrode arrays is preferred for the configuration of FIG. 5C.

In the embodiment of FIG. 5D, the outermost second electrodes, denoted 242-1 and 242-4, have substantially no outermost trailing edges. Dimension L in FIG. 5D is preferably about 3 mm, and other dimensions maybe as stated for the configuration of FIGS. 5A and 5B. Again, the ratio of the radius or surface areas between the first electrode 232 and the second electrodes 242 for the embodiment of FIG. 5D preferably exceeds about 20:1.

FIGS. 5E and 5F depict another embodiment of electrode assembly 220, in which the first electrode array 230 comprises a single wire electrode 232, and the second electrode array 240 comprises a single pair of curved “L”-shaped electrodes 242, in cross-section. Typical dimensions, where different than what has been stated for earlier-described embodiments, are X1≈12 mm, Y2≈5 mm, and L1≈3 mm. The effective surface area or radius ratio is again greater than about 20:1. The fewer electrodes comprising assembly 220 in FIGS. 5E and 5F promote economy of construction, and ease of cleaning, although more than one electrode 232, and more than two electrodes 242 could of course be employed. This particular embodiment incorporates the staggered symmetry described earlier, in which electrode 232 is equidistant from two electrodes 242. Other geometric arrangements, which may not be equidistant, are within the spirit and scope of the invention.

FIGS. 5G-5H illustrate that the second electrodes 242 may have angled, Z-shaped or other corrugated extensions or sections 294. These electrodes can also be hollow. Preferably, the tail extension 294 is a non-linear configuration, having an effective width W′ greater than the width W (see FIG. 5B) of the second electrode 242. The extensions 294 enhance the particle capture efficiency of the electrode assembly 220. Larger airborne particles (e.g., one micron and larger) tend to have their own significant forward momentum in the air stream. A “U”-shaped second electrode 242 without an angled blade extension 294, as shown in FIG. 5A, might allow a larger particle to pass through the electrode assembly 220 uncaptured. The momentum of the particle may prevent it from contacting the trailing edges 244 of the second electrode 242. The increased width W′ of the angled extension 246 is intended to capture the larger particles. For example, if the larger particle passes by the trailing side 244 of the second electrode 242 uncaptured, but the particle is within W′ of the trailing sides 244, the particle will be captured by the extension 294. It is within the spirit and scope of the invention for the extension 294 to comprise other non-linear shapes and configurations such as, but not limited to, a “U”-shape, an “L”-shape, a “Z”-shape, or a shape with a first upstream portion and a second downstream portion positioned at an angle to the upstream portion, and a shape with a tail section that is wider in the downstream portion than the upstream, leading, or nose portion.

In FIG. 5G all tail sections 294 are parallel and point in the same direction. Alternatively, the tail sections 256 can be configured to diverge in order to form a “V” or “Y” configured adjacent to the outlet vents. Thus, in FIG. 5H the upper two tail sections 294 are configured to point upwardly on the page while the lower two tail sections remain pointing downward.

FIGS. 5G-5H also show that in another preferred embodiment the second electrode can be arranged in a non-equidistant arrangement relative to the first electrodes. Thus, in FIGS. 5G and 5H, the middle two second electrodes 243-2 and 242-3 are recessed back further from the first electrode array 230 than the outer electrode 242-1 and 242-4. This arrangement can give better airflow through the ion generating unit 220. It is within the spirit and scope of the invention for all the embodiments shown in FIGS. 5A-13C to incorporate this feature.

FIGS. 5I-5J illustrate a second array of electrodes 240 where each second electrode 242 has a tail section 276 that is wider than the nose 246. The trailing sides 244 angle outward from the nose 246 as the sides 244 extend downstream. Overall, the electrode 242 is teardrop or “V” shaped with the nose 246 located closer to the first array of electrodes 230. This embodiment traps or collects particles in a similar fashion as the electrodes shown in FIGS. 5G-5H. In general, the larger width of the tail section 276 will collect particles within the airflow that may go uncollected by a thinner second electrode 242 (see, for example, FIG. 5A). As is evident from the figures the nose is rounded and substantially smaller than the rounded bulbous tail of the second electrode 242. The nose is rounded so that it does not become an emitter as are the first electrodes. Further the nose has a radius that is larger than the radius of the first electrode, preferably fifteen times larger.

As shown in FIGS. 5I and 5J, the second electrode 242 is hollow. It is within the scope and spirit of the invention for the electrode 242 to be a solid object.

As shown in FIG. 5J, the tail section 296 must not be so wide that the airflow passing between the second electrodes 242 is restricted and impair the airflow exiting the unit 100 or 200. Accordingly, and in a preferred embodiment, the distance between second electrodes, shown as Y2, is slightly larger in this embodiment.

Electrode Assembly with an Upstream Focus Electrode:

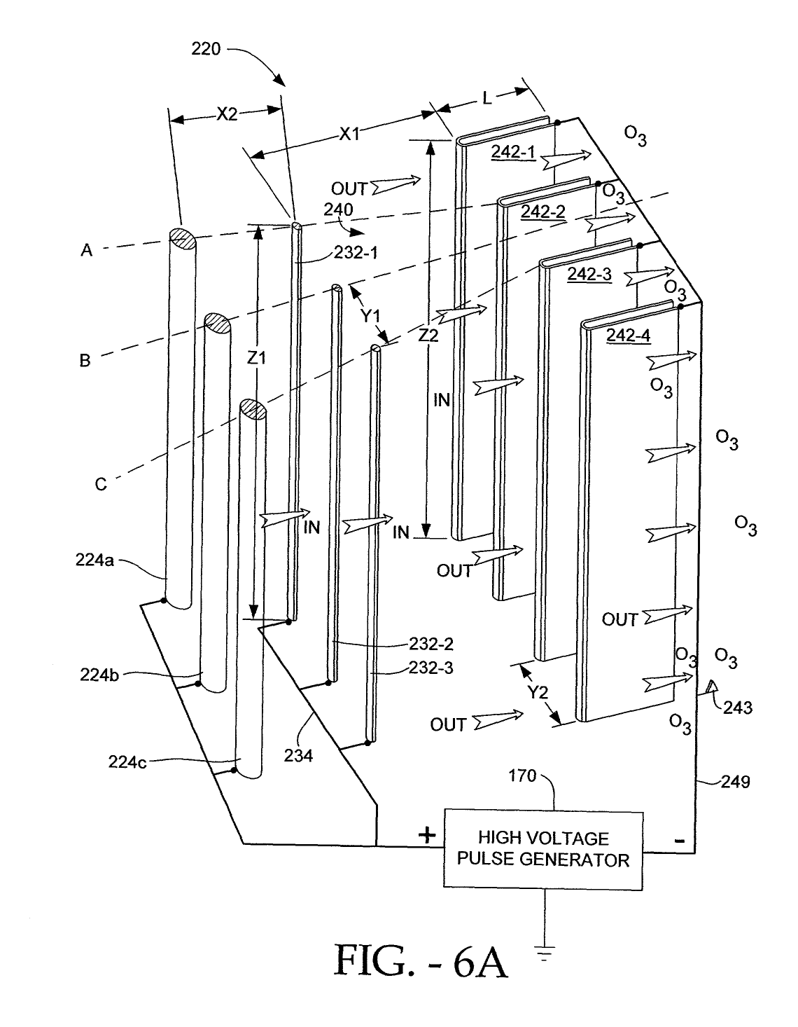

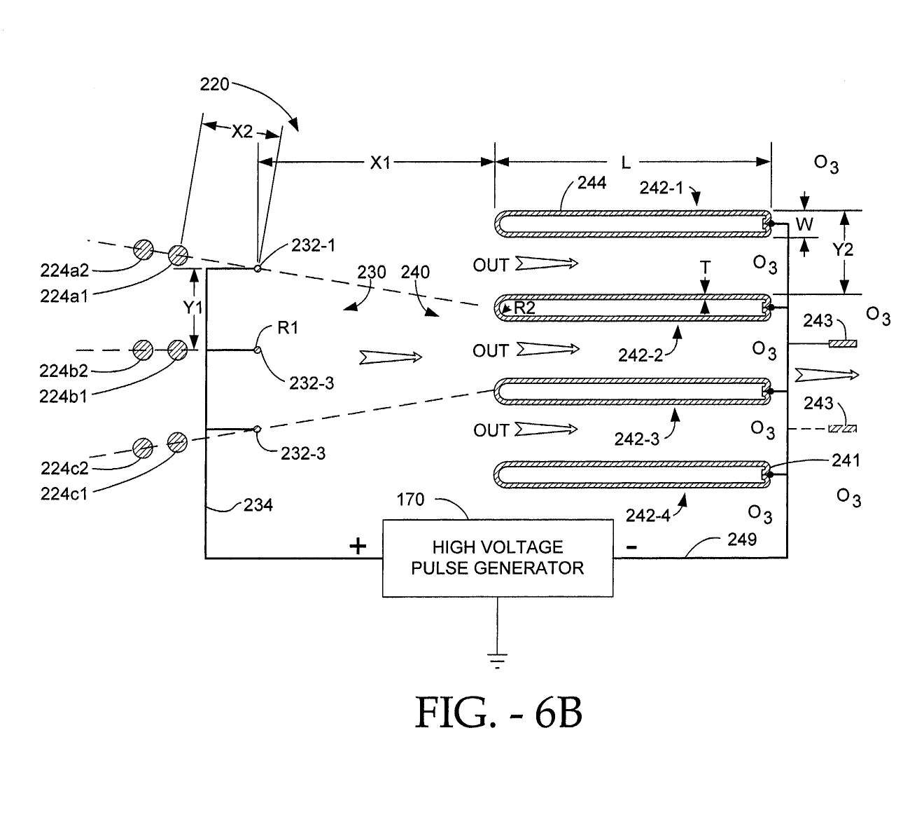

FIGS. 6A-6B

The embodiments illustrated in FIGS. 6A-6B are somewhat similar to the previously described embodiments in FIGS. 5A-5B. The electrode assembly 220 includes a first array of electrodes 230 and a second array of electrodes 240. Again, for this and the other embodiments, the term “array of electrodes” may refer to a single electrode or a plurality of electrodes. Preferably, the number of electrodes 232 in the first array of electrodes 230 will differ by one relative to the number of electrodes 242 in the second array of electrodes 240. The distances L, X1, Y1, Y2, Z1 and Z2 for this embodiment are similar to those previously described in FIG. 5A.

As shown in FIG. 6A, the electrode assembly 220 preferably adds a third, or leading, or focus, or directional electrode 224a, 224b, 224c (generally referred to as “electrode 224”) upstream of each first electrode 232-1,232-2,232-3. The focus electrode 224 produces an enhanced airflow velocity exiting the devices 100 or 200. In general, the third focus electrode 224 directs the airflow, and ions generated by the first electrode 232, towards the second electrodes 242. Each third focus electrode 224 is a distance X2 upstream from at least one of the first electrodes 232. The distance X2 is preferably 5-6 mm, or four to five diameters of the focus electrode 224. However, the third focus electrode 224 maybe further from, or closer to, the first electrode 232.

The third focus electrode 224 illustrated in FIG. 6A is a rod-shaped electrode. The third focus electrode 224 may also comprise other shapes that preferably do not contain any sharp edges. The third focus electrode 224 is preferably manufactured from material that will not erode or oxidize, such as stainless steel. The diameter of the third focus electrode 224, in a preferred embodiment, is at least fifteen times greater than the diameter of the first electrode 232. However, the diameter of the third focus electrode 224 maybe larger or smaller. The diameter of the third focus electrode 224 is preferably large enough so that third focus electrode 224 does not function as an ion emitting surface when electrically connected to the high voltage generator 170. The maximum diameter of the third focus electrode 224 is somewhat constrained. As the diameter increases, the third focus electrode 224 will begin to noticeably impair the airflow rate of the units 100 or 200. Therefore, the diameter of the third electrode 224 is balanced between the need to form a non-ion emitting surface and airflow properties of the unit 100 or 200.

In a preferred embodiment, each third focus electrodes 224 is electrically connected to the first array 230 and the high voltage generator 170 by the conductor 234. As shown in FIG. 6A, the third focus electrodes 224 are electrically connected to the same positive outlet of the high voltage generator 170 as the first array 230. Accordingly, the first electrode 232 and the third focus electrode 224 generate a positive electrical field. Since the electrical fields generated by the third focus electrode 224 and the first electrode 232 are both positive, the positive field generated by the third focus electrode 224 will push, or repel, or direct, the positive field generated by the first electrode 232 towards the second array 240. For example, the positive field generated by the third focus electrode 224a will push, or repel, or direct, the positive field generated by the first electrode 232-1 towards the second array 240. In general, the third focus electrode 224 shapes the electrical field generated by each electrode 232 in the first array 230. This shaping effect is believed to decrease the amount of ozone generated by the electrode assembly 220 and increases the airflow of the units 100 and 200.

The particles within the airflow are positively charged by the ions generated by the first electrode 232. As previously mentioned, the positively charged particles are collected by the negatively charged second electrodes 242. The third focus electrode 224 also directs the airflow towards the second electrodes 242 by guiding the charged particles towards the trailing sides 244 of each second electrode 242. It is believed that the airflow will travel around the third focus electrode 224, partially guiding the airflow towards the trailing sides 244, improving the collection rate of the electrode assembly 220.

The third focus electrode 224 maybe located at various positions upstream of each first electrode 232. By way of example only, a third focus electrode 224b is located directly upstream of the first electrode 232-2 so that the center of the third focus electrode 224b is in-line and symmetrically aligned with the first electrode 232-2, as shown by extension line B. Extension line B is located midway between the second electrode 242-2 and the second electrode 242-3.

Alternatively, a third focus electrode 224 may also be located at an angle relative to the first electrode 232. For example, a third focus electrode 224a maybe located upstream of the first electrode 232-1 along a line extending from the middle of the nose 246 of the second electrode 242-2 through the center of the first electrode 232-1, as shown by extension line A. The third focus electrode 224a is in-line and symmetrically aligned with the first electrode 232-1 along extension line A. Similarly, the third electrode 224c is located upstream to the first electrode 232-3 along a line extending from the middle of the nose 246 of the second electrode 242-3 through the first electrode 232-3, as shown by extension line C. The third focus electrode 224c is in-line and symmetrically aligned with the first electrode 232-3 along extension line C. It is within the scope of the present invention for the electrode assembly 220 to include third focus electrodes 224 that are both directly upstream and at an angle to the first electrodes 232, as depicted in FIG. 6A. Thus, the focus electrodes 224 fan out in relation to the first array of electrodes 230.

FIG. 6B illustrates that an electrode assembly 220 may contain multiple third focus electrodes 224 upstream of each first electrode 232. By way of example only, the third focus electrode 224a2 is in-line and symmetrically aligned with the third focus electrode 224a1, as shown by extension line A. In a preferred embodiment, only the third focus electrodes 224a1, 224b1, 224c1 are electrically connected to the high voltage generator 170 by conductor 234. Accordingly, not all of the third electrodes 224 are at the same operating potential. In the embodiment shown in FIG. 6B, the third focus electrodes 224a1, 224b1, 224c1 are at the same electrical potential as the first electrodes 232, while the third focus electrodes 224a2, 224b2, 224c2 are floating. Alternatively, the third focus electrodes 224a2, 224b2 and 224c2 maybe electrically connected to the high voltage generator 170 by the conductor 234.

FIG. 6B illustrates that each second electrode 242 may also have a protective end 241. In the previous embodiments, each “U”-shaped second electrode 242 has an open end.

Typically, the end of each trailing side or side wall 244 contains sharp edges. The gap between the trailing sides or side walls 244, and the sharp edges at the end of the trailing sides or side walls 244, generate unwanted eddy currents. The eddy currents create a “backdraft,” or airflow traveling from the outlet towards the inlet, which slow down the airflow rate of the units 100 or 200.

In a preferred embodiment, the protective end 241 is created by shaping, or rolling, the trailing sides or side walls 244 inward and pressing them together, forming a rounded trailing end with no gap between the trailing sides or side walls of each second electrode 242.

Accordingly, the side walls have outer surfaces, and the outer surface of end of the side walls are bent back inwards towards the nose 246, adjacent to the trailing ends of the side walls so that the outer surface of the side walls are adjacent to, or face, or touch each other. Preferably, a smooth trailing edge is integrally formed on the second electrode 242. If desired, it is within the scope of the invention to spot weld the rounded ends together along the length of the second electrode 242.

It is also within the scope of the present invention to form the protective end 241 by other methods such as, but not limited to, placing a strap of plastic across each end of the trailing sides 244 for the fall length of the second electrode 242. The rounded or capped end is an improvement over the previous electrodes 242 without a protective end 241. Eliminating the gap between the trailing sides 244 reduces or eliminates the eddy currents typically generated by a second electrode 242 with an open end. The rounded protective end 241 also provides a smooth surface for purpose of cleaning the second electrode. Accordingly, in this embodiment the collector electrode 242 is a one-piece, integrally formed, electrode with a protection end 241.

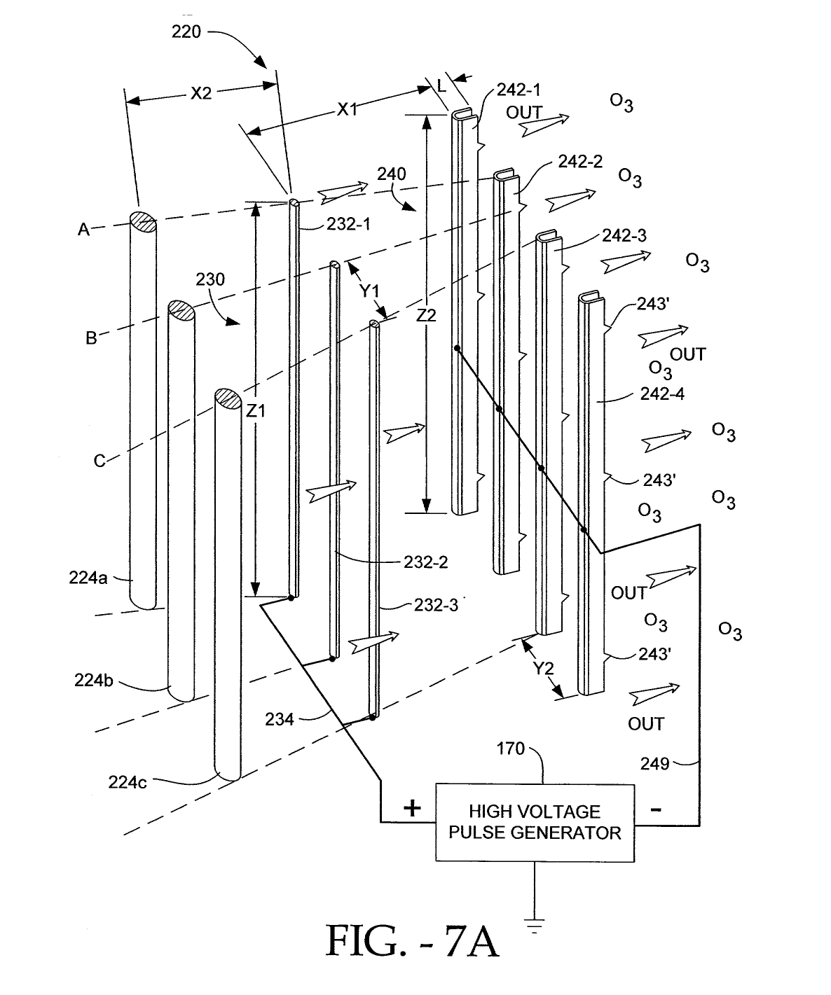

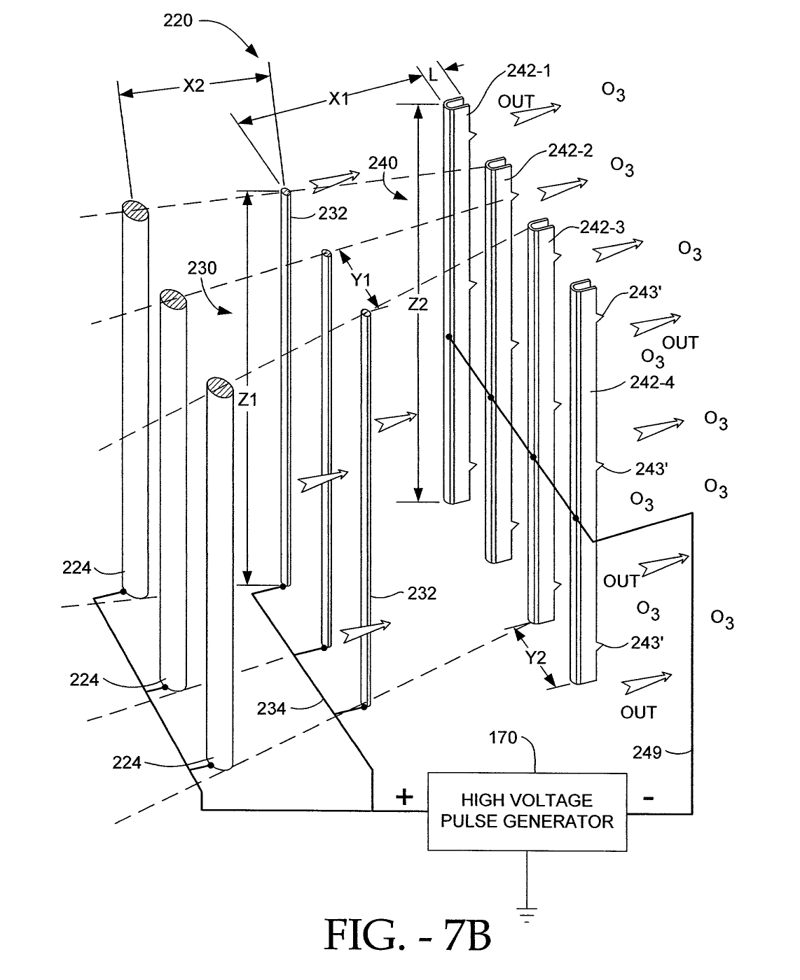

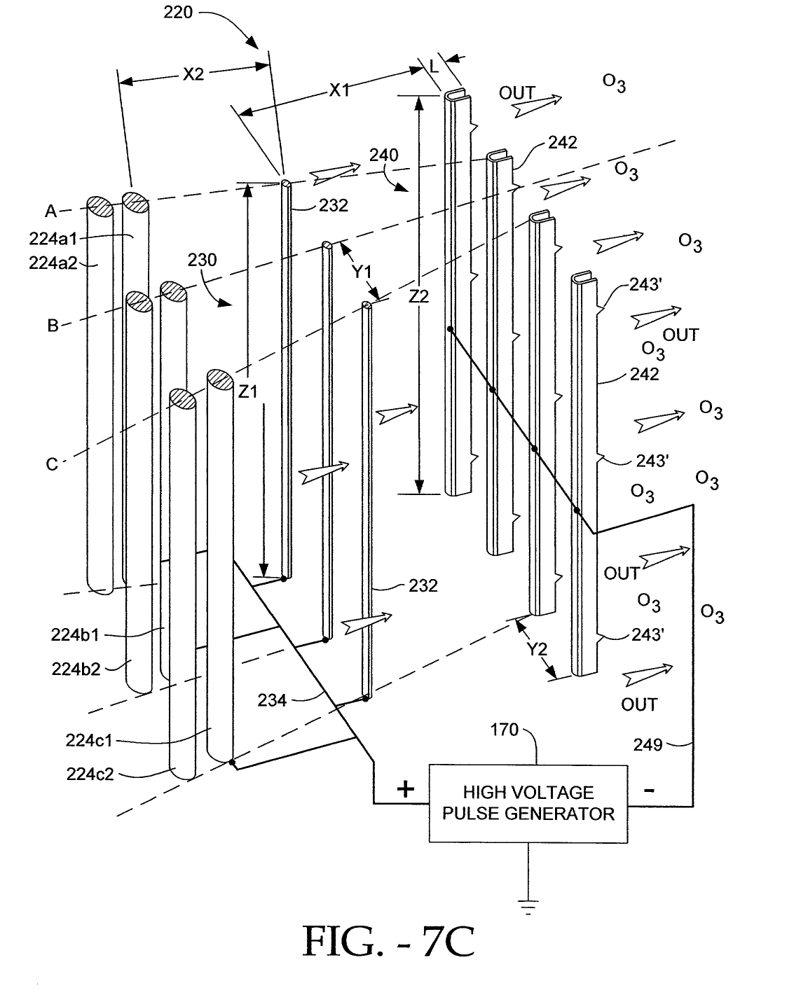

FIGS. 7A-7D

FIG. 7A illustrates an electrode assembly 220 including a first array of electrodes 230 having three wire-shaped first electrodes 232-1, 232-2, 232-3 (generally referred to as “electrode 232”), and a second array of electrodes 240 having four “U”-shaped second electrodes 242-1, 242-2, 242-3, 242-4 (generally referred to as “electrode 242”). Each first electrode 232 is electrically connected to the high voltage generator 170 at the bottom region, whereas each second electrode 242 is electrically connected to the high-voltage generator 170 in the middle to illustrate that the first and second electrodes 232, 242 can be electrically connected in a variety of locations.

The second electrode 242 in FIG. 7A is a similar version of the second electrode 242 shown in FIG. 5C. The distance L has been shortened to about 8 mm, while the other dimensions X1, Y1, Y2, Z1, Z2 are similar to those shown in FIG. 5A.

A third leading, or focus, electrode 224 is located upstream of each first electrode 232. The innermost third focus electrode 224b is located directly upstream of the first electrode 232-2, as shown by extension line B. Extension line B is located midway between the second electrodes 242-2,242-3. The third focus electrodes 224a, 224c are at an angle with respect to the first electrodes 232-1, 232-3. For example, the third focus electrode 224a is upstream to the first electrode 232-1 along a line extending from the middle of the nose 246 of the second electrode 242-2 extending through the center of the first electrode 232-1, as shown by extension line A. The third electrode 224c is located upstream of the first electrode 232-3 along a line extending from the center of the nose 246 of the second electrode 242-3 through the center of the first electrode 232-3, as shown by extension line C. Accordingly, and preferably, the focus electrodes 242 fan out in relation to the first electrodes 232 as an aid for directing the flow of ions and charged particles. FIG. 7B illustrates that the third focus electrodes 224 may also be electrically connected to the high voltage generator 170 by conductor 234.

FIG. 7C illustrates that a pair of third focus electrodes 224 may be located upstream of each first electrode 232. Preferably, the multiple third focus electrodes 224 are in-line and symmetrically aligned with each other. For example, the third focus electrode 224a2 is in-line and symmetrically aligned with the third focus electrode 224a1, along extension line A. As previously mentioned, preferably only third focus electrodes 224a1, 224b1, 224c1 are electrically connected to the high voltage generator 170 by conductor 234. It is also within the scope of the present invention to have none or all of the third focus electrodes 224 electrically connected to the high voltage generator 170.

FIG. 7D illustrates third focus electrodes 224 added to the electrode assembly 220 shown in FIG. 5D. Preferably, a third focus electrode 224 is located upstream of each first electrode 232. For example, the third focus electrode 224b is in-line and symmetrically aligned with the first electrode 232-2, as shown by extension line B. Extension line B is located midway between the second electrodes 242-2, 242-3. The third focus electrode 224a is in-line and symmetrically aligned with the first electrode 232-1, as shown by extension line A. Similarly, the third electrode 224c is in-line and symmetrically aligned with the first electrode 232-3, as shown by extension line C. Extension lines A-C extend from the middle of the nose 246 of the “U”-shaped second electrodes 242-2,242-3 through the first electrodes 232-1, 232-3, respectively. In a preferred embodiment, the third electrodes 224a, 224b, 224c are electrically connected to the high voltage generator 170 by the conductor 234. This embodiment may also include a pair of third focus electrodes 224 upstream of each first electrode 232, as is depicted in FIG. 7C.

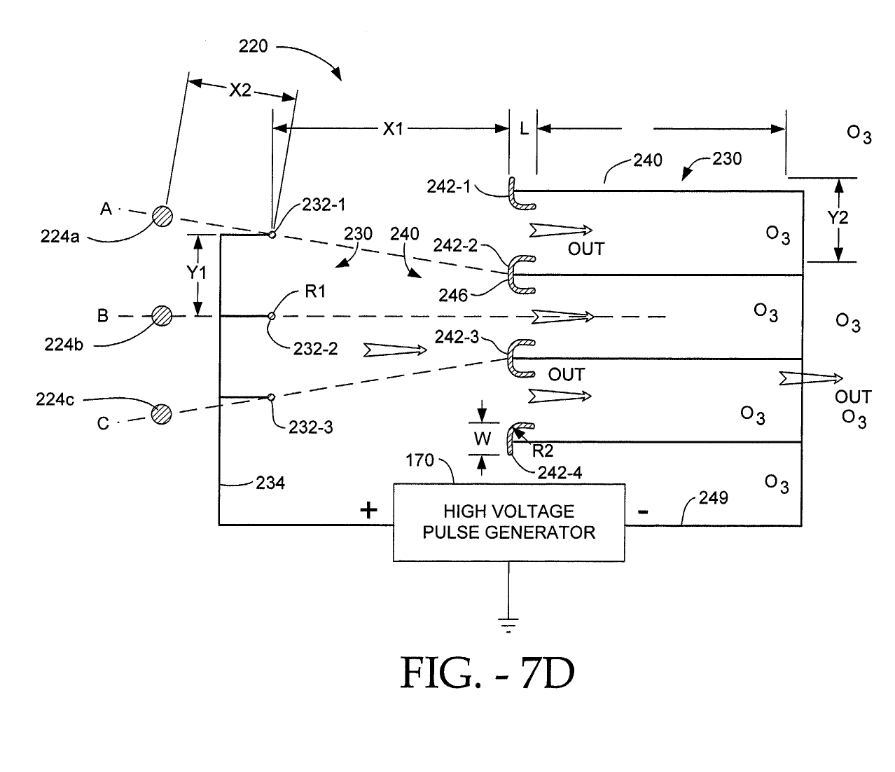

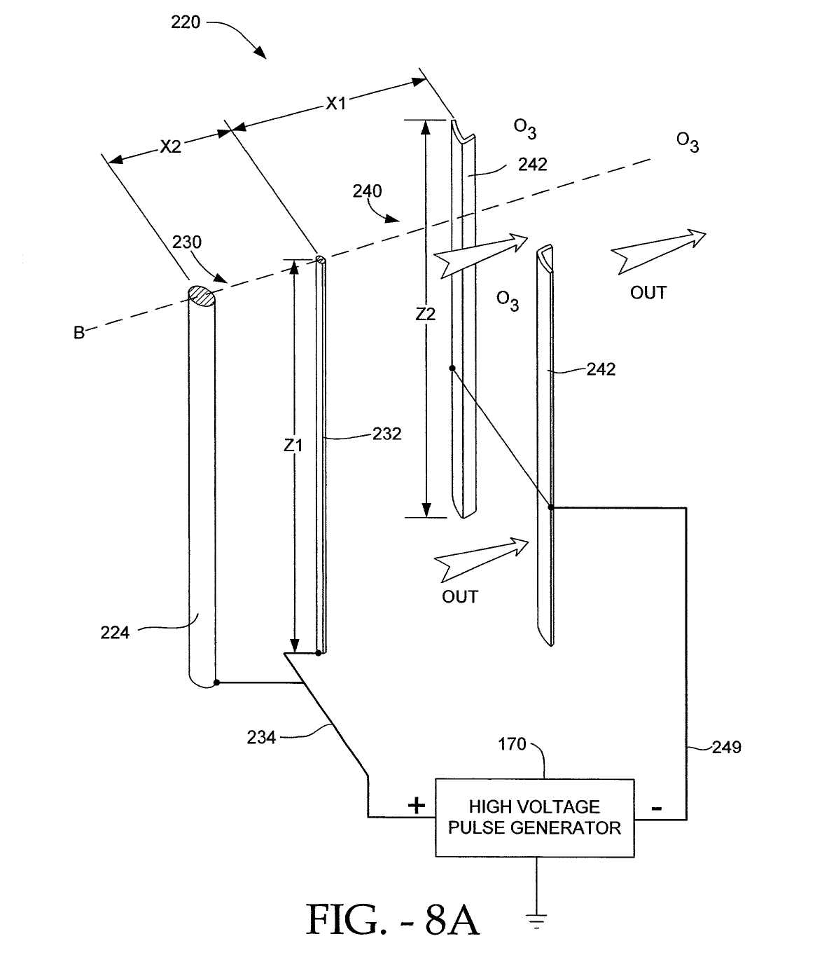

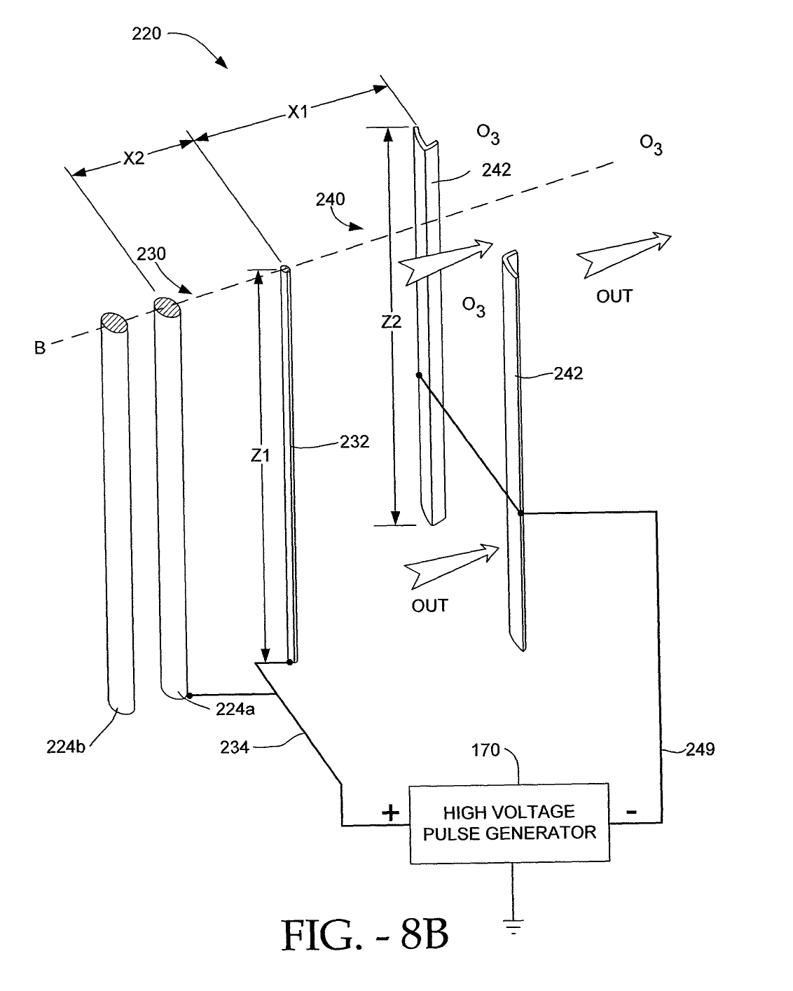

FIGS. 8A-8C

FIGS. 8A-8C illustrate that the electrode assembly 220 shown in FIG. 5E may include a third focus electrode 224 upstream of the first array of electrodes 230. Preferably, the center of the third focus electrode 224 is in-line and symmetrically aligned with the center of the first electrode 232, as shown by extension line B. Extension line B is located midway between the second electrodes 242. The distances X1, X2, Y1, Y2, Z1 and Z2 are similar to the embodiments previously described. The first electrode 232 and the second electrode 242 maybe electrically connected to the high voltage generator 170 by conductor 234, 249 respectively. It is within the scope of the present invention to connect the first and second electrodes to opposite ends of the high voltage generator 170 (e.g., the first electrode 232 maybe negatively charged and the second electrode 242 may be positively charged). In a preferred embodiment the third focus electrode 224 is also electrically connected to the high voltage generator 170.

FIG. 8B illustrates that a pair of third focus electrodes 224a, 224b maybe located upstream of the first electrode 232. The third focus electrodes 224a, 224b are in-line and symmetrically aligned with the first electrode 232, as shown by extension line B. Extension line B is located midway between the second electrodes 242. Preferably, the third focus electrode 224b is upstream of third focus electrode 224a a distance equal to the diameter of a third focus electrode 224. In a preferred embodiment, only the third focus electrode 224a is electrically connected to the high voltage generator 170. It is within the scope of the present invention to electrically connect both third focus electrodes 224a, 224b to the high voltage generator 170.

FIG. 8C illustrates that each third focus electrode 224 maybe located at an angle with respect to the first electrode 232. Similar to the previous embodiments, the third focus electrode 224a1 and 224b1 is located a distance X2 upstream from the first electrode 232. By way of example only, the third focus electrodes 224a1, 224a2 are located along a line extending from the middle of the second electrode 242-2 through the center of the first electrode 232, as shown by extension line A. The third focus electrode 224a2 is in-line and symmetrically aligned with the third focus electrode 224a1 along extension line A. Similarly, the third focus electrodes 224b1, 224b2 are along a line extending from the middle of the second electrode 242-1 through the middle of the first electrode 232, as shown by extension line B. The third focus electrode 224b2 is in line and symmetrically aligned with the third focus electrode 224b1 along extension line B. The third focus electrodes 224 are fanned out and form a “V” pattern upstream of first electrode 232. In a preferred embodiment, only the third focus electrodes 224a1 and 224b1 are electrically connected to the high voltage generator 170 by conductor 234. It is within the scope of the invention to electrically connect the third focus electrodes 224a and 224b2 to the high voltage generator 170.

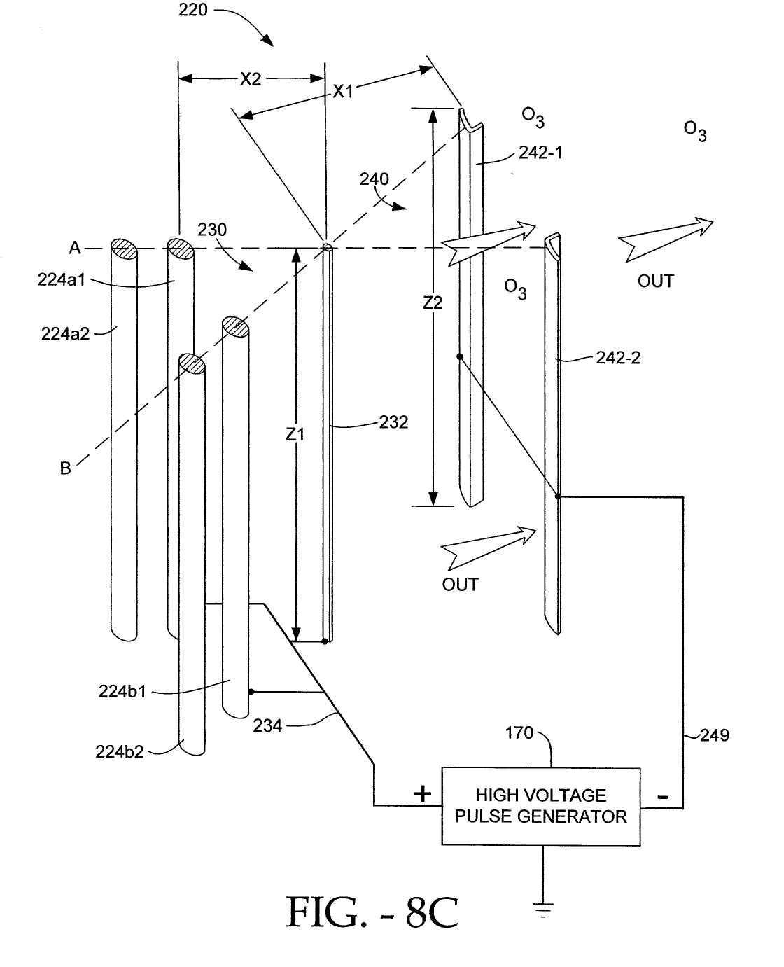

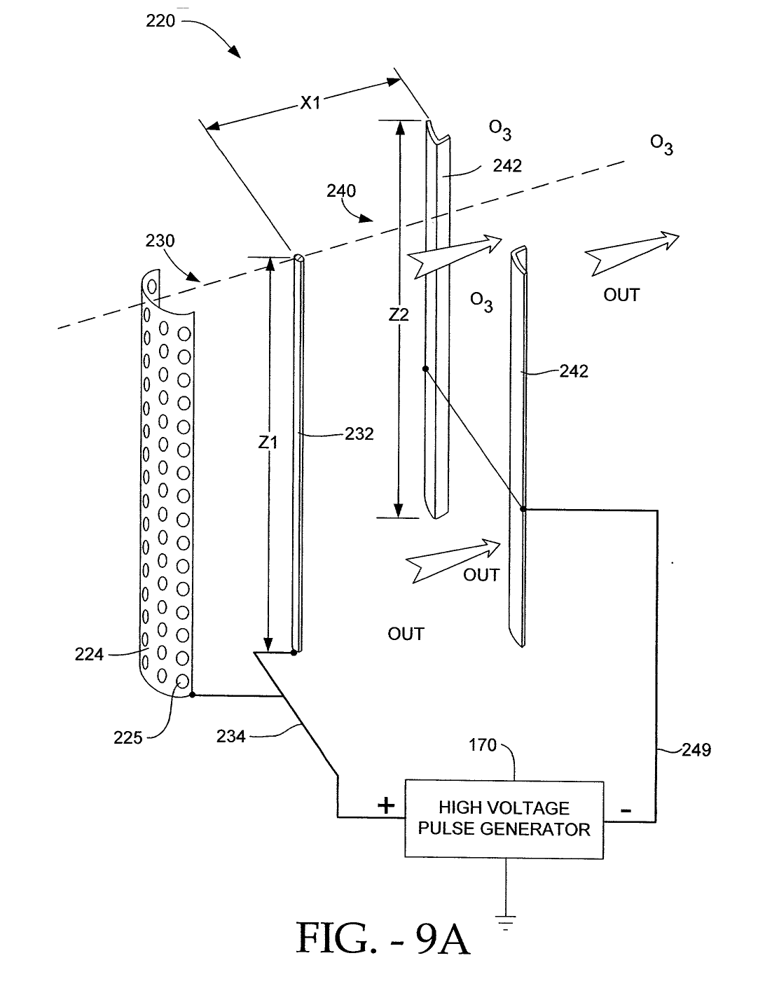

FIGS. 9A-9C

The previously described embodiments of the electrode assembly 220 disclose a rod-shaped third focus electrode 224 upstream of each first electrode 232. FIG. 9A illustrates an alternative configuration for the third focus electrode 224. By way of example only, the electrode assembly 220 may include a “U”-shaped or possibly “C”-shaped third focus electrode 224 upstream of each first electrode 232. Further, the third focus electrode 224 can have other curved configurations such as, but not limited to, circular-shaped, elliptical-shaped, parabolically-shaped, and other concave shapes facing the first electrode 232. In a preferred embodiment, the third focus electrode 224 has holes 225 extending through, forming a perforated surface to minimize the resistance of the third focus electrode 224 on the airflow rate. Further in other embodiments the “U”-shaped third focus electrode 224 can be made of a screen or a mesh.

In a preferred embodiment, the third focus electrode 224 is electrically connected to the high voltage generator 170 by conductor 234. The third focus electrode 224 in FIG. 9A is preferably not an ion emitting surface. Similar to previous embodiments, the third focus electrode 224 generates a positive electric field and pushes or repels the electric field generated by the first electrode 232 towards the second array 240. FIG. 9B illustrates that a perforated “U”-shaped or “C”-shaped third focus electrode 224 can be incorporated into the electrode assembly 220 shown in FIG. 5A.

FIG. 9C illustrates third focus electrodes 224 similar to those depicted in FIG. 9B, except that the third focus electrodes 224 are rotated by 180° to preset a convex surface facing to the first electrodes 232 in order to focus and direct the field of ions and airflow from the first electrode 232 toward the second electrode 242. These third focus electrodes 224 shown in FIGS. 9A-9C are located along extension lines A, B, C similar to previously described embodiments.

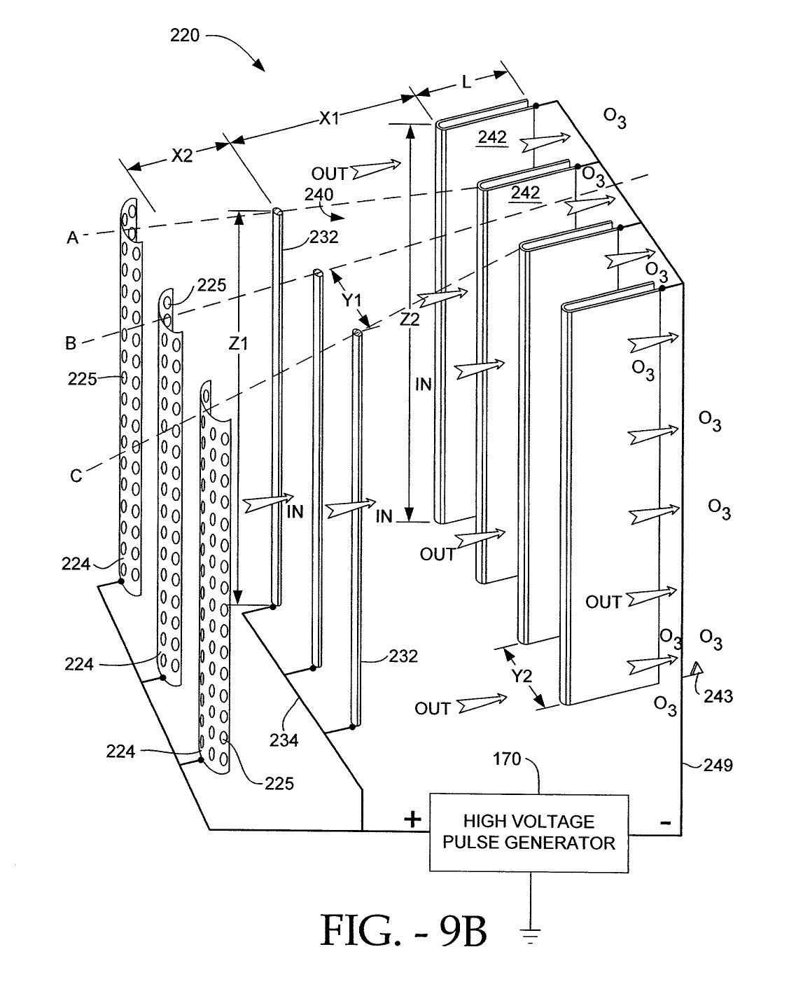

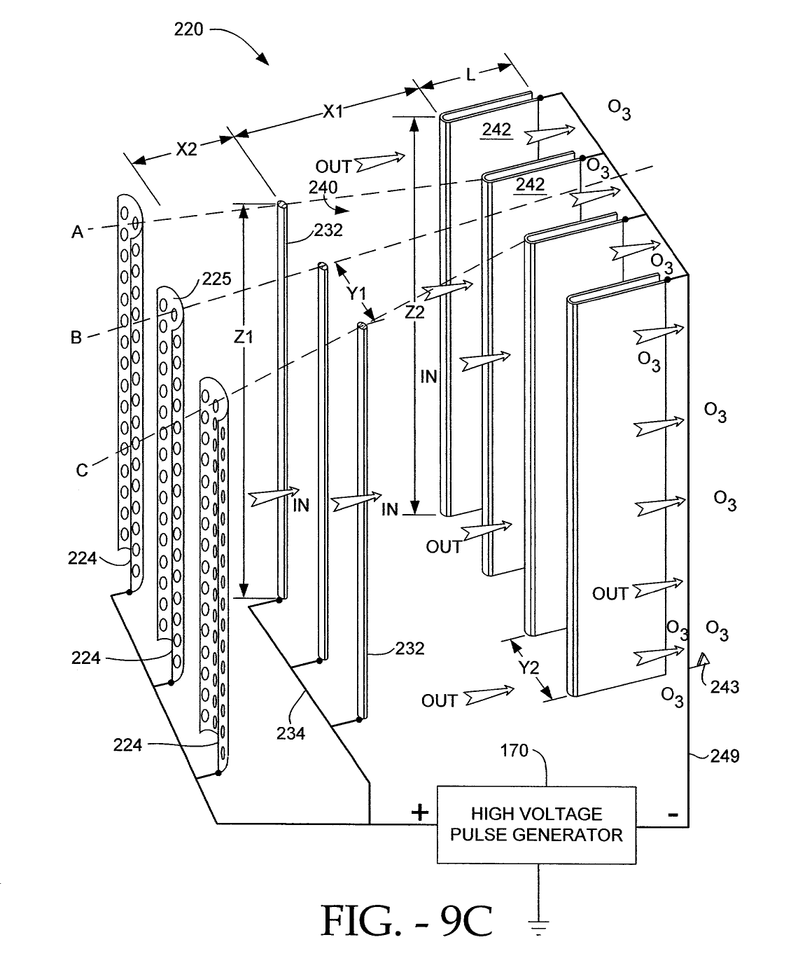

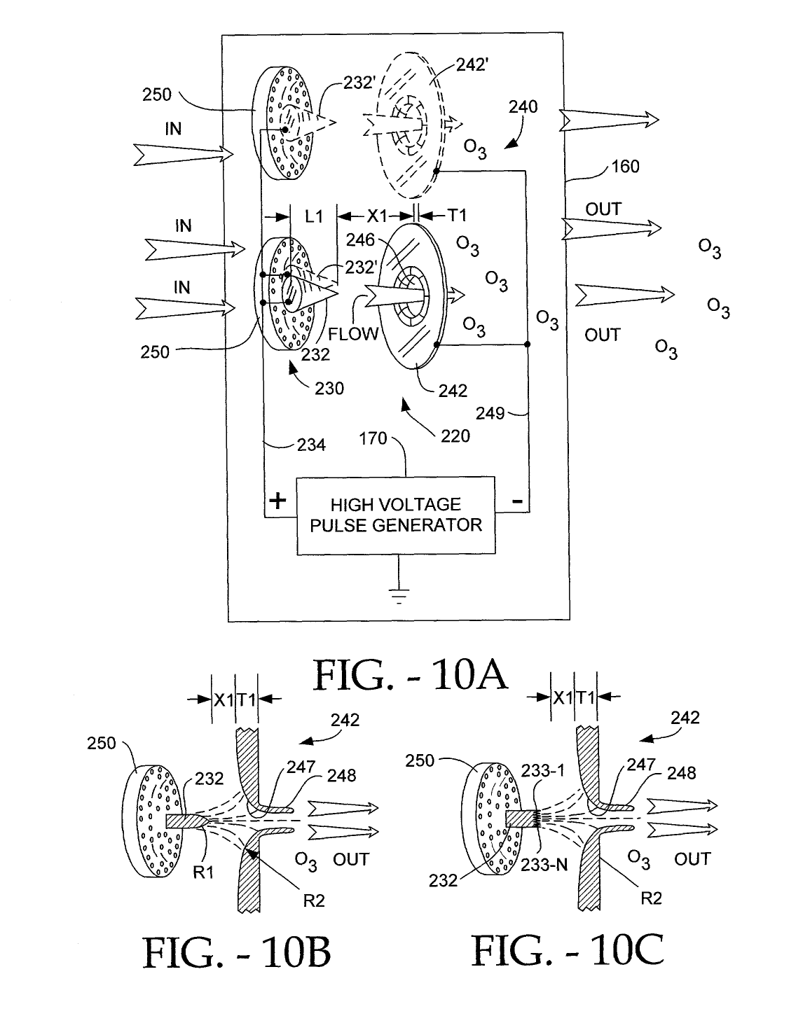

FIGS. 10A-10C

FIG. 10A illustrates a pin-ring configuration of the electrode assembly 220. The electrode assembly 220 contains a cone-shaped or triangular-shaped first electrode 232, a ring-shaped second electrode 242 downstream of the first electrode 232, and a third focus electrode 250 upstream of the first electrode 232. In a preferred embodiment, the third focus electrode 250 is electrically connected to the high voltage generator 170. Alternatively, the third focus electrode 250 can have a floating potential. As indicated by phantom elements 232′, 242′, the electrode assembly 220 can comprise a plurality of such pin-like and ring-like elements. The plurality of pin-ring configurations as depicted in FIG. 10A can be positioned one above the other along the elongated housing of the invention. Such a plurality of pin-ring configurations can of course operate in another embodiment without the third focus electrode 250. It is understood that this plurality of pin-ring configurations can be upstanding and elongated along the elongated direction of said housing and can replace the first and second electrodes shown, for example, in FIG. 2B, and be removable much as the second electrode in FIG. 2B is removable. Preferably, the first electrode 232 is tungsten, and the second electrode 242 is stainless steel. Typical dimensions for the embodiment of FIG. 10A are L1≈10 millimeters, X1≈9.5 millimeters, T≈0.5 millimeters and the diameter of the opening 246≈12 millimeters.

The electrical properties and characteristics of the third focus electrode 250 is similar to the third focus electrode 224 described in previous embodiments. In contrast to the rod-shaped physical characteristic of the previous embodiments, the shape the third focus electrode 250 is a disc, with the concave surface preferably facing toward the second electrode 242. The third focus electrode 250 preferably has holes extending therethrough to minimize the disruption in airflow. It is within the scope of the present invention for the third focus electrode 250 to comprise other shapes such as, but not limited to, a convex disc, a parabolic disc, a spherical disc, or other convex or concave shapes, or a rectangle, or other planar surface and be within the spirit and scope of the invention. The diameter of the third focus electrode 250 is preferably at least fifteen times greater than the diameter of the first electrode 232.

The second electrode 242 has an opening 246. The opening 246 is preferably circular in this embodiment. It is within the scope of the present invention that the opening 246 can comprise other shapes such as, but not limited to, rectangular, hexagonal or octagonal. The second electrode 242 has a collar 247 (see FIG. 10B) surrounding the opening 246. The collar 247 attracts the dust contained within the airstream passing through the opening 246. As a result, the airstream emitted by the electrode assembly 220 has a reduced dust content.

Other similar pin-ring embodiments are shown in FIGS. 10B-10C. For example, the first electrode 232 may comprise a rod-shaped electrode having a tapered end. In FIG. 10B, a detailed cross-sectional view of the central portion of the second electrode 242 in FIG. 10A is shown. Preferably, the collar 247 is positioned in relation to the first electrode 232, such that the ionization paths from the distal tip of the first electrode 232 to the collar 247 have substantially equal path lengths. Thus, while the distal tip (or emitting tip) of the first electrode 232 is advantageously small to concentrate the electric field, the adjacent regions of the second electrode 242 preferably provide many equidistant inter-electrode paths. The lines drawn in phantom in FIGS. 10B and 10C depict theoretical electric force field lines emanating from the first electrode 232 and terminating on the curved surface of the second electrode 242. Preferably, the bulk of the field emanates within about 45 degrees of coaxial axis between the first electrode 232 and the second electrode 242.

In FIG. 10C, one or more first electrodes 232 are replaced by a conductive block 232″ of carbon fibers, the block having a distal surface in which projecting fibers 233-1, . . . 233-N take on the appearance of a “bed of nails.” The projecting fibers can each act as an emitter electrode and provide a plurality of emitting surfaces. Over a period of time, some or all of the electrodes will literally be consumed, where upon the block 232″ maybe replaced. Materials other than graphite maybe used for block 232″ providing that the material has a surface with projecting conductive fibers such as 233-N.

Electrode Assembly with a Downstream Trailing Electrode:

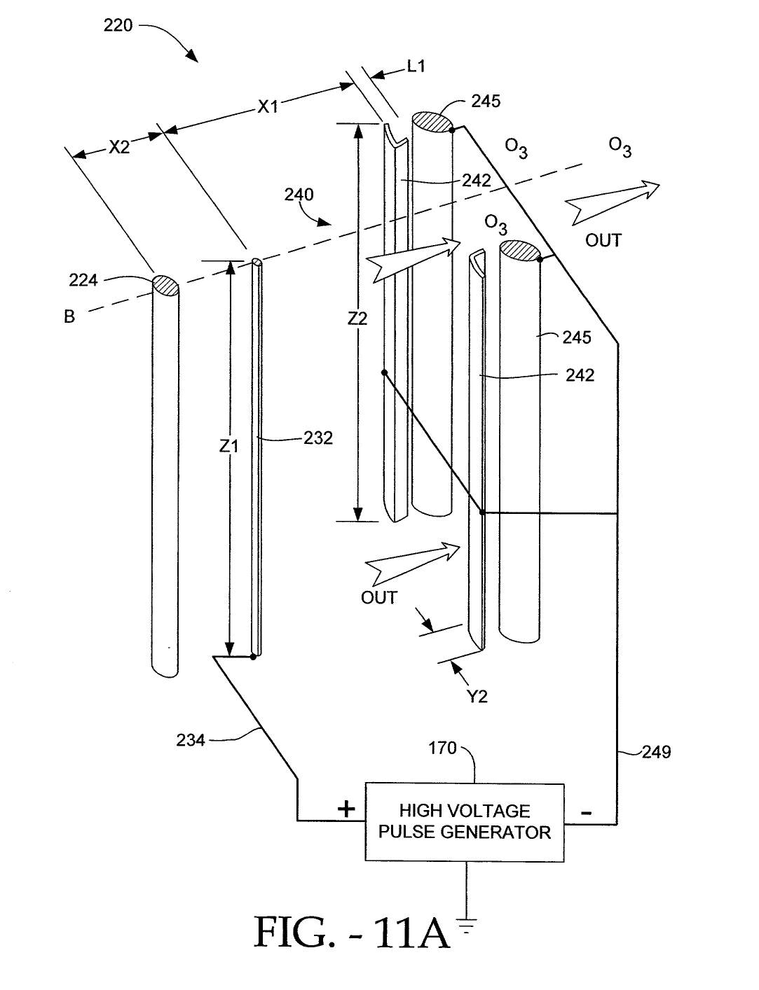

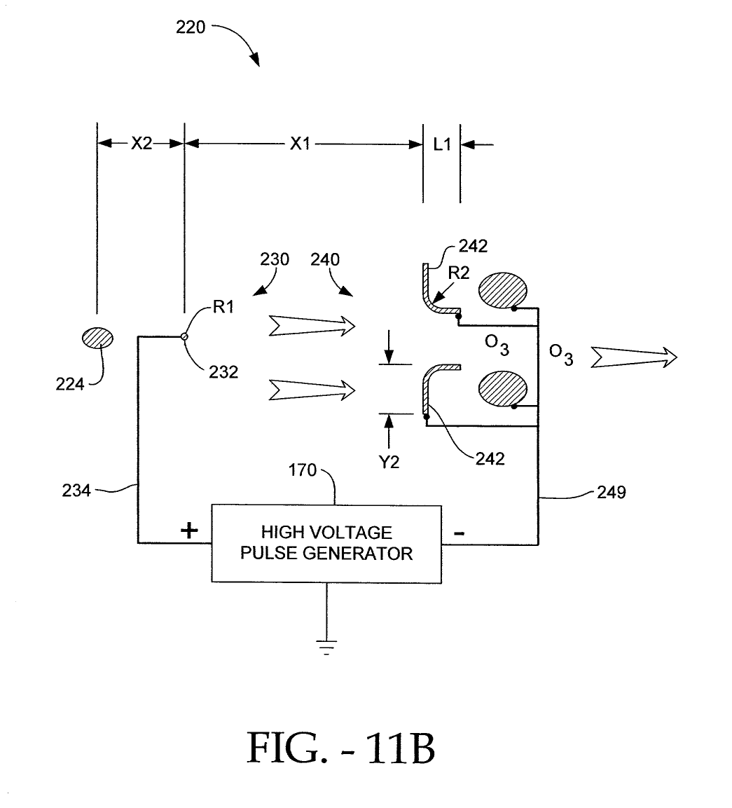

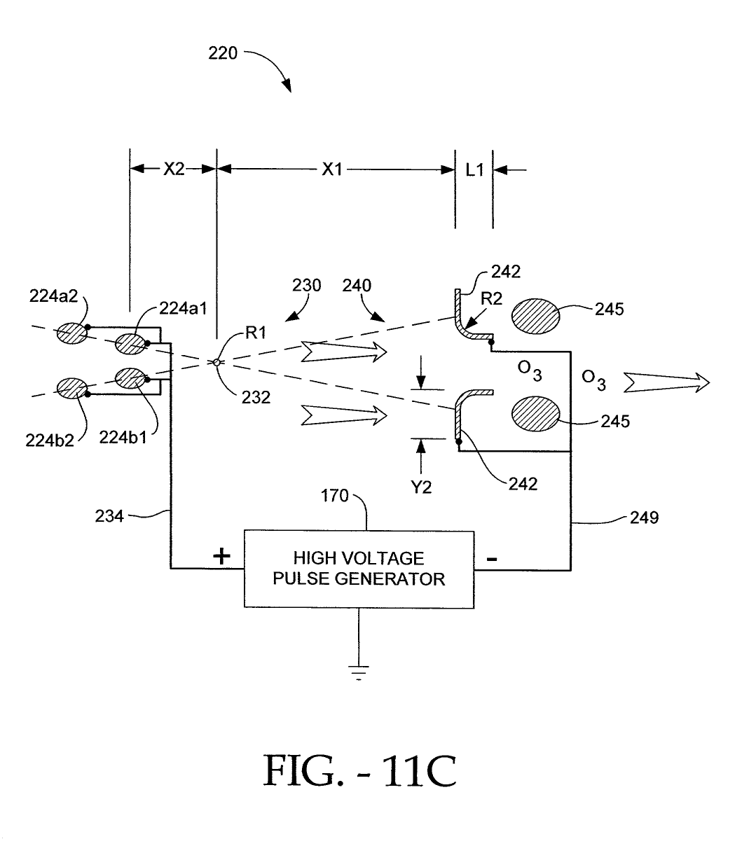

FIGS. 11A-11D

FIGS. 11A-11C illustrate an electrode assembly 220 having an array of trailing electrodes 245 added to an electrode assembly 220 similar to that shown in FIG. 8A. It is understood that an alternative embodiment similar to FIG. 11A can include a trailing electrode or electrodes 245 without any focus electrodes 224 and be within the spirit and scope of the inventions. Referring now to FIGS. 11A-11B, each trailing electrode 245 is located downstream of the second array of electrodes 240. Preferably, the trailing electrodes 245 are located downstream from the second electrodes 242 by at least three times the radius R2 (see FIG. 11B). Further, the trailing electrodes 245 are preferably directly downstream of each second electrode 242 so as not to interfere with the flow of air. Also, the trailing electrode 245 is aerodynamically smooth, for example, circular, elliptical, or teardrops shaped in cross-section so as not to unduly interfere with the smoothness of the airflow thereby. In a preferred embodiment, the trailing electrodes 245 are electrically connected to the same outlet of the high voltage generator 170 as the second array of electrodes 240. As shown in FIG. 11A, the second electrodes 242 and the trailing electrodes 245 have a negative electrical charge. This arrangement can introduce more negative charges into the air stream. Alternatively, the trailing electrodes 245 may have a floating potential and not be electrically connected to the high voltage generator 170. The trailing electrode can also be grounded in other embodiments. Further, alternatively as shown in FIG. 11D, the trailing electrode 245 can be formed with the second electrode out of a sheet of metal formed in the shape of the second electrode and then extending to the position of the trailing electrode and formed as a hollow trailing electrode with a peripheral wall that is about the shape of the outer surface of the trailing electrode 245 depicted in FIG. 11C.

When the trailing electrodes 245 are electrically connected to the high voltage generator 170, the positively charged particles within the airflow are also attracted to and collect on, the trailing electrodes 245. In an electrode assembly with no trailing electrode 245, most of the particles will collect on the surface area of the second electrodes 242. However, some particles will pass through the unit 200 without being collected by the second electrodes 242. The trailing electrodes 245 serve as a second surface area to collect the positively charged particles. The trailing electrodes 245 may also deflect charged particles toward the second electrodes 242.

The trailing electrodes 245 preferably also emit a small amount of negative ions into the airflow. These negative ions will neutralize the positive ions emitted by the first electrodes 232. If the positive ions emitted by the first electrodes 232 are not neutralized before the airflow reaches the outlet 260, the outlet fins 212 may become electrically charged and particles within the airflow may tend to stick to the fins 212. If this occurs, the amount of particles collected by the fins 212 will eventually block or minimize the airflow exiting the unit 100 or 200.

FIG. 11C illustrates another embodiment of the electrode assembly 200, with trailing electrodes 245 added to an embodiment similar to that shown in FIG. 8C. The trailing electrodes 245 are located downstream of the second array 240 similar to the previously described embodiments above. It is within the scope of the present invention to electrically connect the trailing electrodes 245 to the high voltage generator 170. As shown in FIG. 11C, all of the third focus electrodes 224 are electrically connected to the high voltage generator 170. In a preferred embodiment, only the third focus electrodes 224a1, 224b1 are electrically connected to the high voltage generator 170, and the third focus electrodes 224a2, 224b2 have a floating potential.

Electrode Assemblies with Various Combinations of Focus Electrodes Trailing Electrodes and Enhanced Second Electrodes with Protective Ends:

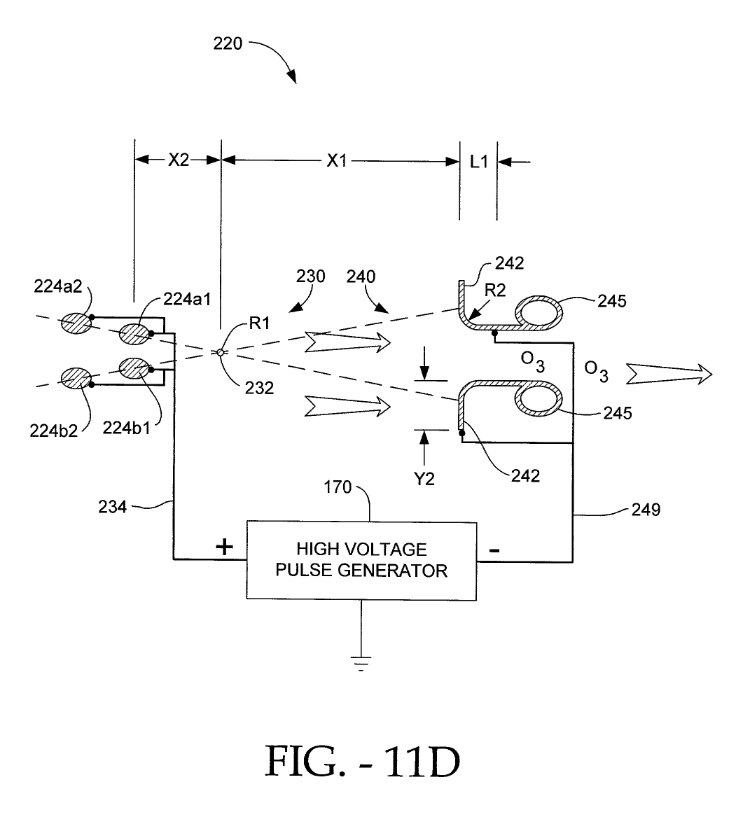

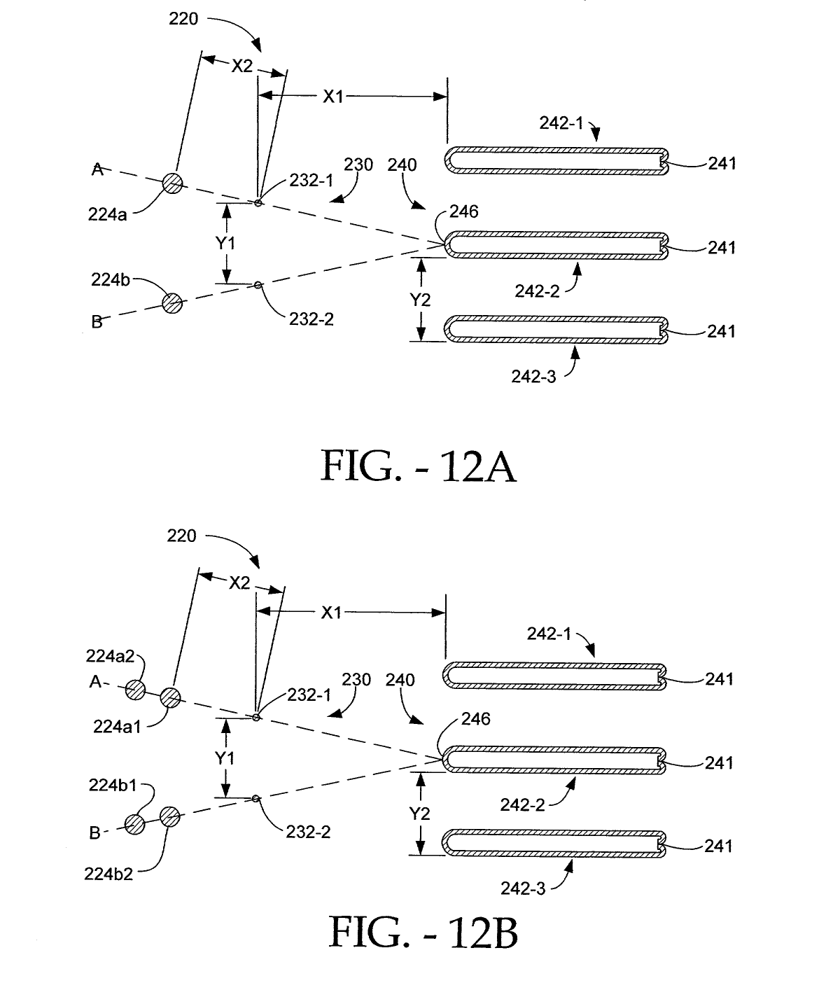

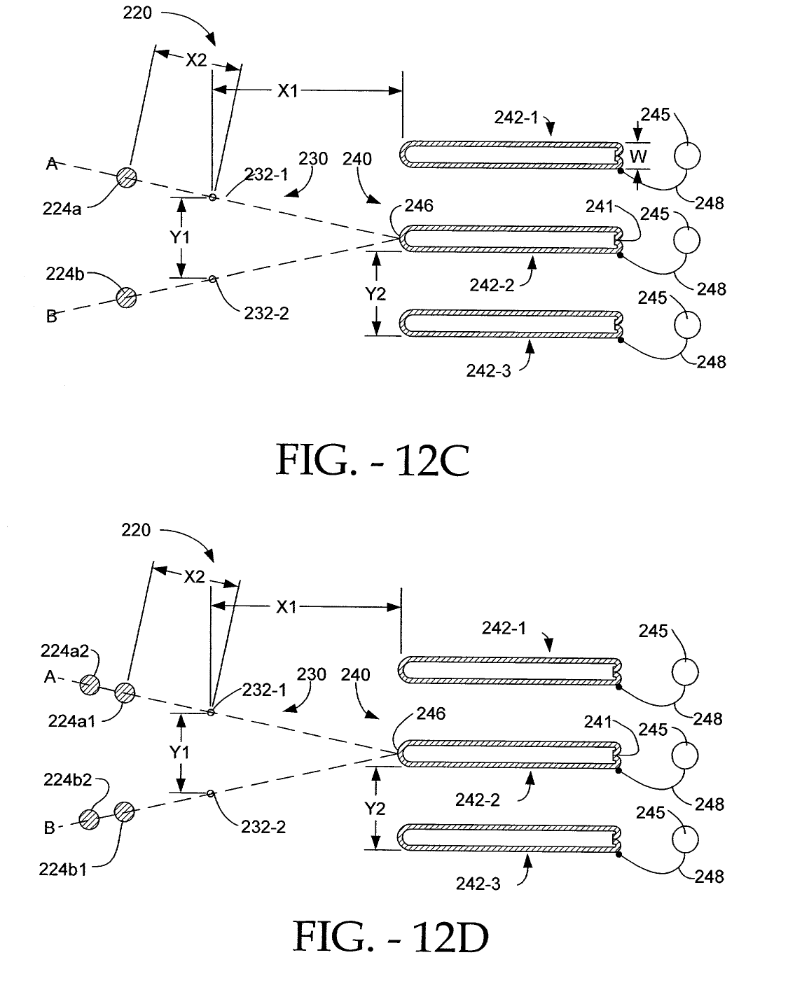

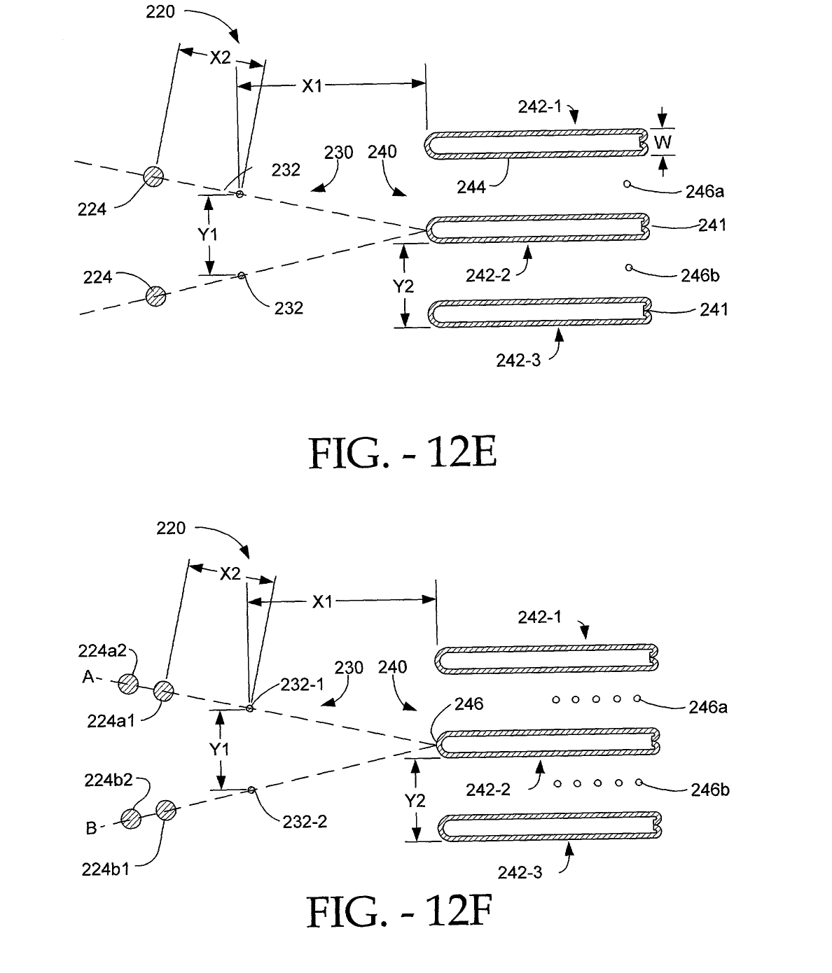

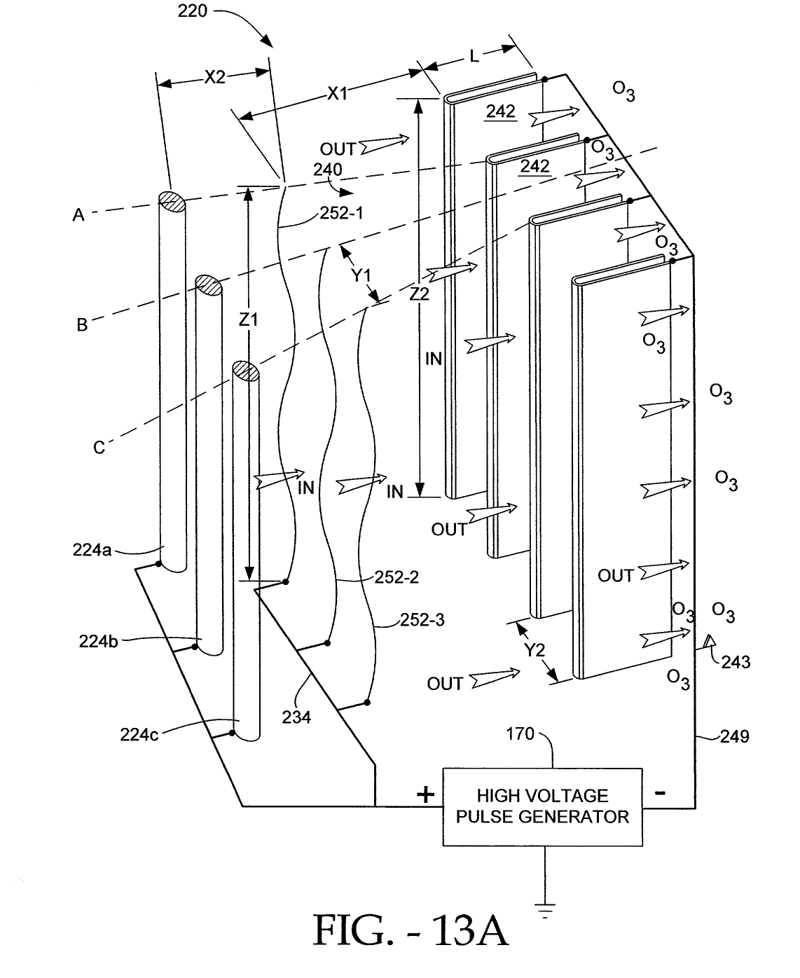

FIGS. 12A-12D

FIG. 12A illustrates an electrode assembly 220 that includes a first array of electrodes 230 having two wire-shaped electrodes 232-1, 232-2 (generally referred to as “electrode 232”) and a second array of electrodes 240 having three “U”-shaped electrodes 242-1, 242-2,242-3 (generally referred to as “electrode 242”). This configuration is in contrast to, for example, the configurations of FIG. 10A, wherein there are three first emitter electrodes 232 and four second collector electrodes 242.

Upstream from each first electrode 232, at a distance X2, is a third focus electrode 224. Each third focus electrode 224a, 224b (generally referred to as “electrode 224”) is at an angle with respect to a first electrode 232. For example, the third focus electrode 224a is preferably along a line extending from the middle of the nose 246 of the second electrode 242-2 through the center of the first electrode 232-1, as shown by extension line A. The third focus electrode 224a is in-line and symmetrically aligned with the first electrode 232-1 along extension line A. Similarly, the third focus electrode 224b is located along a line extending from middle of the nose 246 of the second electrode 242-2 through the center of the first electrode 232-2, as shown by extension line B. The third focus electrode 224b is in-line and symmetrically aligned with the first electrode 232-2 along extension line B. As previously described, the diameter of each third focus electrode 224 is preferably at least fifteen times greater than the diameter of the first electrode 232.

As shown in FIG. 12A, and similar to the embodiment shown in FIG. 6B, each second electrode preferably has a protective end 241. In a preferred embodiment, the third focus electrodes 224 are electrically connected to the high voltage generator 170 (not shown). It is within the spirit and scope of the invention to not electrically connect the third focus electrodes 224 to the high voltage generator 170.

FIG. 12B illustrates that multiple third focus electrodes 224 may be located upstream of each first emitter electrode 232. For example, the third focus electrode 224a2 is in-line and symmetrically aligned with the third focus electrode 224a1 along extension line A. Similarly, the third focus electrode 224b2 is in-line and symmetrically aligned with the third focus electrode 242b1 along extension line B. It is within the scope of the present invention to electrically connect all, or none of, the third focus electrodes 224 to the high-voltage generator 170. In a preferred embodiment, only the third focus electrodes 224a1, 224b1 are electrically connected to the high voltage generator 170, with the third focus electrodes 224a2, 224b2 having a floating potential.

FIG. 12C illustrates that the electrode assembly 220 shown in FIG. 12A may also include a trailing electrode 245 downstream of each second electrode 242. Each trailing electrode 245 is in-line with the second electrode so as not to interfere with airflow past the second electrode 242. Each trailing electrode 245 is preferably located a distance downstream of each second electrode 242 equal to at least three times the width W of the second electrode 242. It is within the scope of the present invention for the trailing electrode to by located at other distances downstream. The diameter of the trailing anode 245 is preferably no greater than the width W of the second electrode 242 to limit the interference of the airflow trailing off the second electrode 242.

One aspect of the trailing electrode 245 is to direct the air trailing off the second electrode 242 and provide a more laminar flow of air exiting the outlet 260. Another aspect of the trailing electrode 245 is to neutralize the positive ions generated by the first array 230 and collect particles within the airflow. As shown in FIG. 12C, each trailing electrode 245 is electrically connected to a second electrode 242 by a conductor 248. Since the second electrode 242 is electrically connected to the high voltage generator 170, the trailing electrode 245 is also negatively charged, and serves as a collecting surface, similar to the second electrode 242, to attract the positively charged particles in the airflow. As previously described, electrically connecting the trailing electrode 245 generates negative ions to neutralize the positive ions emitted by the first electrodes 232.

FIG. 12D illustrates that a pair of third focus electrodes 224 may be located upstream of each first electrode 232. For example, the third focus electrode 224a2 is upstream of the third focus electrode 224a1 so that the third focus electrodes 224a1, 224a2 are in-line and symmetrically aligned with each other along extension line A. Similarly, the third focus electrode 224b2 is in line and symmetrically aligned with the third focus electrode 224b1 along extension line B. As previously described, and in a preferred embodiment, only the third focus electrodes 224a1, 224b1 are electrically connected to the high voltage generator 170, while the third focus electrodes 224a2, 224b2 have a floating potential. It is within the spirit and scope of the present invention to electrically connect all, or none, of the third focus electrodes to the high voltage generator 170.

Electrode Assemblies with Second Collector Electrodes Having Interstitial Electrodes:

FIGS. 12E-12F

FIG. 12E illustrates another embodiment of the electrode assembly 220 with an interstitial electrode 246. In this embodiment, the interstitial electrode 246 is located midway between the second electrodes 242. For example, the interstitial electrode 246a is located midway between the second electrodes 242-1, 242-2, while the interstitial electrode 246b is located midway between second electrodes 242-2, 242-3. Preferably, the interstitial electrode 246a, 246b are electrically connected to the first electrodes 232, and generate an electrical field with the same positive or negative charge as the first electrodes 232. The interstitial electrode 246 and the first electrode 232 then have the same polarity. Accordingly, particles traveling toward the interstitial electrode 246 will be repelled by the interstitial electrode 246 towards the second electrodes 242. Alternatively, the interstitial electrodes can have a floating potential or be grounded.

It is to be understood that interstitial electrodes 246a, 246b may also be closer to one second collector electrode than to the other. Also, the interstitial electrodes 246a, 246b are preferably located substantially near or at the protective end 241 or ends of the trailing sides 244, as depicted in FIG. 12E. Still further the interstitial electrode can be substantially located along a line between the two trailing portions or ends of the second electrodes. These rear positions are preferred as the interstitial electrodes can cause the positively charged particle to deflect towards the trailing sides 244 along the entire length of the negatively charged second collector electrode 242, in order for the second collector electrode 242 to collect more particles from the airflow.

Still further, the interstitial electrodes 246a, 246b can be located upstream along the trailing side 244 of the second collector electrodes 244. However, the closer the interstitial electrodes 246a, 246b get to the nose 246 of the second electrode 242, generally the less effective interstitial electrodes 246a, 246b are in urging positively charged particles toward the entire length the second electrodes 242. Preferably, the interstitial electrodes 246a, 246b are wire-shaped and smaller or substantially smaller in diameter than the width “W” of the second collector electrodes 242. For example, the interstitial electrodes can have a diameter of, the same as, or on the order, of the diameter of the first electrodes. For example, the interstitial electrodes can have a diameter of one-sixteenth of an inch. Also, the diameter of the interstitial electrodes 246a, 246b is substantially less than the distance between second collector electrodes, as indicated by Y2. Further the interstitial electrode can have a length or diameter in the downstream direction that is substantially less than the length of the second electrode in the downstream direction. The reason for this size of the interstitial electrodes 246a, 246b is so that the interstitial electrodes 246a, 246b have a minimal effect on the airflow rate exiting the device 100 or 200.

FIG. 12F illustrates that the electrode assembly 220 in FIG. 12E can include a pair of third electrodes 224 upstream of each first electrode 232. As previously described, the pair of third electrodes 224 are preferably in-line and symmetrically aligned with each other. For example, the third electrode 224a2 is in-line and symmetrically aligned with the third electrode 224a1 along extension line A. Extension line A preferably extends from the middle of the nose 246 of the second electrode 242-2 through the center of the first electrode 232-1. As previously disclosed, in a preferred embodiment, only the third electrodes 224a1, 224b1 are electrically connected to the high voltage generator 170. In FIG. 12F, a plurality of interstitial electrode 296a and 246b are located between the second electrodes 242. Preferably these interstitial electrodes are in-line and have a potential gradient with an increasing voltage potential on each successive interstitial electrode in the downstream direction in order to urge particles toward the second electrodes. In this situation the voltage on the interstitial electrodes would have the same sign as the voltage on the first electrode 232.

Electrode Assembly with an Enhanced First Emitter Electrodes:

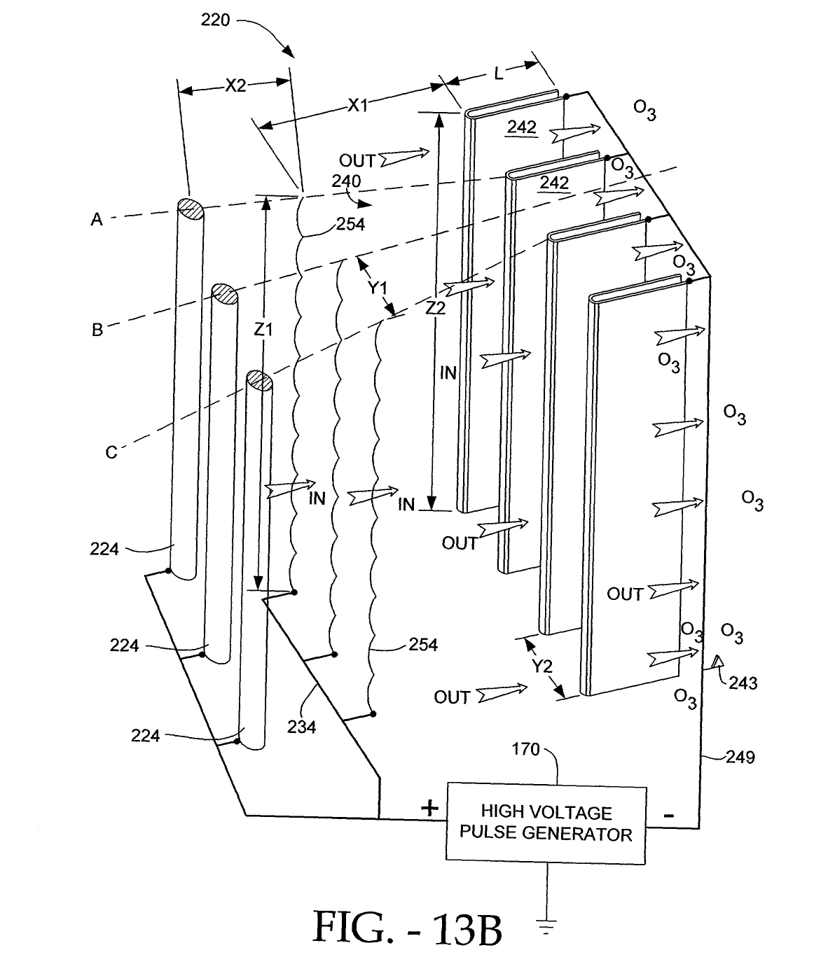

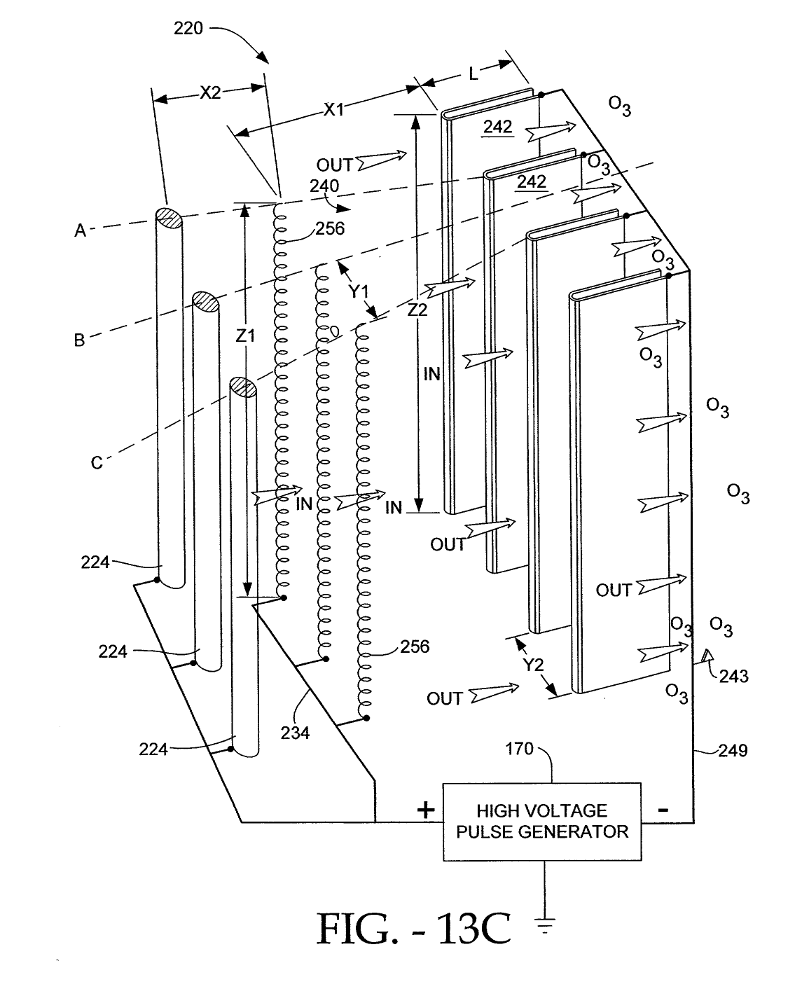

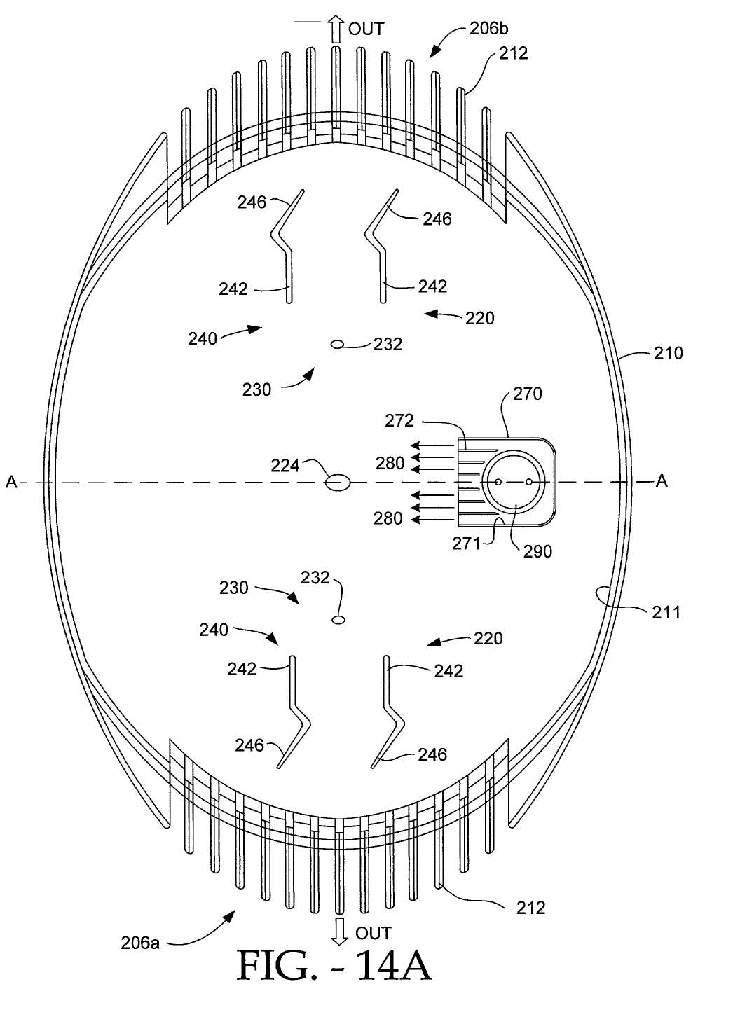

FIGS. 13A-13C

The previously described embodiments of the electrode assembly 220 include a first array of electrodes 230 having at least one wire-shaped electrode 232. It is within the scope of the present invention for the first array of electrodes 230 to contain electrodes consisting of other shapes and configurations.

FIG. 13A illustrates that the first array of electrodes 230 may include curved wire-shaped electrodes 252. The curved wire-shaped electrode 252 is an ion emitting surface and generates an electric field similar to the previously described wire-shaped or rod-shaped electrodes 232. Also similar to previous embodiments, each second electrode 242 is “downstream,” and each third focus electrode 224 is “upstream,” to the curved wire-shaped electrodes 252. The electrical properties and characteristics of the second electrode 242 and the third focus electrode 224 are similar to the previously described embodiment shown in FIG. 6A. It is to be understood that an alternative embodiment of FIG. 13A may exclude the focus electrodes 224 and be within the spirit and scope of the invention.

As shown in FIG. 13A, positive ions are generated and emitted by the first electrode 252. In general, the quantity of negative ions generated and emitted by the first electrode is proportional to the surface area of the first electrode. The height Z1 of the first electrode 252 is equal to the height Z1 of the previously disclosed wire-shaped electrode 232. However, the total length of the electrode 252 is greater than the total length of the electrode 232. By way of example only, and in a preferred embodiment, if the electrode 252 was straightened out the curved or slack wire electrode 252 is 15-30% longer than a rod or wire-shaped electrode 232. The electrode 252 is allowed to be slack to achieve the shorter height Z1. When a wire is held slack, the wire may form a curved shape similar to the first electrode 252 shown in FIG. 13A. It is within the spirit and scope of the invention for the electrode 252 to be rigid. The greater total length of the electrode 252 translates to a larger surface area than the wire-shaped electrode 232. Thus, the electrode 252 will generate and emit more ions than the electrode 232. Ions emitted by the first electrode array attach to the particulate matter within the airflow. The charged particulate matter is attracted to, and collected by, the oppositely charged second collector electrodes 242. Since the electrodes 252 generate and emit more ions than the previously described electrodes 232, more particulate matter will be removed from the airflow. The configuration shown in FIG. 13A may exclude the focus electrodes 224.

FIG. 13B illustrates that the first array of electrodes 230 may include flat coil wire-shaped electrodes 254. Each flat coil wire-shaped electrode 254 also has a larger surface area than the previously disclosed wire-shaped electrode 232. Byway of example only, if the electrode 254 was straightened out, the electrode 254 will have a total length that is preferably 10% longer than the electrode 232. Since the height of the electrode 254 remains at Z1, the electrode 254 has a “kinked” configuration as shown in FIG. 13B. This greater length translates to a larger surface area of the electrode 254 than the surface area of the electrode 232. Accordingly, the electrode 254 will generate and emit a greater number of ions than electrode 232. It is to be understood that an alternative embodiment of FIG. 13B can exclude the focus electrodes 224 and be within the spirit and scope of the invention.

FIG. 13C illustrates that the first array of electrodes 230 may also include coiled wire-shaped electrodes 256. Again, the height Z1 of the electrodes 256 is similar to the height Z1 of the previously described electrodes 232. However, the total length of the electrodes 256 is greater than the total length of the electrodes 232. In a preferred embodiment, if the coiled electrode 256 was straightened out the electrodes 256 will have a total length two to three times longer than the wire-shaped electrodes 232. Thus, the electrodes 256 have a larger surface area than the electrodes 232, and generate and emit more ions than the first electrodes 232.The diameter of the wire that is coiled to produce the electrode 256 is similar to the diameter of the electrode 232. The diameter of the electrode 256 itself is preferably 1-3 mm, but can be smaller in accordance with the diameter of first emitter electrode 232. The diameter of the electrode 256 shall remain small enough so that the electrode 256 has a high emissivity and is an ion emitting surface. It is to be understood that an alternative embodiment of FIG. 13C can exclude the focus electrodes and be within the spirit and scope of the invention.

The electrodes 252, 254 and 256 shown in FIGS. 13A-13C maybe incorporated into any of the electrode assembly 220 configurations previously disclosed in this application.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art and be within the spirit and the scope of the invention. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. An ion generator comprising:
a first electrode;
a second electrode;
a voltage generator electrically coupled to the first electrode and the second electrode in order, when energized, to create a flow of air in a downstream direction from the first electrode to the second electrode; and
wherein said second electrode is comprised of two or more surfaces that are at an angle to each other.

2. The ion generator of claim 1 wherein said second electrode is Z-shaped.

3. The ion generator of claim 1 wherein said second electrode has a tail section that is substantially wider than a nose section.

4. The ion generator of claim 1 wherein said second electrode has a downstream tail section that is substantially wider than an upstream nose section.

5. The ion generator of claim 1 wherein said second electrode has a leading planar section and a trailing section that is at an angle to said leading planar section.

6. The ion generator of claim 1 wherein said second electrode has an upstream leading planar section and a downstream trailing section that is at an angle to said leading planar section.

7. The ion generator of claim 1 wherein said second electrode is hollow.

8. The ion generator of claim 1 wherein said two or more surfaces are each planar.

9. An ion generator comprising:
a first electrode;
a second electrode;
a voltage generator electrically coupled to the first electrode and the second electrode in order, when energized, to create a flow of air in a downstream direction from the first electrode to the second electrode; and
wherein said second electrode has a tail section that is wider than a nose section.

10. The ion generator of claim 9 wherein said tail section is located downstream from said nose section.

11. A device for conditioning air comprising:
a housing with an air inlet and an air outlet;
a first electrode;
a second electrode;
said first electrode located closer to said air inlet than said second electrode;
said second electrode located closer to said air outlet than said first electrode;
a potential generator electrically coupled to the first electrode and the second electrode in order, when energized, to create a flow of air in a downstream direction from the first electrode to the second electrode; and
wherein said second electrode is comprised of two or more surfaces that are at an angle to each other.

12. The ion generator of claim 11 wherein said second electrode is Z-shaped.

13. The ion generator of claim 11 wherein said second electrode has a tail section that is wider than a nose section.

14. The ion generator of claim 11 wherein said second electrode has a downstream tail section that is wider than an upstream nose section.

15. The ion generator of claim 11 wherein said second electrode has a leading planar section and a trailing section that is at an angle to said leading planar section.

16. The ion generator of claim 11 wherein said second electrode has an upstream leading planar section and a downstream trailing section that is at an angle to said leading planar section.

17. The ion generator of claim 11 wherein said second electrode is hollow.

18. The ion generator of claim 11 wherein said two or more surfaces are each planar.

19. A device for conditioning air comprising:
a housing with an air inlet and an air outlet;
a first electrode;
a second electrode;
said first electrode located closer to said air inlet than said second electrode;
said second electrode located closer to said air outlet than said first electrode;
a potential generator electrically coupled to the first electrode and the second electrode in order, when energized, to create a flow of air in a downstream direction from the first electrode to the second electrode; and
wherein said second electrode has a tail section that is wider than a nose section.

20. The ion generator of claim 19 wherein said tail section is located downstream from said nose section.

21. The ion generator of claim 1 wherein said second electrode is teardrop-shaped with a small rounded end and a large bulbous end and with the pointed end located closer to said first electrode.

22. The ion generator of claim 1 wherein said second electrode is V-shaped with a rounded end, and with the rounded end of the V-shape located closer to said first electrode.

23. The ion generator of claim 9 wherein said second electrode is teardrop-shaped with a small rounded end and a large bulbous end and with the small rounded end located closer to said first electrode.

24. The ion generator of claim 9 wherein said second electrode is V-shaped with a rounded end, and with the rounded end of the V-shape located closer to said first electrode.

25. The ion generator of claim 11 wherein said second electrode is teardrop-shaped with a small rounded end and a large bulbous end and with the pointed end located closer to said first electrode.

26. The ion generator of claim 11 wherein said second electrode is V-shaped with a rounded end, and with the rounded end of the V-shape located closer to said first electrode.

27. The ion generator of claim 19 wherein said second electrode is teardrop-shaped with a small rounded end and a large bulbous end and with the small rounded end located closer to said first electrode.

28. The ion generator of claim 19 wherein said second electrode is V-shaped with a rounded end, and with the rounded end of the V-shape located closer to said first electrode.
